(19) United States
(12) Patent Application Publication
(10) Pub. No.: US 2003/0030582 A1
(43) Pub. Date: Feb. 13, 2003

(54) Environment measurement methods, systems, media, signals and data structures

(76) Inventor: Roger S. Vickers, Los Altos, CA (US)

Correspondence Address: DOWELL & DOWELL PC, SUITE 309, 1215 JEFFERSON DAVIS HIGHWAY, ARLINGTON, VA, 22202

(21) Appl. No.: 09/925,527

(22) Filed: Aug. 10, 2001

(51) Int. Cl. G01S 13/86; G01S 13/88

(52) U.S. Cl. 342/54; 342/123; 342/191

(57) ABSTRACT

Environment measurement methods, systems, media, signals and data structures are disclosed. A first method involves receiving first signals produced in response to a laser beam scattered by the environment, receiving second signals produced in response to a radar beam scattered by the environment, and storing data representing the first and second signals, for use in producing a representation of the environment. A second method involves continuously producing data in response to scattered portions of a laser pulse scattered by respective portions of the environment, during a measurement interval of sufficient duration to receive all the scattered portions, and storing the data, for use in producing a representation of the environment.

### BACKGROUND OF THE INVENTION

1. Field of Invention

The present invention relates to measurement, and more particularly, to environment measurement methods, systems, media, signals and data structures.

2. Description of Related Art

Environment measurement systems have many useful applications. For example, forestry companies often require reasonably accurate surveys of ground elevation and foliage height in a given area of the environment, in order to determine how best to build access roads and carry out forestry practices in the area. Similarly, many other types of businesses, as well as governmental bodies, particularly those involved in management of agriculture, forests or natural resources, often require surveys of at least terrain height in a given area. In addition to ground elevation and foliage height, many entities, such as oil and gas exploration companies for example, often wish to obtain information about subterranean strata, objects, or other underground aspects of the environment, if possible.

One existing environment measurement method involves the use of radar. For example, an incident radar beam may be directed from an aircraft to the environment. The radar beam is then reflected or scattered by the environment back to the aircraft, where it is detected at a detector. The signals produced by the detector may then be used to produce information about the environment beneath the aircraft.

However, existing radar systems suffer from a number of limitations. For example, radar systems typically have low resolution, or in other words, they are typically poor at distinguishing between nearby objects emitting similar energy levels. Thus, typical existing radar systems are not reliably accurate in measuring smaller objects, such as measuring radar return scattered by treetops to determine foliage height, for example. Radar representations are also subject to geometric distortions due to rapid relief changes in the object being measured. In addition, many existing radar systems employ wavelengths less than 0.1 meters, and often less than 0.01 meters, however, such wavelengths generally provide little or no subterranean penetration, and indeed, frequently fail to penetrate thick foliage to reach the ground and back.

Another type of environment measurement system includes light detection and ranging (lidar) systems, which use a laser to direct a laser beam to the environment, and a detector the aircraft for determining the distance to the environment in response to the return travel time of the laser beam to the environment and back. Laser systems are typically capable of producing appreciably more accurate measurements of distances to small objects, and are therefore capable of providing more accurate foliage height measurements than typical radar systems. However, in light to moderate foliage thicknesses, the laser beam often cannot penetrate through the foliage to the ground and back. Thus, the laser systems, although more accurate in some respects, are limited in the information they can provide in many circumstances. In addition, existing laser systems typically produce data only in response to the first and last returns from the environment (such as returns from a highest treetop and from the ground, for example), and do not make use of laser returns from portions of the environment in between (such as intervening foliage, twigs or branches, for example). In addition, laser systems are generally not capable of providing subterranean information, and indeed, frequently do not even detect the ground surface.

Accordingly, there is a need for an improved environment measurement system.

### SUMMARY OF THE INVENTION

The present invention addresses the above need by providing, in accordance with a first aspect of the invention, an environment measurement method. The method includes receiving first signals produced in response to a laser beam scattered by the environment, receiving second signals produced in response to a radar beam scattered by the environment, and storing data representing the first and second signals, for use in producing a representation of the environment.

Thus, data for use in producing a representation of the environment may be stored in response to both laser and radar signals, thereby overcoming the disadvantages associated with either type of measurement device by itself. For example, the greater resolution of laser measurements for determining foliage height, along with the lack of susceptibility of such laser measurements to either geometric distortions or to constructive or destructive interference, may be combined with the ability of radar to identify ground height even in thick foliage conditions. In this regard, if desired, a relative foliage height of the environment may be determined, by subtracting a ground level height obtained from radar data, from an absolute foliage height value obtained from laser data. Alternatively, the two types of data may be combined in other ways to form other types of unitary representations, such as by using laser data corresponding to ground returns to arbitrate or calibrate the radar data, for example.

The method may involve receiving the laser beam scattered by the environment and producing the first signals in response thereto. The method may further involve producing an incident laser beam for scattering by the environment to produce the laser beam scattered by the environment.

The method may involve directing the incident laser beam to the environment at a desired angle. In this regard, directing may include adjusting a physical orientation of a beam directing device in response to an orientation signal, to direct the incident laser beam to the environment at the desired angle. The method may also involve producing the orientation signal. Likewise, the method may involve directing the laser beam scattered by the environment from the beam directing device to a detector.

Receiving the laser beam scattered by the environment may include receiving scattered portions of a laser pulse scattered by respective portions of the environment. Similarly, producing the first signals may further include continuously producing data signals in response to the scattered portions of the laser pulse, during a measurement interval of sufficient duration to receive all the scattered portions.

The method may further involve producing the second signals in response to a radar beam scattered by the environment.

In this regard, the method may involve receiving the radar beam scattered by the environment at an airborne receiver, the radar beam having a wavelength of at least on the order of one meter. For example, this may involve receiving, as the radar beam scattered by the environment, a radar beam having a wavelength between 0.7 and 2 meters.

Similarly, the method may include directing an incident radar beam to the environment to produce the radar beam scattered by the environment. This may entail directing to the environment, as the incident radar beam, an ultra-wide band (UWB) radar beam.

Directing may include transmitting the incident radar beam to the environment from a transmission antenna system, and the method may further involve receiving the radar beam scattered by the environment at a reception antenna system.

Producing the second signals may involve delaying signals produced by at least some of a plurality of antennae of the reception antenna system.

The transmission antenna system and the reception antenna system may include a common transceiving antenna system, and transmitting and receiving may thus include transmitting and receiving at the common transceiving antenna system. Alternatively, however, separate antenna systems may be employed for transmitting and receiving.

The method may further include blanking transmitter cross-talk signals while directing the incident radar beam to the environment.

Producing the second signals may include producing frequency-shifted signals in response to the radar beam scattered by the environment. Producing the frequency-shifted signals may involve producing initial electrical signals at frequencies of the radar beam scattered by the environment, in response thereto, and may further involve applying the initial electrical signals and a mixing frequency signal to a mixer, to produce the frequency-shifted signals. Alternatively, or in addition, producing frequency-shifted signals may involve producing in-phase frequency-shifted signals and in-quadrature frequency-shifted signals. Producing the second signals may further include digitizing the frequency-shifted signals.

The method may also involve adjustably attenuating the second signals.

Storing the data may include defining a data structure including a measurement context field for storing measurement context information, a laser field for storing the data representing the first signals, and a radar beam field for storing the data representing the second signals.

Similarly, storing the data may involve storing measurement context information in association with the data representing the first and second signals. In this regard, the measurement context information may include global positioning satellite (GPS) information indicative of a location at which at least one of the laser beam and the radar beam is received, at least one time value indicative of a time at which at least one of the laser beam and the radar beam is received, attenuation information indicative of an amount of attenuation of the second signals, a frequency value indicative of a frequency of the radar beam, user-inputted information, or a flight line indication indicative of a flight line over which the laser beam and the radar beam are received by an airborne environment measurement system, or any combination thereof, for example.

Storing the data representing the second signals may involve storing an in-phase value and an in-quadrature value representing an in-phase component and an in-quadrature component respectively of the second signals.

The method may also involve producing the representation of the environment in response to the data. In this regard, producing the representation may involve applying a migration algorithm to the data representing the second signals, to associate the data representing the second signals with particular locations of the environment. Alternatively, or in addition, producing the representation may include identifying a foliage height of the environment, identifying a height of a terrain surface of the environment, identifying features of the environment below the terrain surface, identifying a slope of the terrain surface, producing a digital elevation model of the environment, or producing at least one contour representation of the environment, for example.

In accordance with another aspect of the invention, there is provided an environment measurement system including a memory device and a processor circuit. The processor circuit is in communication with the memory device, and is configured to receive first signals produced in response to a laser beam scattered by the environment, to receive second signals produced in response to a radar beam scattered by the environment, and to store data representing the first and second signals in the memory device, for use in producing a representation of the environment.

If desired, the system may further include additional structural elements, such as elements described in greater detail herein for example, operable to perform various aspects of the methods described herein.

In accordance with another aspect of the invention, there is provided a data structure including a laser field for storing data representing first signals produced in response to a laser beam scattered by an environment, and a radar beam field for storing data representing second signals produced in response to a radar beam scattered by the environment.

In accordance with yet another aspect of the invention, there is provided an environment measurement method involving continuously producing data in response to scattered portions of a laser pulse scattered by respective portions of the environment, during a measurement interval of sufficient duration to receive all the scattered portions, and storing the data, for use in producing a representation of the environment.

Thus, a full set of laser data, rather than merely a first return value, may be obtained for a given laser pulse. This may be particularly advantageous in light foliage conditions, for example, in which case the laser data may include not only a foliage height value, but also a ground height value, as well as one or more intermediate return values corresponding to objects such as foliage at intermediate heights between the foliage height and the ground height.

Such a measurement interval may be at least on the order of one microsecond, for example.

The method may further involve producing an incident laser pulse having a duration on the order of one nanosecond, for scattering by the environment to produce the scattered portions of the laser pulse.

The method may also involve receiving the incident laser pulse at a beam directing device, adjusting a physical orientation of the beam directing device in response to an orientation signal, to direct the incident laser pulse from the beam directing device to the environment.

In accordance with another aspect of the invention, there is provided an environment measurement system including a memory device and a processor circuit in communication with the memory device. The processor circuit is configured to cooperate with a detection system to continuously produce data in response to scattered portions of a laser pulse scattered by respective portions of the environment, during a measurement interval of sufficient duration to receive all the scattered portions, and to store the data in the memory device, for use in producing a representation of the environment.

If desired, the system may further include additional structural elements, such as elements described in greater detail herein for example, operable to perform various aspects of the methods described herein.

In accordance with another aspect of the invention, there is provided an environment measurement method, involving producing signals in response to a radar beam scattered by the environment and received at an airborne receiver, the radar beam having a wavelength of at least on the order of one meter. The method further includes storing data representing the signals, for use in producing a representation of the environment.

By employing a radar beam having a wavelength at least on the order of one meter, a number of advantages may be obtained. For example, 1-m wavelengths typically penetrate relatively deep into soil, even moist soil, and therefore, data representing signals produced in response to such wavelengths may be used to produce a representation of a subterranean region of the environment. In addition, wavelengths between 0.75 m and 1.5 m are often reserved by governments as communications channels, and therefore, there is typically much less background noise in this wavelength range than in surrounding wavelength ranges, allowing for more accurate radar measurements with higher signal-to-noise ratios. Conversely, it should typically be possible to use this wavelength range with insufficient power to cause any significant long-range interference.

The method may further involve receiving the radar beam scattered by the environment at the airborne receiver, the radar beam having a wavelength between 0.7 and 2 meters.

Producing the signals may involve continuously producing data signals in response to scattered portions of a radar pulse scattered by respective portions of the environment, during a measurement interval of sufficient duration to receive all the scattered portions.

The method may entail directing an ultra-wide band (UWB) incident radar beam to the environment to produce the radar beam scattered by the environment.

In accordance with another aspect of the invention, there is provided an environment measurement system including and airborne radar reception system and a processor circuit. The airborne radar reception system is operable to produce signals in response to a radar beam scattered by the environment and having a wavelength of at least on the order of one meter. The processor circuit is in communication with the airborne radar reception system, and is configured to store data representing the signals, for use in producing a representation of the environment.

In accordance with another aspect of the invention, there is provided an environment measurement method, involving receiving data representing signals produced at an airborne receiver in response to a radar beam scattered by the environment, and applying a migration algorithm to the data, to associate the data with particular locations of the environment.

In this regard, by applying a migration algorithm to the data, the effective spot size of the incident radar beam may be effectively decreased through integration, thereby improving the resolution of a resulting representation of the environment.

Similarly, In accordance with another aspect of the invention, there is provided an environment measurement system including a processor circuit configured to receive the data and apply the migration algorithm thereto.

In accordance with other aspects of the invention, there are provided environment measurement systems, each system including provisions for performing the functions of a respective one of the methods described above.

In accordance with other aspects of the invention, there are provided computer-readable media, each such medium storing codes for directing a processor circuit to perform the functions of a respective one of the methods described above.

In accordance with other aspects of the invention, there are provided signals, each such signal including code segments for directing a processor circuit to perform the functions of a respective one of the methods described above.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention,

FIG. 1 is a block diagram of an environment measurement system according to a first embodiment of the invention, with an exemplary environment shown for illustrative purposes;

FIG. 2 is a block diagram of an environment measurement system according to a second embodiment of the invention;

FIG. 3 is a perspective view of the environment measurement system shown in FIG. 2, installed on an airborne vehicle;

FIG. 4 is a cross-sectional view of an environment being measured by the system shown in FIGS. 2 and 3, along with graphical representations of signals produced in response to a laser beam and a radar beam scattered by the environment;

FIG. 5 is a block diagram of a laser system of the environment measurement system shown in FIG. 2;

FIG. 6 is a block diagram of a radar transmission system of the environment measurement system shown in FIG. 2;

FIG. 7 is a block diagram of a radar reception system of the environment measurement system shown in FIG. 2;

FIGS. 8a and 8b are a block diagram of a central processing system and a memory device of the environment measurement system shown in FIG. 2;

FIG. 9 is a flowchart of a measurement routine executed by a processor circuit of the system shown in FIG. 2;

FIG. 10 is a timing diagram of control signals produced by the system shown in FIG. 2, while executing the measurement routine shown in FIG. 9;

FIG. 11 is a fragmented cross-sectional view of a second environment being measured by the system shown in FIG. 2, along with a graphical representation of signals produced in response to scattered portions of a laser pulse scattered by respective portions of the environment;

FIG. 12 is a flowchart of an analysis routine executed by a representation processing circuit such as the processor circuit of the system shown in FIG. 2;

FIG. 13 is a graphical illustration of a flight line representation which may be produced by the representation processing circuit while executing the analysis routine shown in FIG. 12;

FIG. 14 is a graphical representation of a subterranean portion of the environment, which may be produced by the representation processing circuit while executing the analysis routine shown in FIG. 12;

FIG. 15 is a contour representation of the environment, which may be produced by the representation processing circuit while executing the analysis routine shown in FIG. 12;

FIG. 16 is a three-dimensional contour representation of the environment, which may be produced by the representation processing circuit while executing the analysis routine shown in FIG. 12;

FIG. 17 is a block diagram of a radar transmission system according to a third embodiment of the invention; and

FIG. 18 is a block diagram of a radar transceiving system according to a fourth embodiment of the invention.

### DETAILED DESCRIPTION

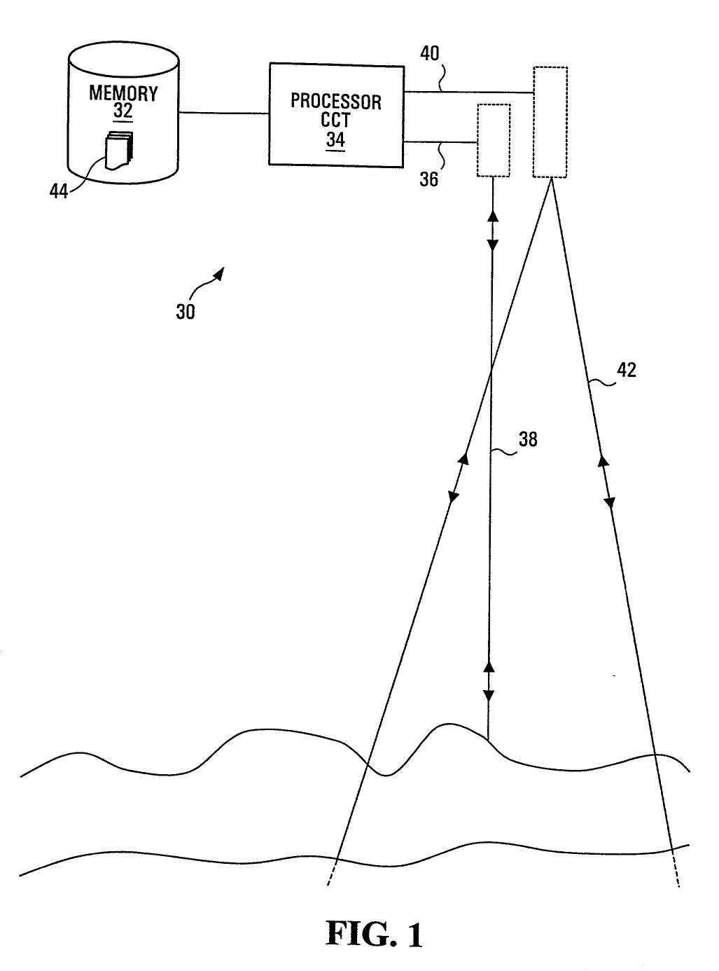

Referring to FIG. 1, an environment measurement system according to a first embodiment of the invention is shown generally at 30. The system 30 includes a memory device 32, and a processor circuit 34 in communication with the memory device 32. In this embodiment, the processor circuit 34 is configured to receive first signals 36 produced in response to a laser beam 38 scattered by the environment, to receive second signals 40 produced in response to a radar beam 42 scattered by the environment, and to store data 44 representing the first and second signals 36 and 40 in the memory device 32, for use in producing a representation of the environment.

System

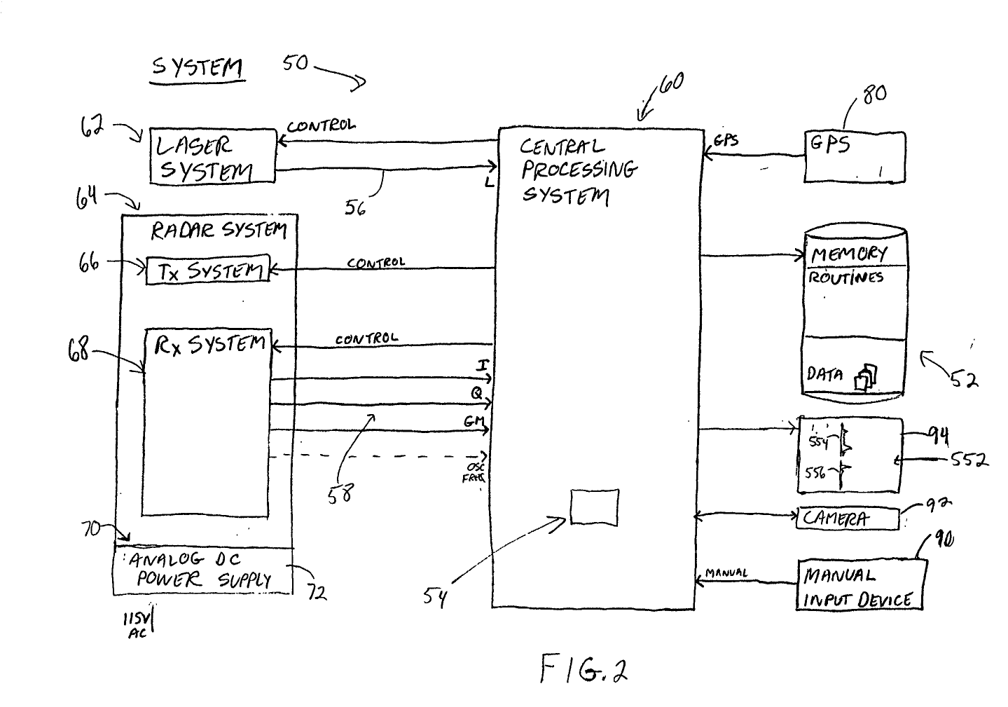

Referring to FIG. 2, an environment measurement system according to a second embodiment of the invention is shown generally at 50. The system 50 includes a memory device shown generally at 52, and a processor circuit shown generally at 54, in communication with the memory device 52. In this embodiment the processor circuit 54 is configured to receive first signals 56 produced in response to a laser beam scattered by the environment, to receive second signals shown generally at 58 produced in response to a radar beam scattered by the environment, and to store data representing the first and second signals 56 and 58 in the memory device 52, for use in producing a representation of the environment.

More particularly, in this embodiment the system 50 includes a central processing system (CPS) shown generally at 60, which in this embodiment includes the processor circuit 54.

In the present embodiment the central processing system (CPS) 60 is in communication with a laser system shown generally at 62, and with a radar system shown generally at 64.

In this embodiment the radar system 64 includes a radar transmission system 66, a radar reception system 68, and a power supply system 70. In this embodiment the power supply system 70 receives unregulated aircraft direct current (DC) power, in response to which it produces and supplies regulated direct current (DC) power to the various components of the radar system 64. More particularly, in the present embodiment the power supply system 70 produces regulated direct currents of 5 amps at +5 volts, 1 A@+15 V and 1 A at −15 V, which are then supplied to appropriate components of the radar system 64.

In this embodiment, the power supply system 70 includes an analog DC power supply 72, which tends to produce less broad-band noise than comparable digital power supplies. Accordingly, additional radio frequency interference (RFI) filtration of the incoming power is not required in the present embodiment. Alternatively, however, other types of power supplies may be substituted, although an appropriate RFI filter (not shown) may be required in such alternative embodiments depending on the amount of noise produced by the power supply.

If AC power is not available in a particular embodiment, then the power supply system 70 may further include power inverters to produce regulated 115 V AC power from an available DC power supply (such as a 28 V DC power supply available on many aircraft, for example). Each inverter may include a suitable breaker, such as a 50 amp breaker, for example.

In this embodiment the CPS 60 is in further communication with a global positioning system (GPS) device 80. The GPS device receives navigation (NAV) message signals from a plurality of GPS satellites orbiting the earth, in response to which it produces data signals indicating the position and velocity of the GPS device, and also the present time. In this embodiment the GPS provides updated data signals representing such information twice per second, although alternatively, faster or slower updating rates may be used. In the present embodiment the GPS device is the sole GPS receiver employed by the system 50. Alternatively, however, if desired, accuracy of the GPS device 80 may be further improved through differential positioning (DGPS). For example, a second GPS receiver (not shown) may be provided at a nearby known location, to allow for determination of a GPS positioning error and calculation of a corresponding corrective factor to be applied to the position data produced by the GPS device 80.

In the present embodiment the CPS 60 is also in communication with further input/output devices, including a manual input device 90, a camera 92 and a display device 94. In this embodiment the manual input device 90 includes a keyboard, and the camera 92 includes a Kodak Professional DCS-460 Digital Camera.

Airborne System

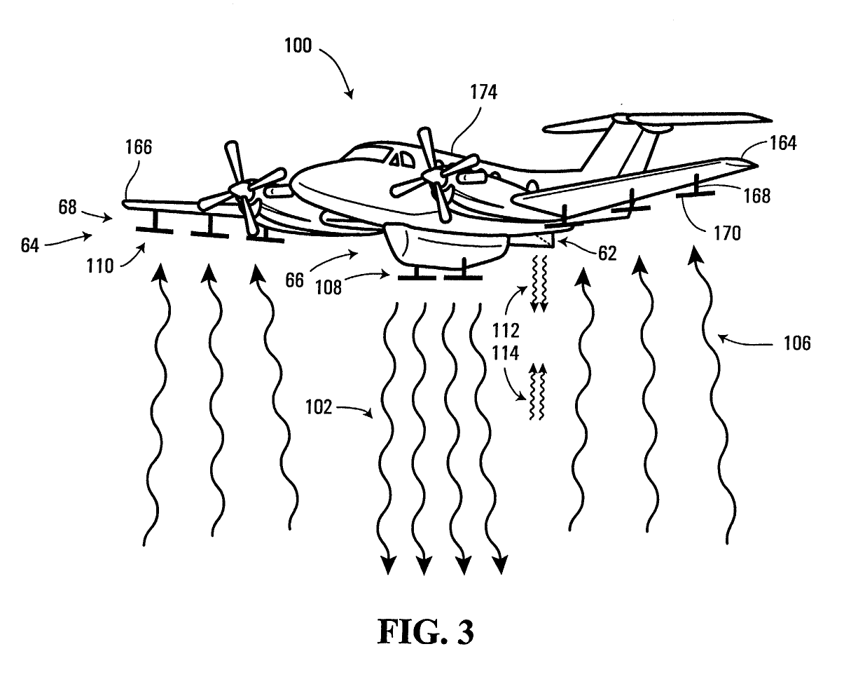

Referring to FIGS. 2, 3 and 4, in the present embodiment the system 50 is mountable in an aircraft, such as that shown at 100 in FIG. 3. More particularly, in the present embodiment the aircraft 100 is a Beechcraft Super Kingair 200 airplane. Alternatively, however, the system 50 may be employed with other types of aircraft such as other airplanes or helicopters for example, or may be employed in other contexts if desired.

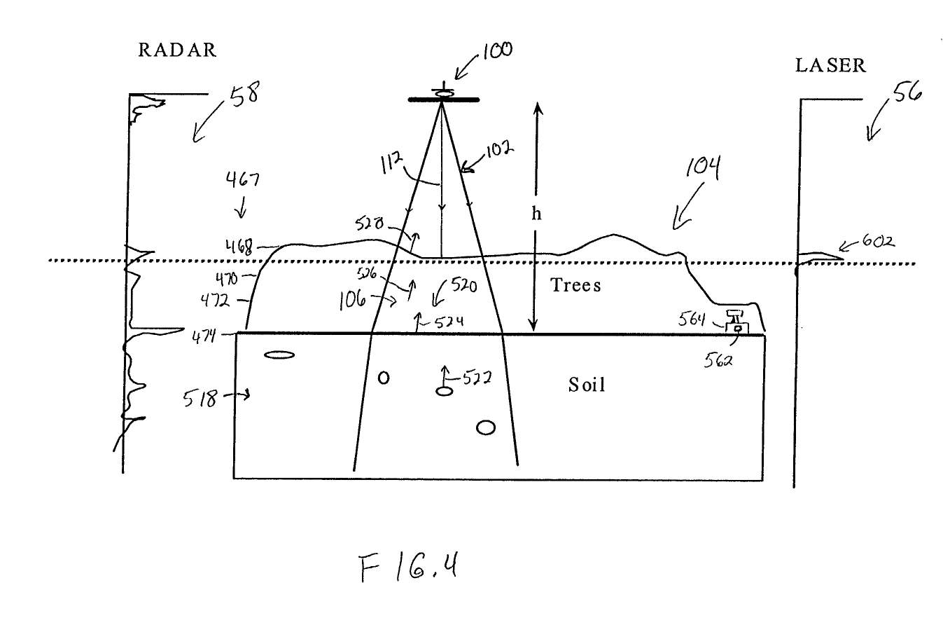

Thus, in this embodiment the system 50 includes the radar system 64, which is operable to produce the second signals 58 in response to a radar beam scattered by the environment. More particularly, in this embodiment the radar system 64 is configured to direct an incident radar beam, shown generally at 102 in FIGS. 3 and 4, to the environment, which is shown generally at 104 in FIG. 4, to produce the radar beam scattered by the environment, shown generally at 106 in FIG. 3.

More particularly still, in this embodiment the radar system 64 includes a transmission antenna system shown generally at 108 in FIG. 3, which is configured to direct the incident radar beam 102 to the environment 104, and a reception antenna system shown generally at 110, configured to receive the radar beam 106 scattered by the environment 104.

Similarly, in this embodiment, the laser system 62 directs an incident laser beam 112 to the environment 104, which scatters the incident laser beam 112, or in other words, produces a laser beam scattered by the environment such as that shown generally at 114 in FIG. 3.

Laser System

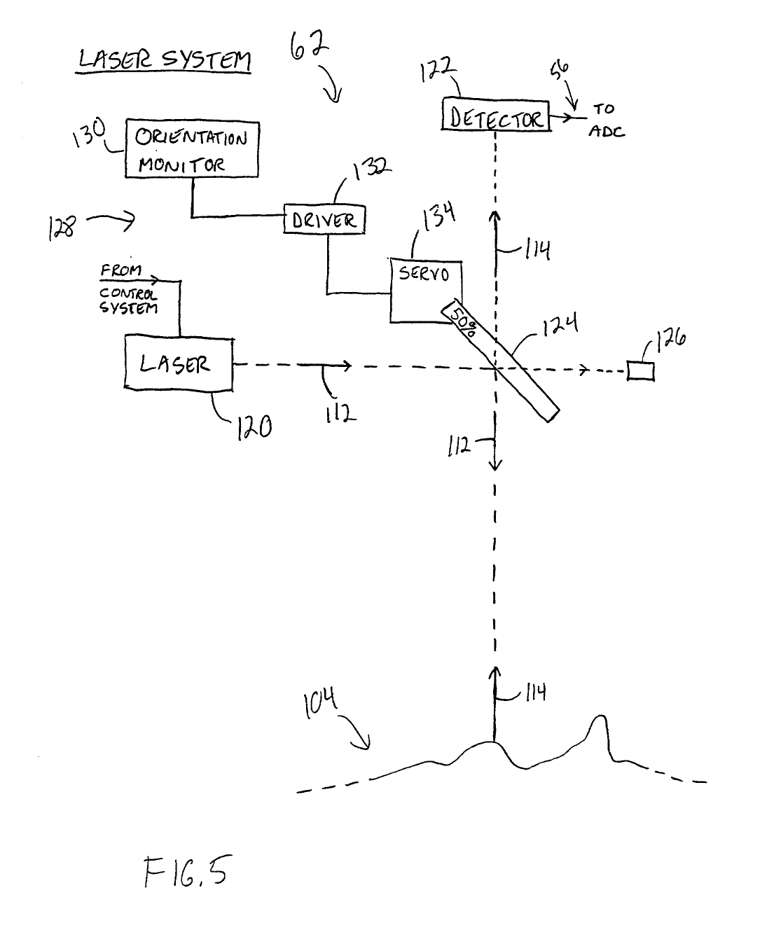

Referring to FIGS. 2, 3, 4 and 5, the laser system of the present embodiment is shown generally at 62 in FIG. 5. In this embodiment the laser system 62 includes a laser 120 operable to produce the incident laser beam 112, for scattering by the environment 104 to produce the laser beam 114 scattered by the environment.

More particularly, in this embodiment the laser 120 includes a laser manufactured by Riegl Laser Measurement Systems GmbH of Horn, Austria as a component of Riegl Laser Mirror Scanner LMS-Q140i-60/80. In the present embodiment the laser 120 is operable to produce, as the incident laser beam 112, a laser pulse at a near-infrared wavelength of 900 nanometers, having a pulse duration of approximately 2 nanoseconds and a beam divergence of 3 milliradians. In this embodiment the laser 120 produces such a pulse every 1/75^{th} of a second, or in other words, is operated at a pulse repetition rate of 75 Hz. The incident laser beam 112 produced by the laser 120 has a Class 1 eye safety, and therefore minimizes safety risks to any humans or animals in the environment 104 or aboard the aircraft 100.

Alternatively, however, other lasers may be substituted if desired. Generally, it is desirable that the laser 120 have a pulse repetition rate of at least about 60 Hz, and a signal-to-noise ratio of 0 dB or better for a 20% reflective target (single pulse). It is also desirable for the laser 120 to be able to operate in altitudes between 1000 and 3000 feet AGL, even more preferably between 500 and 6000 feet AGL, to produce a spot size of 2 m diameter or smaller at 3000 feet AGL, and to have sufficient power to yield detectable scattered returns from low-reflectivity ground at flight altitude.

In this embodiment, the laser system 62 further includes a detector 122 operable to receive the laser beam 114 scattered by the environment 104 and to produce the first signals 56 in response thereto. More particularly, in this embodiment the detector 122 includes a detector manufactured and sold as a component of the aforementioned Riegl Laser Mirror Scanner. Alternatively, however, other detectors may be substituted.

The laser system 62 of the present embodiment further includes a beam directing device 124, operable to direct the incident laser beam 112 to the environment 104 at a desired angle, which in this embodiment is vertical relative to a reference geoid. In this embodiment the beam directing device 124 is also locatable to direct the laser beam 114 scattered by the environment to the detector 122.

More particularly, in this embodiment the beam directing device 124 includes a semitransparent mirror. The beam directing device receives the incident laser beam 112, or more particularly receives each successive 2 ns pulse, from the laser 120, and reflects approximately 50% of the photons in each such pulse toward the environment 104. The remaining 50% of the incident laser beam 112 passes through the beam directing device to a light stopper 126, where it is effectively discarded.

The environment 104 scatters the received incident laser beam 112 to produce the laser beam 114 scattered by the environment, some of which is received at the beam directing device 124. Approximately 50% of this portion of the laser beam 114 scattered by the environment is transmitted through the beam directing device 124 and through a focusing lens 125 to the detector 122, which then produces, as the first signals 56, analog electrical signals whose voltage is proportional to the intensity of the received laser beam 114 scattered by the environment. The remaining 50% is reflected back toward the laser 120, and is absorbed by an absorber (not shown) interposed between the laser 120 and the beam directing device 124. More particularly in this embodiment the absorber includes a disc-shaped absorptive plate having a central aperture therethrough allowing passage of the incident laser beam 112 from the laser 120 to the beam directing device 124.

In the present embodiment, the laser system 62 also includes a motion mechanism shown generally at 128, operable to adjust a physical orientation of the beam directing device 124 in response to an orientation signal, to direct the incident laser beam 112 to the environment 104 at the desired angle, which in this embodiment is vertically downward toward the environment.

In this regard, one of the many possible applications of the present embodiment is to obtain laser data representing the environment 104 directly beneath the aircraft 100 as it flies along a number of relatively straight flight lines. For this purpose, the aircraft 100 and a spot at which the incident laser beam 112 strikes the environment 104 should ideally remain within a common vertical plane at all times during the aircraft's flight along the flight line. However, if the incident laser beam 112 always pointed in a fixed direction relative to the aircraft, then deviations from the desired aircraft motion would cause the incident laser beam 112 to point away from the vertical plane defined underneath the aircraft, and would therefore introduce measurement errors. More particularly, such deviations of aircraft motion may include “roll”, (whereby the aircraft slightly rotates back and forth about a central axis pointing in the direction of its flight trajectory), “pitch” (whereby the aircraft rotates about a horizontal axis perpendicular to the direction of its flight trajectory, causing the nose to point upwards or downwards relative to a horizontal plane), and “yaw” (whereby the entire aircraft deviates from its desired straight line trajectory defining the flight line). However, in practice, it has been found that pitch does not tend to introduce significant measurement errors. Similarly, it has been found that yaw errors, which may be corrected using GPS data in any event, are also insignificant. However, correction for roll is desirable for many applications.

Accordingly, in the present embodiment the purpose of the motion mechanism 128 is to correct for “roll” of the aircraft 100 shown in FIG. 3, to ensure that the incident laser beam 112 is always pointing vertically downward at the environment 104, rather than pointing toward a point laterally offset from a vertical plane defined beneath the aircraft as it flies in a straight flight line over the environment 104. More particularly, in this embodiment the motion mechanism 128 provides roll stabilization of ±0.01 radians to the incident laser beam 112. In the present embodiment the motion mechanism 128 accomplishes this by adjusting a physical orientation of the beam directing device 124 in response to an orientation signal, to direct the incident laser beam 112 to the environment 104, at a desired orientation pointing vertically downwards.

In this embodiment the motion mechanism 128 includes an orientation monitoring device 130 operable to produce the orientation signal. More particularly, in this embodiment the orientation monitoring device 130 includes a single-axis fiber optic gyro, operable to produce signals in response to rotation of the aircraft 100 about a central axis pointing in the direction of flight of the aircraft. In this regard, suitable fiber-optic gyros are available from a number of vendors around the world, such as the E-Core 2000 FOG manufactured by KVH Industries, Inc. of Middletown, R.I., USA, for example.

In this embodiment, the orientation monitoring device 130 produces an electrical orientation signal whose voltage is proportional to the angular rate of rotation of the aircraft 100 about its central axis, and whose polarity is determined by the direction of rotation. For example, if the aircraft is not rotating, a signal at a reference voltage is produced; rotation of the aircraft about its central axis (pointing in the flight direction) results in an electrical orientation signal having a voltage either exceeding the reference voltage in the case of positive rotation about the central axis or less than the reference voltage in the case of negative rotation, by a voltage difference proportional to the rate of rotation of the aircraft.

Alternatively, other types of fiber-optic gyros may be substituted. For example, rather than employing a “rate” gyro, a gyro including a built-in integrator, for producing an electrical orientation signal proportional to the amount (rather than the rate) of angular rotation may be substituted. Similarly, the orientation monitoring device need not include a fiber optic gyro, but may include any other device suitable for monitoring rotation about an axis, such as a mechanical gyro or an accelerometer system, for example.

In the present embodiment the motion mechanism 128 further includes a driver 132, and a servo 134. In this embodiment the driver 132 includes an integrator (not shown), which receives the electrical orientation signal from the orientation monitoring device 130 representing the rate and direction of rotation of the aircraft 100, and effectively integrates such rotational rate information to produce an integrated electrical orientation signal whose deviation from a reference voltage is proportional to an angular displacement of the aircraft 100 about its central axis relative to a horizontal position. In other words, the voltage of the integrated electrical orientation signal is proportional to the angle of the aircraft relative to the horizontal. For example, if the aircraft is horizontal, an integrated orientation signal at the reference voltage is produced; a positive rotation of the aircraft about its central axis (pointing in the flight direction) results in an integrated orientation signal having a positive voltage exceeding the reference voltage by an amount proportional to the angle of the aircraft relative to the horizontal position; and a negative rotation results in an integrated orientation signal less than the reference voltage by an amount proportional to the angle of the aircraft relative to the horizontal.

In this embodiment the driver 132 further includes a “reset integrators to zero” button (not shown), for error correction purposes. In this regard, it will be appreciated that integration of an angular rate R of rotation yields an angular displacement of φ+k, where k is a constant. Accordingly, the “reset integrators to zero” button may be actuated when the aircraft is in a stable horizontal orientation and is not rotating, to cause the integrator to produce the integrated orientation signal at precisely the reference voltage. However, it will be appreciated that over time, errors in the integrated angular displacement may accumulate, and may cause the integrator to produce the reference voltage when the aircraft is actually at a non-zero angular displacement relative to the horizontal. To prevent such errors from significantly accumulating, the “reset integrators to zero” button may be periodically actuated when the aircraft is horizontal. For example, in this embodiment the integrators are reset to zero in this manner prior to commencement of each individual flight line flown by the aircraft 100.

The servo 134 is attachable to the beam directing device 124, and is operable to rotate the beam directing device 124 about an axis parallel to the central axis of the aircraft 100 (i.e., about an axis pointing in the flight direction of the aircraft). The servo also produces an electrical feedback signal whose deviation from a reference voltage varies in proportion to the angle at which the servo has rotated the beam directing device 124 relative to the aircraft 100. In this embodiment the reference voltage of the servo 134 is the same as the reference voltage of the integrated orientation signal produced by the integrator of the driver 132, however, the deviations from the reference voltage are in opposite directions compared to the corresponding deviations of the integrated orientation signal from its own reference voltage as described above.

In this embodiment, to ensure proper vertical alignment of the incident laser beam 112, the driver 132 receives the orientation signal from the orientation monitoring device 130, in response to which it produces the integrated orientation signal as described above. The driver 132 also receives the electrical feedback signal from the servo 134. If the voltage and polarity of the integrated orientation signal do not precisely equal the voltage and polarity of the electrical feedback signal, the driver 132 supplies electrical power to the servo 134, the polarity of such power being determined by the sign of the difference between the voltages of the feedback and integrated orientation signals, to cause the servo to rotate the beam directing device 124. Such rotation in turn alters the voltage (and possibly polarity) of the electrical feedback signal produced by the servo, until the difference between the feedback and integrated orientation signals is reduced to zero, at which point no further power is supplied by the driver to the servo. For example, if the aircraft 100 is initially flying in a perfectly horizontal plane, with the beam directing device also horizontal, the orientation and electrical feedback signals are both at the reference voltage, and the difference is zero. If the aircraft then “rolls”, or more particularly, positively rotates by an angle φ about its central axis pointing in its flight direction, the integrator of the driver 132 receives orientation signals from the orientation monitoring device 130, in response to which it produces an integrated electrical orientation signal exceeding the reference voltage in proportion to the angle φ by which the aircraft has rolled. At the instant of such a roll, before the servo reacts, the feedback signal produced by the servo is still at the reference voltage. The driver 132 supplies power to the servo 134 whose polarity is determined by the sign of the difference between the feedback and integrated orientation signals, which in this case is negative, causing the servo to rotate the beam directing device 124 in a negative direction. Such negative rotation also causes the servo 134 to produce a positive electrical feedback signal whose voltage exceeds the reference voltage in proportion to the amount by which the servo has rotated the beam directing device relative to the aircraft. Such negative rotation continues until the servo has rotated the beam directing device in a negative direction by the same angle as the aircraft has rotated in a positive direction, at which point the feedback and integrated orientation signals are equal and the driver ceases supplying power to the servo. It will be appreciated that at this point, the beam directing device 124 will once again be directing the incident laser beam 112 vertically downwards, having effectively corrected for any such roll of the aircraft 100.

Alternatively, other suitable motion mechanisms may be substituted for the motion mechanism 128. In this regard, for many applications it is desirable to be able to provide roll correction accurate to ±0.01 radians. Similarly, if desired, correction for pitch and/or yaw may be substituted or added.

In this embodiment, further manual fine adjustment of the vertical orientation of the beam may be performed if desired. For example, the servo 134 may include a manual adjustment control (not shown) which allows the zero-point of the servo (i.e., the angle at which the servo produces the electrical feedback signal at the reference voltage) to be manually adjusted. The aircraft 100 may then fly over calm (flat) water, with the aircraft flying in a level horizontal plane, and the orientation of the servo, and hence of the beam directing device 124, may be finely manually adjusted to provide a maximum return signal level of the laser beam 114 scattered by the environment.

If desired, the laser system 62 may include additional optical components (not shown). In this embodiment, the laser system 62 is installed in the aircraft 100, with the laser 120, the beam directing device 124, the servo 134, the light stopper 126 and the detector 122 installed in a baggage pod area of the aircraft 100. The orientation monitoring device 130, driver 132, and related electronic components, including the central processing system 60 shown in FIG. 2, are installed within a cabin area of the aircraft. In the present embodiment, suitable windows (not shown) are installed to prevent debris from entering the baggage pod, and to allow the laser beam to exit without attenuation.

Also in this embodiment, the laser system 62 may be calibrated prior to use if desired. For example, the incident laser beam 112 may be directed at a nearby low-reflectivity target (not shown) on the ground prior to takeoff of the aircraft 100, and neutral density filters (not shown) may be interposed between the target and the detector 122 to simulate attenuation that would be experienced at flight altitudes. The resulting data produced by the central processing system 60 representing the distance to the target may be compared to the known distance to the target, and calibration may then be performed if required.

Radar Transmission System

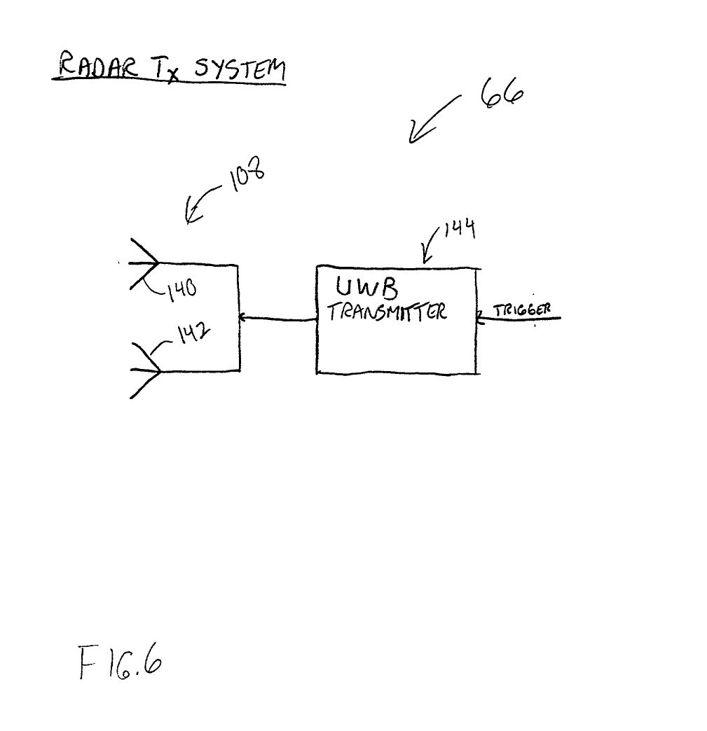

Referring to FIGS. 2, 3, 4 and 6, the radar transmission system is shown generally at 66 in FIG. 6. In this embodiment, the radar transmission system 66 includes the transmission antenna system 108, which in this embodiment includes first and second transmission antennae 140 and 142 respectively. In this embodiment, each of the transmission antennae is tuned to a bandwidth (3 dB) of 180-420 MHz, has an efficiency in excess of 25%.

In this embodiment, the radar system 64, or more particularly the radar transmission system 66, is configured to direct to the environment 104, as the incident radar beam 102, an ultra-wide band (UWB) radar beam. The radar transmission system directs the UWB incident radar beam to the environment 104, to produce the radar beam 106 scattered by the environment. To achieve this, in the present embodiment the radar transmission system 66 includes an ultra-wide band (UWB) transmitter 144, in communication with the transmission antenna system 108.

In the present embodiment the UWB transmitter 144 receives a triggering signal from the central processing system 60 shown in FIG. 2, at a desired rate at which UWB radar pulses are to be produced. In this embodiment, it is desirable to produce radar pulses at a rate of at least one per meter of travel of the aircraft 100, which in this embodiment typically flies at a groundspeed of less than 270 km/h or 75 m/s. Accordingly, in this embodiment the desired pulse repetition rate is 75 radar pulses per second.

In response to each triggering signal received from the central processing system 60, which in this embodiment is received once every 1/75^{th} of a second, the UWB transmitter 144 generates and transmits an electrical impulse signal to the transmission antenna system 108. More particularly, in this embodiment the impulse signal is a unipolar impulse signal having a duration of approximately 3.3 ns, a voltage of approximately 1 kV, a rise time (10-90%) of less than 1 ns and a pulse width (3 dB points) of 1.7±0.3 ns. The UWB transmitter in the present embodiment produces such impulse signals to have a short-term phase jitter of less than 50 ps over a 10 s period and a long-term jitter of less than 250 ps over a 30 minute period. In this embodiment the UWB transmitter 144 includes a transmitter manufactured by the loffe Research Institute of St. Petersburg, Russia operable to produce a 10 kV impulse signal, and further includes an attenuator (not shown) to produce the desired 1 kV impulse signal. Alternatively, other types of impulse signals and/or other types of UWB transmitters may be substituted, such as a model AVG-3B-C transmitter manufactured by Avtech Electrosystems Ltd. of Ottawa, Canada, for example. It is preferable, however, that the UWB transmitter be capable of accurately producing unipolar impulse signals as described above, and be capable of accurately operating at ambient temperatures of at least 27° C. (80° F.).

In response to the impulse signal, the transmission antenna system produces and tune a 3.3 ns electromagnetic radar pulse over an ultra-wide band frequency range between 200 MHz and 400 MHz. More particularly, in this embodiment the transmission antenna system 108 produces the radar pulse at a power ranging from approximately 9 W at 200 MHz to 1.5 W at 400 MHz.

In the present embodiment the transmission antenna system 108 is configured to produce the radar pulse to extend over a spot size of the environment 104 of approximately 25 m per 1000 ft (300 m) AGL, or in other words, to have a beam width of approximately 5°.

It will be appreciated that the wavelength of the UWB radar pulse in the present embodiment ranges from 1.5 m to 0.75 m, with the center frequency of 300 MHz having a wavelength of 1 m. Therefore, by order of magnitude, the radar transmission system 66 of the radar system 64 is configured to transmit, as the incident radar beam 102, a radar beam having a wavelength of at least on the order of one meter. Thus, in this embodiment the wavelength of the incident radar beam 102 is between 0.7 and 2 m. Alternatively, however, other wavelengths may be substituted, although it is noted that wavelengths longer than 2 m tend to result in poorer resolution, while wavelengths shorter than 0.7 m tend to result in poorer ground penetration.

More generally, other radar transmission systems may be substituted.

Radar Reception System

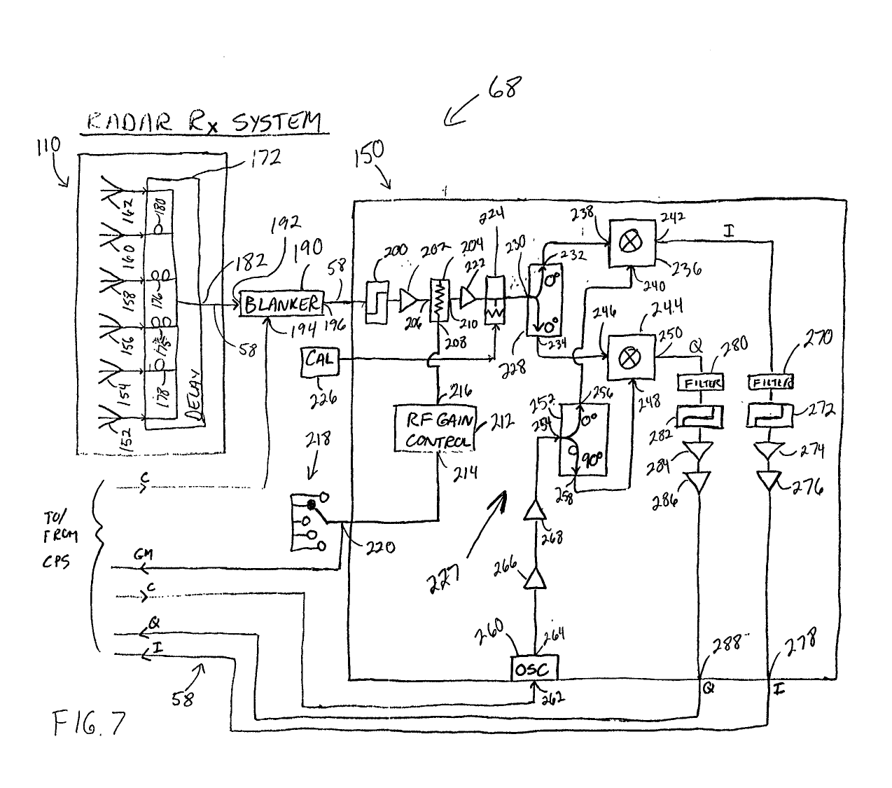

Referring to FIGS. 2, 3, 4 and 7, the radar reception system of the radar system 64 is shown generally at 68 in FIG. 7.

In the present embodiment, the radar reception system 64 is installed in the aircraft 100 shown in FIG. 3, and may therefore be referred to as an airborne radar reception system or receiver. As the radar transmission system 66 in the present embodiment transmits, as the incident radar beam 102, a radar beam having a wavelength of at least on the order of one meter, the radar reception system 68 is therefore configured to receive, as the radar beam 106 scattered by the environment 104, a radar beam having a wavelength of at least on the order of one meter. More particularly, in this embodiment the radar reception system is configured to receive, as the radar beam scattered by the environment, a radar beam having a wavelength between 0.7 and 2 meters, or more particularly still, between 0.75 and 1.5 meters.

Generally, in the present embodiment, the radar reception system 68 is operable to produce signals, or more particularly the second signals 58, in response to the radar beam 106 scattered by the environment 104.

In this embodiment, the radar reception system 68 includes the reception antenna system 110, and further includes a receiver shown generally at 150.

Referring to FIGS. 2 and 7, in the present embodiment, the reception antenna system 110 includes first, second, third, fourth, fifth and sixth antennae 152, 154, 156, 158, 160 and 162 respectively. In this present embodiment, the first, second and third antennae 152, 154 and 156 are mountable on a port wing 164 of the aircraft 100 shown in FIG. 2, while the fourth, fifth and sixth antennae are mountable on a starboard wing 166, symmetrically opposite the first, second and third antennae. More particularly, in the present embodiment the antennae 152 through 162 are mounted orthogonally with respect to a forward direction of flight of the aircraft 100, so that nulls in the resulting antenna pattern are projected to the sides of the flight path.

In this embodiment the antennae 152 through 162 are constructed in three stages. Stand-off pieces, such as that shown at 168 in FIG. 2 for example, are fabricated from aluminum strut material, and are cut and welded so as to mount the antennae, such as that shown at 170, a distance of one-quarter wave from each of the wings 164 or 166. In this embodiment, the center frequency of the UWB pulse has a wavelength of 1 m, and therefore, each stand-off piece is constructed to mount each respective antenna 0.25 m below its respective wing. Next, an antenna electrical section or active element is constructed as a broadband fat dipole with resistive loading, and is laid upon G-100.25″ board. Finally, the active element is encased in fiberglass to form the antenna, such as the antenna 170 for example, which is then attached to the stand-off piece. Each antenna may then be tested for electrical performance, and for mechanical load carrying capacity in accordance with FAA directives. In this embodiment, each of the resulting antennae is tuned to a bandwidth (3 dB) of 180-420 MHz, and has an efficiency in excess of 25%.

In the present embodiment the radar system 64, or more particularly the reception antenna system 110, further includes a delay device 172, operable to delay signals produced by at least some of a plurality of antennae (or more particularly, the antennae 152 through 162) of the reception antenna system 110.

In this regard, it will be appreciated that for the purpose of measuring the environment 104 at a point directly beneath the aircraft 100, portions of a radar pulse scattered or reflected by such a point will arrive at the antennae closest to a fuselage 174 of the aircraft 100 slightly before portions of the same pulse scattered by the same point arrive at the antennae mounted further from the fuselage 174, which are geographically further away from the point of the environment 104. This effect diminishes as altitude of the aircraft 100 increases, as the angle formed by the antenna most distal from the fuselage, the point of the environment 104, and the antenna most proximal to the fuselage, decreases with increasing altitude.

Accordingly, in order to improve the synchronization of the electrical signals produced by the antennae 152 through 162 in response to a given radar pulse scattered by the environment, it is desirable to introduce a delay into the electrical signals produced by each of the antennae, in inverse proportion to its distance from the fuselage and the altitude of the aircraft. Although the actual amounts of such delays will vary from application to application depending on altitude and the spacing and configuration of the antennae, a simplified model may be demonstrated for illustrative purposes. For example, assuming that the port and starboard wings 164 and 166 lie in a horizontal plane and extend perpendicular to a central axis (not shown) of the fuselage 174, and assuming the antennae are mounted in the order shown in FIG. 7, i.e., with the antenna 152 at the outer edge of the port wing 164 a distance S₁₅₂ from the central axis of the fuselage, antenna 154 mid-way along the port wing a distance S₁₅₄ from the fuselage, and antenna 156 at an inner portion of the port wing a distance S₁₅₆ of the fuselage, then geometrically, the relative delay time that is desirable for antenna 156 may be shown to be:

$${t}_{156} = \frac{\sqrt{{h}^{2} + {S}_{152}^{ 2}} - \sqrt{{h}^{2} + {S}_{156}^{ 2}}}{c} \qquad ( 1 )$$

wherein

t₁₅₆=the desired delay time for antenna 156, in seconds;

h=the height of the horizontal plane in which the antennae 152 and 156 lie when the aircraft 100 is flying level, above the point of interest of the environment, in meters (for present purposes, this height may be assumed to equal the altitude of the aircraft 100);

S₁₅₂=the horizontal distance between the antenna 152 and the central axis of the fuselage 174, in meters;

S₁₅₆=the horizontal distance between the antenna 156 and the central axis of the fuselage 174, in meters; and

c=the speed of light, in meters per second.

Similarly, the desired delay for the antenna 154 is:

$${t}_{154} = \frac{\sqrt{{h}^{2} + {S}_{152}^{ 2}} - \sqrt{{h}^{2} + {S}_{154}^{ 2}}}{c} \qquad ( 2 )$$

and no delay is required for antenna 156.

Similarly, assuming the antennae 158, 160 and 162 are mounted on the starboard wing 166 symmetrically opposite the antennae 156, 154 and 152, then the delays for antennae 158 and 160 are the same as those for antennae 156 and 154 respectively, and antenna 162 is not delayed.

In order to effect such delays, in the present embodiment the delay device 172 includes a plurality of delay cables. More particularly, in this embodiment the delay cables include first and second delay cables 175 and 176 in communication with the antennae 156 and 158 respectively, for providing a delay t₁₅₆ as described above. In this regard, each of the delay cables 175 and 176 includes a 50-ohm impedance cable, in which electrical signals propagate at approximately a speed of approximately (⅔)c. Thus, the length of the delay cables 175 and 176 in the present embodiment is I₁₇₄=(⅔)ct₁₅₆. Similarly, the delay cables include third and fourth delay cables 178 and 180, in communication with the antennae 154 and 160 respectively, each of length (⅔)ct₅₄. Aside from such delay cables, each of the antennae 152 through 162 is in communication with an output port 182 of the delay device 172 along an equal length of cable, so that signals produced by each of the antennae 152 through 162 arrive at the output port 182 in an equal amount of time, except for the delays introduced by the delay cables 175 through 180.

In the present embodiment, the lengths of the delay cables 175 through 180 are calculated on the assumption of an arbitrary typical height h=1000 ft (300 m) above the hypothetical point in the environment. In this regard, in the present embodiment the delay device 172 is intended to provide relatively unfocussed delay correction, and is therefore suitable for altitudes ranging from 150 m to 450 m. However, in addition to the delay device 172, the radar reception system 68 includes further delay devices (not shown), with delay cable lengths configured for different flight altitudes. The delay device 172 in the present embodiment is configured as an easily detachable delay box, which is easily replaceable during flight with an alternative delay box with delay cables shortened or lengthened to correspond to a higher or lower flight altitude respectively.

Referring to FIGS. 2, 3, 4 and 7, in this embodiment, the radar reception system 68 further includes a blanker 190 operable to blank transmitter cross-talk signals while directing the incident radar beam 102 to the environment 104. In this regard, due to the close physical proximity of the reception antenna system 110 to the transmission antenna system 108, a portion of the incident radar beam 102 itself (as opposed to its scattered return from the environment) tends to be inadvertently received at the reception antenna system 110. In response to this directly-received portion of the incident radar beam 102, the reception antenna system 110 produces electrical signals (referred to herein as transmitter cross-talk signals) vastly more powerful than the signals it produces in response to the scattered return of the radar beam from the environment. However, as the receiver 150 is configured to receive much lower-power electrical signals produced in response to the radar beam 106 that has been scattered by the environment, the signals produced in response to the directly-received portion of the incident radar beam 102 may tend to overload or damage various components of the receiver.

To prevent such damage, in the present embodiment the blanker 190 is configured to block all electrical signals produced at the output port 182 of the reception antenna system 110, thereby preventing such transmitter cross-talk signals from reaching the receiver 150, during successive time intervals in which each successive pulse of the incident radar beam 102 pulse is transmitted by the radar transmission system 66. To achieve this, in the present embodiment the blanker 190 includes an input port 192 for receiving the second signals 58 from the reception antenna system 110, a control input port 194 for receiving control signals from the central processing system 60, and an output port 196 for forwarding the second signals 58 to the receiver 150. In this embodiment, as discussed in greater detail below, the blanker 190 receives control signals at the control input port 194 from the central processing system 60, causing it to commence blanking the transmitter cross-talk signals received from the reception antenna system 110 at a first time preceding transmission of each successive pulse of the incident radar beam 102, and to cease blanking such signals at a second time following the transmission of each such pulse. As discussed in greater detail below, the interval defined between the first and second times is selected so as to be long enough to blank any transmitter cross-talk signals produced in response to the incident radar beam 102, but not to blank any signals produced in response to the radar beam 106 scattered by the environment 104.

Referring to FIGS. 2, 3 and 7, in this embodiment the second signals 58 produced by the reception antenna system 110 in response to the radar beam 106 scattered by the environment 104, are then received at the receiver 150 shown in FIG. 7 (except during blanking intervals of the blanker 190).

Generally, the receiver 150 serves to adjust the amplitude and frequency of the second signals 58, for the purpose of subsequent digitization. With respect to signal amplitude, the purpose of the receiver 150 in the present embodiment is to supply the second signals 58 to a digitizer (discussed below) such that a background noise level of the second signals has sufficient amplitude to toggle a least significant bit of the digitizer, and a maximum or saturation level of the second signals has just enough amplitude to toggle a most significant bit of the digitizer.

With respect to frequency, the receiver 150 serves to down-shift the frequency of the second signals 58 to less than half of the sampling rate of the digitizer, to permit digitization without Nyquist aliasing that would otherwise result. In this regard, in the present embodiment the receiver 150 receives the second signals 58, frequency-shifts the second signals, and outputs the second signals as in-phase frequency-shifted signals and in-quadrature frequency-shifted signals, both of which range from baseband to half the original bandwidth of the second signals (0-100 MHz). The receiver 150 preferably has an overall noise figure of 3 dB, a dynamic range of 48 dB, a bandwidth (3 dB) in excess of 200 MHz, and a phase linearity of 30 degrees.

In this embodiment, to achieve the foregoing purposes, the second signals 58 are first received at a limiter 200 of the receiver 150, which in this embodiment is a −1 dB limiter. The limiter 200 serves a purpose similar to that of the blanker 190, to prevent inadvertent overload of various components of the receiver 150 in the event that the signal levels of the second signals 58 received from the reception antenna system 110 dramatically exceed expected values. In this embodiment the limiter 200 effectively clips or limits the signal excursion of the second signals, limiting their signal level to +13 dBm, or about ±1 V.

In this embodiment, signals output from the limiter 200 are then received at a an amplifier 202, which in this embodiment is a low-noise +15 dB amplifier.

Referring to FIGS. 2 and 7, in the present embodiment, following such low-noise amplification, the amplified second signals 58 output from the amplifier 202 are received at an attenuator 204, which in this embodiment is operable to adjustably attenuate the second signals. More particularly, in this embodiment the attenuator 204 includes an input port 206, a control input port 208 and an output port 210. The attenuator 204 is in communication with a radio frequency (RF) gain control device 212, which includes a control input port 214 and a control output port 216. The RF gain control device 212 is in further communication with a manual gain control device 218, which in this embodiment is a five-position manual switch. In response to user actuation of the manual gain control device 218, to place the switch in one of five positions shown in FIG. 7, the manual gain control device produces a respective one of five corresponding distinct control signals, which is received at the control input port 214 of the RF gain control device 212.

The manual gain control device further includes a gain monitor connection 220, which is in communication with the central processing system 60 shown in FIG. 2, to provide the central processing system with an indication of the gain or attenuation level at any given time.

In this embodiment, the five positions of the manual gain control device 218 correspond to various flight altitudes. For example, in this embodiment a first switch position corresponds to a flight altitude of 1000 ft or higher, for which minimal or no attenuation is desired, and conversely, a fifth switch position corresponds to a flight altitude of 50 ft, for which a maximum attenuation is desired, due to the high intensity of the radar beam 106 scattered by the environment as detected from such a low altitude, and the remaining switch positions correspond to intervening altitudes for which respective intermediate attenuation levels are desired. Alternatively, if desired, the central processing system may be placed in communication with an on-board navigation computer (not shown) of the aircraft 100, and may automatically adjust the attenuation of the second signals 58 in response to altitude of the aircraft.

In response to the control signal received at its control input port 214, the RF gain control device 212 in the present embodiment produces a control signal at its output port 216 at one of five discrete current levels corresponding to the particular control signal produced by the manual gain control device 218.

In this embodiment the control signal produced at the control output port 216 of the RF gain control device 212 is received at the control input port 208 of the attenuator 204. In the present embodiment, the attenuator 204 attenuates the second signals 58 received at its input port 206 by an amount corresponding to the current of the control signal received at its control input port 208, and supplies the attenuated second signals 58 at the output port 210 of the attenuator. More particularly, in this embodiment the attenuated second signals 58 produced at the output port 210 are adjustably attenuated between 0 dB and −30 dB relative to their strength upon arrival at the input port 206. More particularly still, in this embodiment the five attenuation levels corresponding to the five positions of the manual gain control device 218 are 0 dB, 6 dB, 12 dB, 20 dB and 30 dB respectively.

In this embodiment, the attenuated second signals 58 produced at the output port 210 of the attenuator 204 are then received at an amplifier 222. In this embodiment, the amplifier 222 is a +31 dB voltage amplifier.

In the present embodiment the amplified second signals 58 produced by the amplifier 222 are then supplied to a combiner 224, which is in communication with a calibration signal generator 226. More particularly, in this embodiment the calibration signal generator 226 produces a calibration signal at a frequency within the range of the UWB pulse produced by the radar transmission system 66. More particularly still, in this embodiment the calibration signal generator 226 produces, as the calibration signal, a sine wave signal at a frequency of 320 MHz, at a level of 0 dBm.

The combiner 224 receives the calibration signal, attenuates it by −66 dB, and inserts the attenuated −66 dBm calibration signal into the second signals 58. As discussed in greater detail below, the calibration signal may be used to provide phase and amplitude tracking between I and Q channels and to monitor channel balance and digitizing errors.

Referring to FIGS. 2, 3, 4 and 7, in this embodiment, the second signals 58, now including the calibration signal, are then supplied to a frequency-shifter, shown generally at 227 in FIG. 7. In the present embodiment the frequency-shifter 227 is operable to produce the second signals 58 by producing frequency-shifted signals in response to the radar beam 106 scattered by the environment. More particularly, in this embodiment the frequency-shifted signals correspond to sum and difference frequencies resulting from mixing initial electrical signals produced in response to the radar beam 106 with a mixing frequency.

In this regard, in this embodiment the radar system 64, or more particularly the radar reception system 68, is configured to produce the second signals 58 by first producing initial electrical signals at frequencies of the radar beam 106 scattered by the environment 104, in response thereto. More particularly, in this embodiment such frequencies include frequencies between 200 and 400 MHz, and the initial electrical signals, such as those output from the combiner 224 for example, are produced at these frequencies. It will be appreciated that in order to accurately digitally sample 400 MHz signals to avoid aliasing, it would be necessary to sample at a rate greater than the Nyquist frequency of 800 MHz for such signals. However, it has been found that many commercially-available digitizers tend to be unreliable at sampling rates significantly greater than 500 MHz. For example, some such digitizers interleave two separate 500 MHz sampling frequencies, which tend to drift apart over time. In order to address this difficulty, the frequency-shifter 227 serves to down-shift the frequencies of the second signals 58, to frequencies below 250 MHz (or more particularly, baseband frequencies below 100 MHz), to allow the second signals 58 to be reliably sampled with a commercially-available 500 MHz digitizer.

To achieve this, in the present embodiment the frequency-shifter 227 includes a mixer operable to produce the frequency-shifted signals in response to the initial electrical signals and a mixing frequency signal. More particularly, in this embodiment the frequency-shifter 227 includes a power splitter 228, a first mixer 236, a second mixer 244, a phase-shifter 252, an oscillator 260, and amplifiers 266 and 268.

More particularly still, in this embodiment the second signals 58 output from the combiner 224 are first received at an input port 230 of the power splitter 228. The power splitter 228 simultaneously supplies the incoming second signals 58 to a first output port 232 and a second output port 234, effectively dividing the second signals into a first channel and a second channel, each identical to the incoming second signals 58 except for their respective energy levels. In this regard, the power splitter 228 equally divides the energy of the second signals 58 among the two channels, and therefore, each channel of the second signals 58 produced at the first and second output ports has a signal strength of −3 dB relative to the strength of the second signals 58 received at the input port 230. In this embodiment the two channels of the second signals 58 are supplied at identical phase to the output ports 232 and 234, which supply the first and second channels to the first and second mixers 236 and 244 respectively.

Generally, in this embodiment the mixers 236 and 244 receive the first and second channels of the second signals 58, and also receive mixing frequency signals, in response to which the mixers frequency-shift the second signals 58.

In order to produce the mixing frequency signals, in this embodiment the receiver 150 includes the oscillator 260, which is configured to produce a mixing frequency signal at the center frequency of the ultra-wide band of the radar beam 106 scattered by the environment, which in this embodiment is 300 MHz. The oscillator 260 receives a control signal from the central processing system 60 at a control signal input port 262, which in this embodiment includes a 10 MHz clock signal. In response to the received control signal, the oscillator 260 produces a phase coherent 300 MHz mixing frequency signal, at a signal level of −4 dBm, at an output port 264 of the oscillator.

The 300 MHz mixing frequency signal is then received and amplified by the amplifiers 266 and 268, which in this embodiment include a +6 dB amplifier and a +8 dB amplifier respectively. Alternatively, one or more other amplification devices may be substituted.

The amplified mixing frequency signal is then supplied to an input port 254 of the phase-shifter 252. In this embodiment, the phase-shifter 252 includes a hybrid coupler which simultaneously supplies the received amplified mixing frequency signal to first and second output ports 256 and 258, effectively defining two mixing frequency channels. In this regard, the phase-shifter 252 divides the energy of the incoming amplified mixing frequency signal equally among the two channels, so that the mixing frequency signal produced at each of the output ports 256 and 258 has a signal level of −3 dB relative to the signal level of the mixing frequency signal received at the input port 254 (more particularly, each of the two signals is produced at +7 dBm). However, in this embodiment the phase-shifter 252 introduces a 90° or one-quarter cycle phase delay in the mixing frequency signal produced at the second output port 258 relative to that produced at the first output port 256 of the phase-shifter. The mixing frequency signals produced at the output ports 256 and 258 are then supplied to the mixers 236 and 244.

In this embodiment, the frequency-shifter 227 is operable to produce, as the frequency-shifted signals, in-phase frequency-shifted signals and in-quadrature frequency-shifted signals. In this regard, in the present embodiment, as discussed below, the center frequency of the second signals 58 is effectively down-shifted from 300 MHz to baseband (0 MHz), so that the frequency-shifted second signals 58 include both positive (real) frequencies between 0 and 100 MHz, as well as negative frequencies between −100 MHz and baseband. Accordingly, in order to fully represent the second signals 58, including such negative frequencies, both an in-phase component and an in-quadrature component (each from 0 to +100 MHz) are required in order to express the second signals as complex vectors or phasors having respective real and imaginary components.

To produce the in-phase frequency-shifted signals, in the present embodiment the mixer 236 includes an input port 238, a mixing signal input port 240, and an output port 242. At the input port 238, the mixer 236 receives the first channel of the second signals 58 supplied from the output port 232 of the power splitter 228. In addition, at the mixing signal input port 240, the mixer 236 receives the mixing frequency signal from the first output port 256 of the phase-shifter 252. In response to the first channel of the second signals and the mixing frequency signal, the mixer 236 frequency-shifts the first channel of the second signals 58 to produce frequency-shifted signals, which are supplied at the output port 242. More particularly, it will be appreciated that the mixer 236 will produce a number of difference and sum frequency range, including a first difference frequency range f_{UWB}−f_{M}, a first sum frequency range f_{UWB}+f_{M}, and so on, where f_{UWB} is the frequency range of the second signals 58 upon arrival at the input port 238 (in this embodiment, 300±100 MHz), and f_{M} is the mixing frequency (in this embodiment 300 MHz). Thus, in this embodiment the first difference frequency range is 0±100 MHz, and the first sum frequency range is 600±100 MHz.

Similarly, to produce the in-quadrature frequency-shifted signals, in this embodiment the mixer 244 includes an input port 246, a mixing signal input port 248, and an output port 250. At the input port 246, the mixer 236 receives the second channel of the second signals 58 supplied from the output port 234 of the power splitter 228. In addition, at the mixing signal input port 248, the mixer 244 receives the mixing frequency signal from the second output port 258 of the phase-shifter 252, which in this embodiment is phase-delayed 90° relative to the mixing frequency signal received at the mixer 236. In response to the second channel of the second signals and the phase-delayed mixing frequency signal, the mixer 244 frequency-shifts the second channel of the second signals 58 to produce frequency-shifted signals, which are supplied at the output port 250. More particularly, in this embodiment the mixer 244 produces a number of difference and sum frequency ranges identical to the frequency ranges produced by the mixer 236, including the first difference frequency range of 0±100 MHz. However, in this embodiment the frequency-shifted signals produced by the mixer 244 at such frequencies are phase-delayed by 90° relative to the corresponding signals produced at the mixer 236, due to the phase-delay of the incoming mixing frequency signal received at the mixer 244.

Thus, as a result of the frequency-shifter 227, the second signals 58 are effectively divided into an in-phase frequency-shifted channel produced at the output port 242 of the mixer 236 (hereinafter referred to as the “I” channel), and an in-quadrature frequency-shifted channel produced at the output port 250 of the mixer 244 (hereinafter referred to as the “Q” channel).

The I-channel signals are then received at a filter 270, which in this embodiment includes a 100 MHz low-pass filter. The filter 270 serves to remove all “sum” signals produced by the mixer 236, such as the first sum frequency range of 600±100 MHz for example, and passes only the first difference frequency range of 0±100 MHz, or more particularly, the 0-100 MHz real component of such frequencies.

In this embodiment, the 0-100 MHz I-channel signals are then received at a limiter 272, followed by successive amplifiers 274 and 276. In this regard, it will be appreciated that many typical amplifiers have poor responses, including significant drift and phase distortion, at frequencies below 10 MHz. Accordingly, in order to provide adequate amplification of the frequency-shifted 0-100 MHz I-channel signals, the amplifiers 274 and 276 include respective baseband amplifiers, sometimes referred to as video amplifiers, capable of amplifying the I-channel signals with minimal drift and phase distortion across the entire range from DC (O MHz) to 100 MHz. More particularly, in this embodiment the amplifier 274 includes a +31 dB baseband amplifier, and the amplifier 276 includes a +15 dB baseband amplifier.

As such baseband amplifiers are typically expensive, the limiter 272 serves to provide added protection for the baseband amplifiers against overloads, which may arise due to saturation of upstream amplifiers, coupling between cables, poor shielding, etc. In the present embodiment the limiter 272 is a hard limiter operable to clip or limit the power of incoming I-channel signals to prevent overload of the baseband amplifiers 274 and 276.

Amplified I-channel signals from the baseband amplifier 276 are then communicated, via an I-channel exit port 278 of the receiver 150, to the central processing system 60 shown in FIG. 2.

Similarly, in this embodiment, Q-channel signals from the mixer 244 are passed through a filter 280, a limiter 282, and baseband amplifiers 284 and 286, which are identical to the corresponding I-channel components 270, 272, 274, 276. Q-channel signals are processed by such components in the same manner as described above in connection with the I-channel signals, and are then communicated, via a Q-channel exit port 288, to the central processing system 60.

Thus, following processing by the receiver 150 as described above, the second signals 58 produced in response to the radar beam 106 scattered by the environment 104 are transmitted to the central processing system 60 in the form of 0-100 MHz I-channel signals, and 0-100 MHz Q-channel signals in quadrature with the I-channel signals.

If desired, prior to use of the radar reception system 68 to measure the environment 104, the calibration signal inserted by the calibration signal generator 226 and combiner 224 may be used to balance the I-channel and Q-channel signals. For example, a network analyzer may be connected to the I-channel and Q-channel exit ports 278 and 288. The calibration signal, which in this embodiment was generated as a 320 MHz sine-wave and down-shifted to 20 MHz by the frequency-shifter 227, may be decomposed from the I-channel and Q-channel signals using any suitable method (such as a fast Fourier transform, for example). If the amplitudes of the decomposed calibration signals of the I-channel and Q-channel signals do not match, or if they are not precisely 90° out of phase, then various components of the receiver 150, such as the amplifiers or phase-shifter for example, may be adjusted until the I-channel and Q-channel calibration signals are balanced, with equal amplitude and the desired 90° phase difference. In this embodiment, such calibration is performed once per flight mission. However, if in a given embodiment the receiver 150 is particularly unstable, it may be desirable to perform such calibration more often, such as once per flight line for example. Alternatively, if desired, rather than performing such calibration in response to the analog signals produced at the I-channel and Q-channel exit ports 278 and 288, such calibration may be performed in response to corresponding digital signals produced by the central processing system, as described below.

Central Processing System

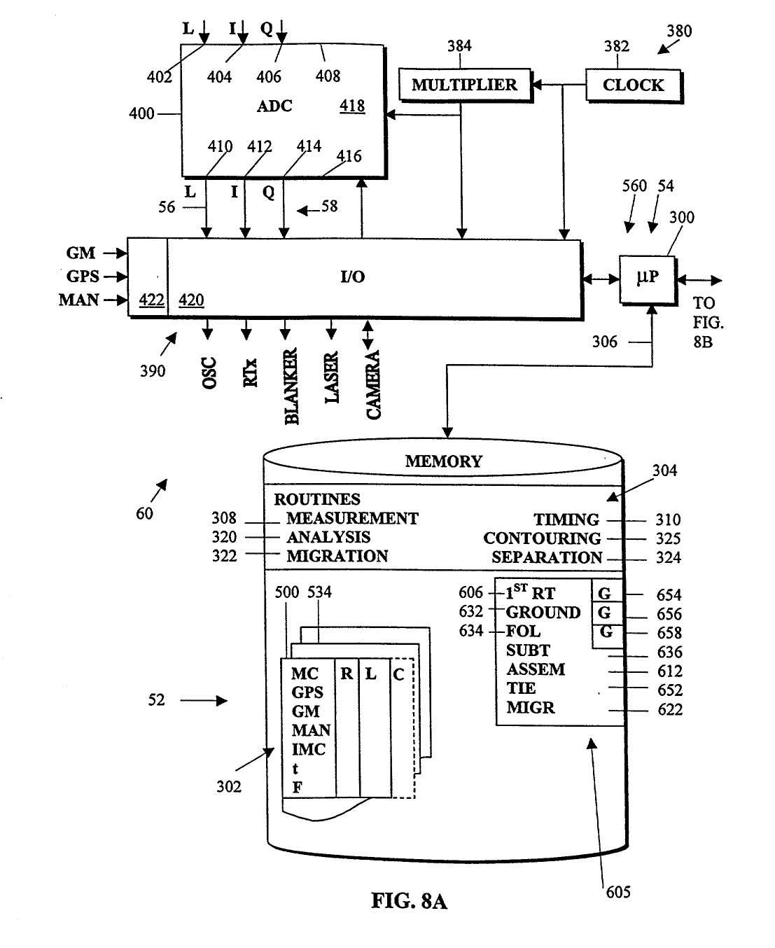

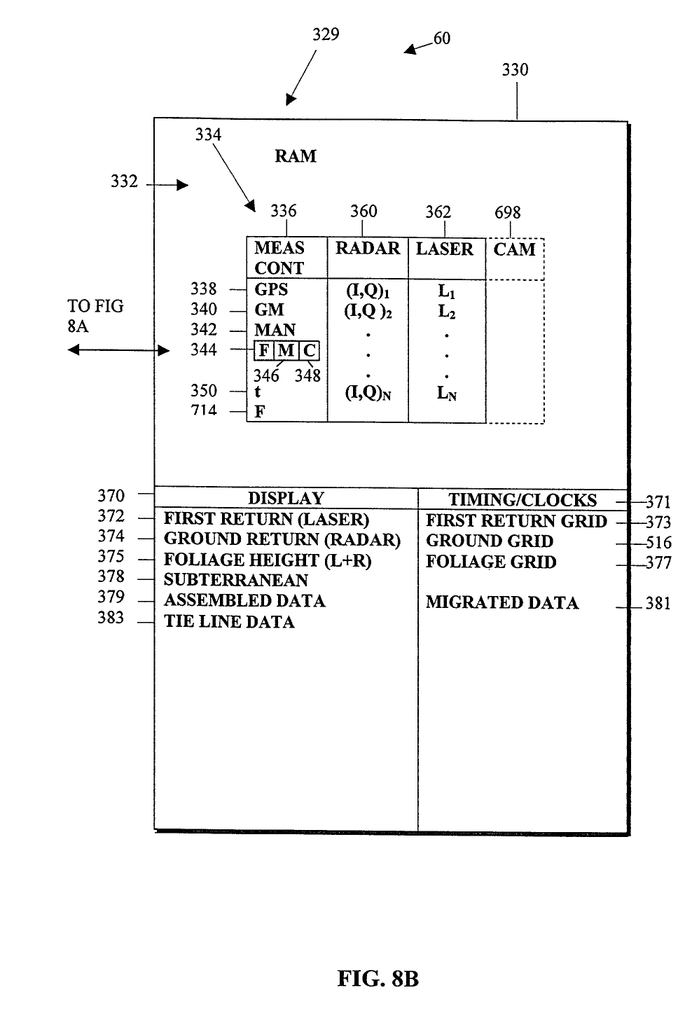

Referring to FIGS. 2, 4 and 8 (comprising FIGS. 8a and 8b), the central processing system (CPS) is shown generally at 60 in FIG. 8. In this embodiment, the CPS 60 includes the processor circuit 54, which in this embodiment includes a microprocessor 300, or more particularly, a 1.3 GHz Pentium-4 microprocessor. More generally, however, in this specification including the claims, the term “processor circuit” is intended to broadly encompass any type of device capable of processing signals for the purposes described herein, including (without limitation) other types of microprocessors, microcontrollers, other integrated circuits, other types of circuits or combinations of circuits, logic gates or gate arrays, or programmable devices of any sort, either alone or in combination with other such devices located at the same location or remotely from each other, for example.

The processor circuit 54 is in communication with the memory device 52, which in this embodiment includes a hard disk drive. Alternatively, however, any other suitable memory device, such as compact discs (CDs), other types of magnetic disks or diskettes, optical storage devices, magnetic tapes, random access memories (RAMs), programmable read-only memories such as EPROMs, EEPROMs or FLASH memories, for example, or any other type of memory device, either at the location of the processor circuit or located remotely therefrom, may be substituted if desired.

In this embodiment the memory device 52 is used to store data shown generally at 302 representing the first and second signals 56 and 58, for use in producing a representation of the environment 104. In the present embodiment the memory device 52 also acts as a computer readable medium providing instructions, including a plurality of routines shown generally at 304, for directing a processor circuit to perform the functions associated with the various routines described herein. However, the hard disk drive is merely one example of a suitable memory device for either of the above purposes. Alternatively, such routines may be provided as software stored on a different medium such as those described earlier herein, for example, or available from a communications medium such as the Internet, for example.

Alternatively, such routines may be provided as signals comprising code segments for directing a processor circuit to perform similar or equivalent functions to those described herein. In the present embodiment such signals may be produced on a signal line 306 via which the processor circuit 54 and memory device 52 are in communication, however, alternatively, any other suitable way of producing such signals may be substituted.

More particularly, in the present embodiment the routines 304 include a measurement routine 308, which in turn includes a timing thread 310.

In this embodiment the routines 304 also include an analysis routine 320, which in turn includes a migration subroutine 322 and a separation subroutine 324. In this regard, in the present embodiment, the processor circuit 54 also acts as a representation processing circuit, configured to produce the representation of the environment 104 in response to the data 302 representing the first and second signals 56 and 58. Alternatively, however, for many applications it will be unnecessary to perform such analysis with the same processor circuit 54 which executes the measurement routine 308, as the analysis may typically be performed on the ground, after the aircraft 100 has landed following a flight during which the data 302 representing the first and second signals 56 and 58 has been stored. Alternatively, therefore, the representation processing circuit may include a processor circuit other than the processor circuit 54, such as a processor circuit of a land-based desktop computer, for example.

In this embodiment the analysis routine 320 further includes a contouring routine 325, which in this embodiment includes ANUDEM software, available from the Centre for Resource and Environmental Studies of the Australian National University, in Canberra, Australia. Alternatively, other contouring routines may be substituted.

In the present embodiment, the processor circuit 54 is in further communication with a second memory device 329, which in this embodiment includes a random access memory (RAM) 330.

Referring to FIGS. 2, 7, 8a and 8b, in this embodiment, the measurement routine 308 in the memory device 52 directs the processor circuit 54 to define a plurality of registers or stores in the RAM 330, including a data store 332, for storing at least one data structure such as that shown generally at 334, including a laser field 362 for storing data representing the first signals 56 and a radar beam field 360 for storing data representing the second signals 58.

In this embodiment, the data structure 334 further includes a measurement context field shown generally at 336 for storing measurement context information. In this embodiment the measurement context field 336 includes a GPS sub-field 338 for storing data received from the GPS device 80, a gain monitoring sub-field 340 for storing data representing the position of the manual gain control device 218 of the radar reception system 68, and a manual data sub-field 342 for storing user-inputted information. More particularly, in this embodiment the manual data sub-field 342 includes a flight line sub-field 344 for storing a number representing a present flight line or path of the aircraft 100, a mission sub-field 346 for storing an identification of a present flight mission (for example, a single flight mission typically comprises a plurality of flight lines), a comments sub-field 348 for storing other user-inputted information which may be relevant to the interpretation of the data 302 produced and stored during the course of the flight, and a time sub-field 350 for storing a value representing a time at which the data structure 334 was stored.

In addition, in this embodiment the data structure 334 includes the radar beam field shown generally at 360, for storing data representing the second signals 58 produced in response to a radar beam scattered (more particularly, the radar beam 106) scattered by the environment 104, and the laser field shown generally at 362, for storing data representing the first signals 56, produced in response to the laser beam 114 scattered by the environment. More particularly, in this embodiment the radar beam field 360 includes 512 successive two-byte sub-fields for storing 512 respective byte pairs, each byte pair representing a respective successive digital sample of the second signals 58, and the laser field 362 includes 512 successive one-byte sub-fields for storing 512 respective single bytes, each byte representing a respective successive digital sample of the first signals 56. In the present embodiment the data store 332 is used to generate and temporarily store a data structure such as that shown at 334, which is then stored in the memory device 52 as a block of the data 302.

In the present embodiment the measurement routine 308 also directs the processor circuit 54 to define further registers in the RAM 330, including a display buffer 370, and a timing register 371. The display buffer may be used to control the display device 94 to display a representation of the data representing the first signals 56 and/or the second signals 58 if desired. The timing register in the present embodiment is used by the processor circuit 54 as a calculation area for the purpose of generating timing signals at various frequencies in response to master timing signals.

Similarly, in this embodiment the analysis routine 320 directs the processor circuit 54 to define further registers and stores in the second memory device 329, including a first return height store 372, a first return grid store 373, a ground return height store 374, a relative foliage height store 375, a ground grid store 376, a foliage grid store 377, a subterranean data store 378, an assembled data store 379, a migrated data store 381 and a tie lines region 383. The first return height store 372 is used to store numerical representations of the height of highest portions of the environment 104, relative to a geoid, produced in response to the laser data stored in the laser fields 362 of the data 302, and the first return grid store 373 is used to store similar data formatted into a grid. The ground return height store 374 is used to store numerical representations of the height of the ground level of the environment relative to the geoid, produced in response to the radar data stored in the radar beam fields 360 of the data 302. The relative foliage height store 375 is used to store numerical representations of the height of foliage of the environment relative to ground level of the environment, produced in response to both the laser and radar data. Similarly, the ground grid store 376 and the foliage grid store 377 are used to store similar data formatted into a grid. The subterranean data store 378 is used to store a numerical representation of a subterranean region of the environment 104. The assembled data store 379 is used to store intermediate radar data for use in producing such representations. The migrated data store 381 is used to store data representing the second signals 58, to which a migration algorithm has been applied by a representation processing circuit. The tie lines region 383 includes a plurality of stores corresponding to the various other stores described in this paragraph, for storing data corresponding to a set of tie lines flown by the aircraft 100, substantially perpendicular to the main flight lines flown by the aircraft.

In this embodiment, the CPS 60 further includes a timing device shown generally at 380, for producing the master timing signals. More particularly, in this embodiment the timing device 380 includes a clock 382, which in this embodiment is an oven-controlled crystal oscillator (OCXO) available from MTI-Milliren Technologies, Inc. of Newbury Port, Mass., USA, which produces a 10 MHz clock signal, accurate to one part in 10¹⁰. Alternatively, however, any other suitable type of clock, such as an atomic clock or other crystal oscillators for example, may be substituted. The clock 382 supplies the 10 MHz clock signal to the processor circuit 54, via an I/O system shown generally at 390. In addition, in this embodiment the clock 382 supplies the 10 MHz clock signal to a multiplier 384, to the oscillator 260 shown in FIG. 7, and to the GPS device 80 shown in FIG. 2.

In the present embodiment, the multiplier 384 includes a 50× multiplier, constructed in the usual manner from phase-lock loop modules. The multiplier 384 receives the 10 MHz clock signal from the clock 382, in response to which it produces a signal having fifty cycles for each cycle of the 10 MHz clock signal. In other words, the multiplier 384 produces a 500 MHz clock signal, in response to, and synchronized with, the 10 MHz clock signal produced by the clock 382. The multiplier 384 supplies the 500 MHz clock signal to the processor circuit 54, via the I/O system 390.

In addition, the multiplier 384 supplies the 500 MHz clock signal to an analog-to-digital converter (ADC) shown generally at 400. In this embodiment, the ADC is operable to digitize the first and second signals 56 and 58. More particularly, with respect to the second signals 58, the ADC is operable to digitize frequency-shifted signals received from the I-channel and Q-channel exit ports 278 and 288 shown in FIG. 7. In the present embodiment the ADC 400 includes a digitizer capable of sampling at a rate of 500 MS/s. The ADC 400 preferably has a phase jitter of less than 50 ps over a 10 s period and less than 200 ps over a 10 minute period, is capable of operating accurately at ambient temperatures of at least 27° C. (80° F.), and preferably produces no detectable drop-outs (failures to take a sample). In the present embodiment, the ADC 400 includes a Cougar-1000 digitizer available from Acqiris Asia-Pacific of Surrey Hills, Australia, from Acqiris USA of Monroe, N.Y., USA, or from Acqiris Europe of Geneva, Switzerland. Alternatively, however, other suitable digitizers are available from various manufacturers worldwide and may be substituted.

More particularly, referring to FIGS. 2, 3, 4, 5, 7, 8a and 8b, in this embodiment the ADC 400 is capable of simultaneously receiving four separate analog channels of bandwidths up to 250 MHz at four respective input ports 402, 404, 406 and 408, digitizing each such channel at a sampling rate of 500 MS/s, and producing corresponding digital data signals at respective output ports 410, 412, 414 and 416. In this embodiment, only three such channels are used.

More particularly, in this embodiment the first input port 402 of the ADC 400 is in communication with the detector 122 shown in FIG. 5, for receiving the first signals 56 produced in response to the laser beam 114 scattered by the environment 104. The second and third input ports 404 and 406 are in communication with the radar system 64, for receiving the second signals 58 produced in response to the radar beam 106 scattered by the environment 104. More particularly, in this embodiment the input port 404 is in communication with the I-channel exit port 278 of the radar reception system 68 shown in FIG. 6 for receiving the I-channel signals of the second signals 58, and the third input port 406 is in communication with the Q-channel exit port 288 of the radar reception system for receiving the Q-channel signals of the second signals. The ADC 400 samples such signals on each of the above three channels at 500 MS/s, by producing an 8-bit digital representation of the amplitude of the sampled signal at each sampling interval.

In this embodiment the ADC 400 further includes an internal memory 418, which in this embodiment is capable of buffering or storing 128,000 such samples. The ADC 400 produces digital data signals at the output ports 410, 412 and 414, representing the first signals 56, the I-channel component of the second signals 58, and the Q-channel component of the second signals 58, respectively. These digital data signals are communicated to the processor circuit 54, via the I/O system 390.

In this embodiment, the I/O system 390 includes a high-speed I/O device 420 in communication with the ADC 400, the clock 382, the multiplier 384, and also with the laser 120 shown in FIG. 5, the UWB transmitter 144 shown in FIG. 6, and with the blanker 190 and the oscillator 260 shown in FIG. 7. More particularly, in this embodiment the high-speed I/O device 420 includes a PXI bus, in accordance with the PXI (PCI eXtensions for Instrumentation) specification.

In addition, in the present embodiment the I/O system 390 includes a low-speed I/O device 422, which in this embodiment includes a low-speed I/O buffer, in communication with the GPS device 80 and the manual input device 90 shown in FIG. 2, and with the gain monitor connection 220 shown in FIG. 7. Alternatively, other types of high-speed I/O devices, low-speed I/O devices, and/or I/O systems may be substituted.

Operation

Measurement

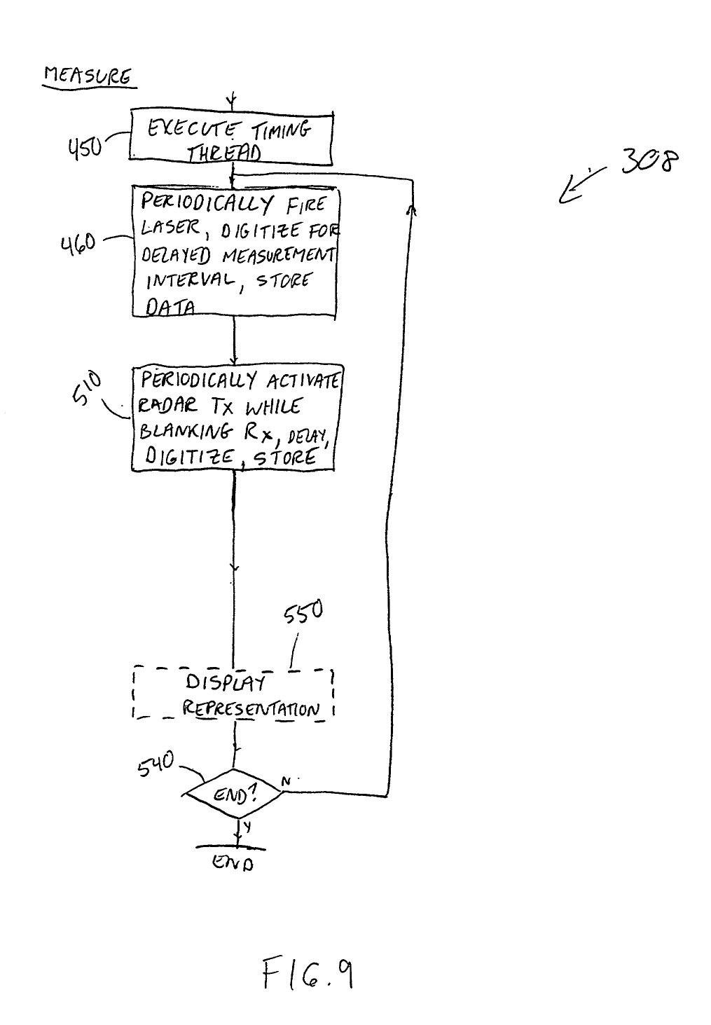

Referring to FIGS. 2 through 9, the measurement routine is shown generally at 308 in FIG. 9. Generally, the measurement routine 308 includes a plurality of blocks of codes which configure the processor circuit 54 to receive the first signals 56 produced in response to the laser beam 114 scattered by the environment 104, to receive the second signals 58 produced in response to a radar beam scattered by the environment (which in this embodiment is the radar beam 106 scattered by the environment), and to store the data 302 representing the first and second signals in the memory device 52, for use in producing a representation of the environment.

In this embodiment, execution of the measurement routine 308 is commenced in response to manual user input from the manual input device 90. In the present embodiment, to measure the environment 104, an operator of the aircraft 100 typically flies a number of substantially parallel flight lines over the environment at a substantially uniform altitude above a geoid, each of which may be 10 km long for example, over the environment, during which the environment is measured. In addition, to provide improved analytical results, in the present embodiment the aircraft 100 also flies a number of tie lines, substantially perpendicular to and intersecting the flight lines. Accordingly, in this embodiment a user of the system 50 typically awaits confirmation, either from the operator of the aircraft 100 or from monitoring navigation instruments, that the aircraft 100 has commenced its flight along a given flight line or tie line, in response to which the user actuates the manual input device 90 to commence execution of the measurement routine. Alternatively, however, other measurement techniques may be substituted, and similarly, the measurement routine may be automatically executed if desired.

In the present embodiment, the measurement routine 308 commences with a first block of codes 450 shown in FIG. 9, which directs the processor circuit 54 to commence execution of the timing thread 310. In this embodiment, the timing thread directs the processor circuit to receive the 10 MHz and 500 MHz clock signals from the clock 382 and the multiplier 384 shown in FIG. 8a, and to count the number of cycles in such signals, in order to effectively act as a divider to produce at least one synchronized lower-frequency timing signal for use in controlling various other components of the system 50. More particularly, in this embodiment, in response to the 10 MHz clock signal from the clock 382, the timing thread 310 directs the processor circuit to produce a 150 Hz timing signal for use in triggering the laser system 62, the radar transmission system 66, the blanker 190 of the radar reception system 68, and the ADC 400. In the present embodiment the timing thread 310 also directs the processor circuit to synchronize an internal system clock (not shown) of the central processing system with the clock 382.

Referring to FIGS. 3, 4, 5, 8a, 8b, 9, 10 and 11, block 460 then directs the processor circuit 54 to cause the first signals 56 to be produced in response to the laser beam 114 scattered by the environment 104, and to store data 302 representing the first signals in the memory device 52. To achieve this, in the present embodiment the processor circuit 54 monitors the 10 MHz clock signal received from the clock 382, the 500 MHz signal received from the multiplier 384, and also monitors the 150 Hz timing signal which the processor circuit produces under the direction of the timing thread 310 in response to the 10 MHz clock signal.

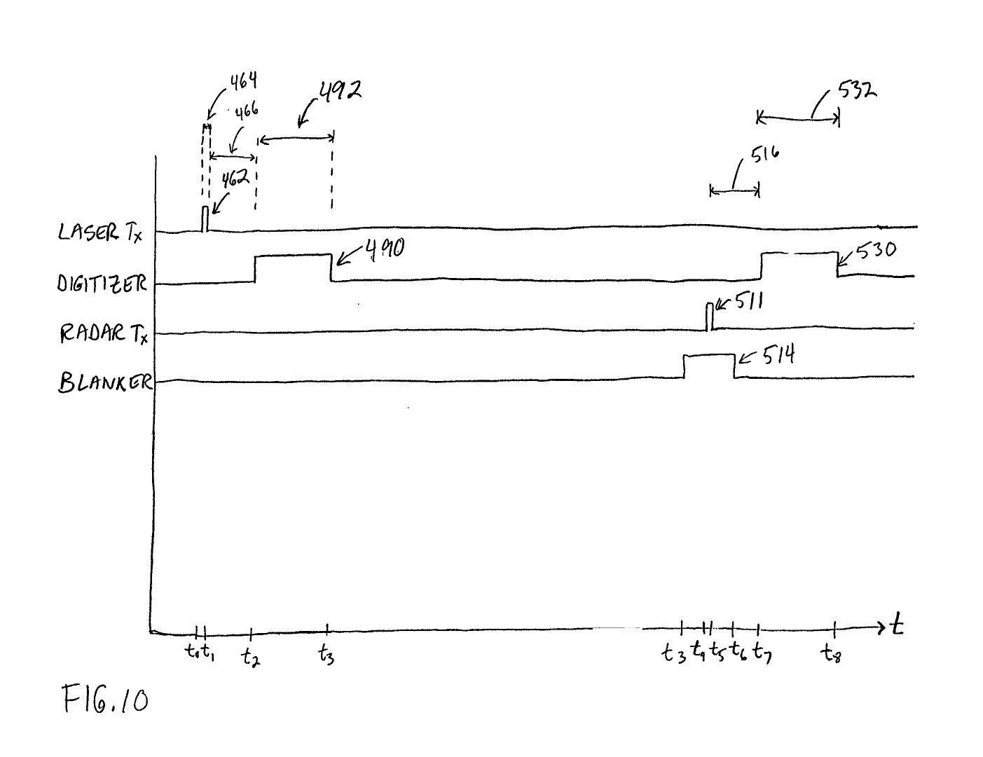

Referring to FIGS. 3, 5, 8a, 8b, 9 and 10, in this embodiment, block 460 first directs the processor circuit 54 to operate the laser 120 to produce, as the incident laser beam 112, an incident laser pulse having a duration on the order of one nanosecond, for scattering by the environment to produce scattered portions of the laser pulse. More particularly, in the present embodiment, 75 times per second, at the commencement of every even-numbered cycle of the 150 Hz timing signal (in other words, once every 133,333.33 cycles of the 10 MHz clock signal; for example, at t=0 s, 0.0133 s, 0.0267 s, etc.) block 460 directs the processor circuit 54 to control the I/O system 390 to transmit a triggering signal, such as that shown at 462 in FIG. 10, to the laser 120 shown in FIG. 5. More particularly, in this embodiment the I/O system 390 further includes a standard commercially available high-speed transistor-transistor logic (TTL) chip (not shown) operable to produce triggering signals having sub-nanosecond rise times. Alternatively, any other devices operable to produce fast rise-time triggering signals, such as a complementary metal oxide semiconductor (CMOS) chip or a macroscopic resistor-capacitor (RC) circuit configuration for example, may be substituted for the TTL chip. In this embodiment, block 460 directs the processor circuit to control the TTL chip of the I/O system 390 to produce the triggering signal 462 to have a duration 464 on the order of one nanosecond. More particularly, in this embodiment the duration 464 of the triggering signal 462 is two nanoseconds (one complete cycle of the 500 MHz clock signal). The 2 ns triggering signal 462 causes the laser 120 to transmit to the environment, as the incident laser beam 112, a laser pulse of approximately 2 ns in duration. Due to the operation of the motion mechanism 128 of the laser system 62 as described earlier herein, the incident laser beam 112 is directed vertically downward from the aircraft 100 toward the environment 104.

Block 460 then directs the processor circuit 54 to continue monitoring the 10 MHz clock signal from the clock 382, until a pre-defined delay 466 has elapsed. More particularly, in this embodiment the delay 466 is equal to 1.2 microseconds (12 cycles of the 10 MHz clock signal).

In this regard, it will be appreciated that the aircraft 100 will typically be flying at a safe height above the highest foliage, projections or other uppermost portions of the environment 104. For example, if the aircraft 100 is flying at an average altitude of 300 m (1000 ft) AGL, there will generally not be any foliage or other projections higher than 120 m AGL. Accordingly, in this example, during the first 1.2 μs microseconds (the hypothetical return travel time for the laser beam 112 to travel 180 m down and back) following the generation of the incident laser beam 112 in response to the triggering pulse 462, there is no need to produce and store data in response to any signals produced by the detector 122 of the laser system 62, as any such signals are produced in response to optical noise rather than the laser beam 114 scattered by the environment 104.

As the incident laser beam 112 strikes the environment 104, the environment scatters the incident laser beam to produce the laser beam 114 scattered by the environment. A short time following the delay 466, the detector begins to receive the laser beam 114 scattered by the environment, and begins to produce the first signals 56 in response thereto.

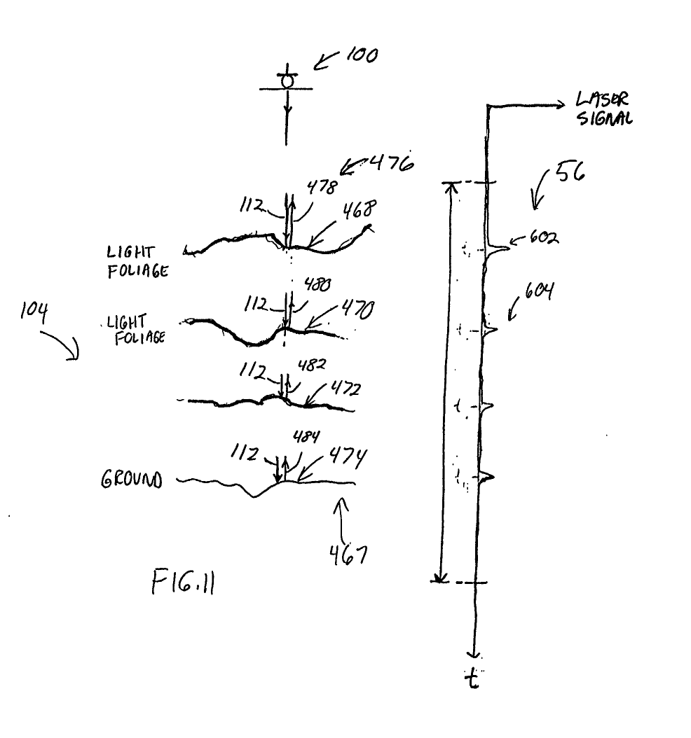

More particularly, referring to FIG. 11, at any given instant in time, there may be a plurality of portions 467 of the environment 104 directly beneath the aircraft 100, such as an upper portion 468, intermediate portions 470 and 472 and a lower portion 474 for example. In this embodiment the upper and intermediate portions include light foliage, while the lower portion 474 includes ground level. In some circumstances, for example, if the foliage portions are relatively sparse or bare tree branches and twigs, the upper portion 468 may permit at least some of the incident laser beam 112 to pass through to the intermediate and lower portions of the environment, and may similarly permit scattered portions 476 of the resulting laser beam 114 scattered by such lower portions of the environment to return to the aircraft 100 for detection. For example, as shown in FIG. 11, the scattered portions 476 produced by the environment in response to the incident laser pulse may include scattered portions 478, 480, 482 and 484, scattered by the respective portions 468, 470, 472 and 474 of the environment 104.

Accordingly, referring back to FIGS. 5, 8a, 8b, 9, 10 and 11, in this embodiment block 460 configures the processor circuit 54 to cooperate with a detection system, to continuously produce the data 302 in response to the scattered portions 476 of the laser pulse (i.e. the laser beam 114) scattered by the respective portions 467 of the environment 104, during a measurement interval of sufficient duration to receive all the scattered portions 476. More particularly, in this embodiment the detection system includes the detector 122, which is operable to receive the scattered portions 476 and to produce (as the first signals 56) analog signals in response thereto. The detection system further includes the ADC 400, and block 460 directs the processor circuit 54 to operate the ADC 400 to cooperate with the detector 122 to continuously produce digital signals in response to the analog signals, during the measurement interval.

More particularly, at the end of the 1.2 μs delay 466 shown in FIG. 10, block 460 directs the processor circuit 54 to control the TTL chip of the I/O system 390 to transmit a triggering signal to the ADC 400 shown in FIG. 7, to effectively define a measurement window such as that shown at 490 in FIG. 10, having a duration or measurement interval 492 of at least on the order of one microsecond. More particularly still, in this embodiment this triggering signal is similar to the triggering signal 462, and in response to receiving a leading edge of the triggering signal, the ADC 400 is pre-programmed to take 512 samples of the first signals 56 at its sampling rate of 500 MS/s. Thus, in this embodiment the measurement interval 492 is 1.024 microseconds.

In this regard, in the present embodiment, and in the present example, wherein the aircraft 100 is flying at an average altitude of 300 m AGL, it will be appreciated that the longest possible return time of the laser is the ground return time, i.e. the time required to detect the scattered portion 484 scattered by the lower portion 474 of the environment, which at an altitude of 300 m is 2 microseconds. Thus, as the measurement interval 492 commences 1.2 μs after transmission of the incident laser beam 112 (before any scattered portions of the laser pulse are able to arrive at the detector 122), and ends 1.024 microseconds later (after the last such scattered portion has arrived at the detector 122), the measurement interval 492 in the present embodiment is sufficient for all of the scattered portions 476 to be received by the detector 122.

In this embodiment, the detector 122 receives the scattered portions 476 of the laser beam 114 scattered by the respective portions 467 of the environment 104, in response to which the detector 122 produces the first signals 56, or more particularly, analog electrical signals whose voltage varies in proportion to the intensity of the received scattered portions 476 of the laser beam 114.

The ADC 400 receives the first signals 56 in their analog form from the detector 122 at the input port 402, and simultaneously receives the 500 MHz clock signal from the multiplier 384. Upon receiving a leading edge of the triggering signal from the I/O system 390, the measurement window 490 commences, during which the ADC digitizes the first signals 56, by sampling the first signals 56 at a rate of 500 MS/s. More particularly, each sample produced by the ADC 400 includes an 8-bit digital representation of the voltage of the first signals 56 arriving at the input port 402. The ADC 400 temporarily stores each such sample in the internal memory 418. In addition, the ADC 400 transmits the first signals 56 in digital format to the processor circuit 54, or more particularly, transmits digital electrical signals representing the 8-bit samples temporarily stored in the internal memory 418 to the processor circuit via the high-speed I/O device 420. The ADC 400 continues to sample the signals arriving at the input port 402 in this manner, until 512 such samples have been taken, at which point the ADC ceases such sampling.

In this embodiment, block 460 directs the processor circuit 54 to receive the first signals 56 in their digital format from the ADC 400, and to store data representing the digital signals in the second memory device 329, which in this embodiment is the RAM 330. More particularly, block 460 directs the processor circuit to define, in the second memory device 329, the data structure 334 including the measurement context field 336 for storing measurement context information, the laser field 362 for storing the data representing the first signals 56, and the radar beam field 360 for storing the data representing the second signals 58. Block 460 then directs the processor circuit 54 to store 512 bytes in response to the digital signals received from the ADC 400, in successive entries in the laser field 362 of the data structure 334, each byte representing a corresponding 8-bit sample produced by the ADC.

In this embodiment, block 460 further directs the processor circuit 54 to store measurement context information in the second memory device 329 in association with the data representing the first signals 56.

More particularly, in this embodiment, block 460 directs the processor circuit 54 to store, as the measurement context information, global positioning satellite (GPS) information indicative of a location at which at least one of the laser beam and the radar beam (in this case, the laser beam 114) is received. To achieve this, block 460 directs the processor circuit to receive data signals produced by the GPS device 80 representing the present position and velocity of the aircraft 100 and the present time, via the low-speed I/O device 422, and to store data representing the position and present time in the GPS field 338 of the data structure 334. In this regard, as the GPS information in the present embodiment is updated only twice per second, whereas radar and laser measurements are each obtained 75 times per second, the GPS information provides an approximation of the measurement location. However, as discussed in greater detail below, the GPS measurements may be further processed to interpolate more accurate position data indicative of the measurement location.

Similarly, in this embodiment block 460 directs the processor circuit to store, as the measurement context information, user-inputted information. More particularly, in this embodiment the user-inputted information includes a flight line indication indicative of a flight line over which the laser beam and the radar beam are received by an airborne environment measurement system. To achieve this, block 460 directs the processor circuit to monitor signals from the low-speed I/O buffer produced in response to new manual input at the manual input device 90, and to update the contents of the manual data sub-field 342 of the data structure 334 if necessary.

In addition, in this embodiment block 460 directs the processor circuit 54 to store, as the measurement context information, at least one time value indicative of a time at which at least one of the laser beam and the radar beam (in this case, the laser beam 114) is received. To achieve this, block 460 directs the processor circuit to update a current time value stored in the time sub-field 350 of the data structure 334, in response to signals produced by the internal system clock (not shown) which is synchronized with the clock 382.

In this embodiment, for the purpose of a data structure containing laser data, it is not necessary to update the contents of the gain monitoring sub-field 340. In addition, although the GPS and manual sub-fields 338 and 342 have been described as being updated with each new data structure, alternatively, such sub-fields may be updated less frequently. In this regard, in the present embodiment each successive data structure is generated every 1/150^{th} of one second, whereas new GPS data is obtained only twice per second, and accordingly, strictly speaking, it is not necessary to store GPS data any more frequently than it is obtained. Moreover, even if GPS information were obtained more frequently, during the 1/150^{th} of one second between generation of successive data structures, the aircraft 100 is likely to travel approximately one-half meter, and accordingly, the change in GPS position data will typically be less than the error bars surrounding such position data. Similarly, lower updating rates, such as 10 Hz for example, are generally adequate for updating manually-entered data.

Block 460 then directs the processor circuit 54 to store the data produced in response to the scattered portions 476 of the laser pulse (laser beam 114) scattered by the respective portions 467 of the environment 104, in the memory device 52, for use in producing a representation of the environment.

More particularly, block 460 directs the processor circuit to store the data structure 334 as a new corresponding data structure 500 in the memory device 52, as the data 302. If the data 302 already contains previously generated data structures, block 460 directs the processor circuit to append the new data structure 500 to the data 302, contiguously to the most recently stored existing data structure of the data 302. Thus, in this embodiment, the data 302 includes a plurality of contiguous successively-generated data structures such as the data structure 334.

Block 460 then directs the processor circuit to clear the contents of the laser field 362 of the data structure 334 in the second memory device 329, for generation of the next successive data structure.

Referring to FIGS. 3, 4, 6, 7, 8a, 8b, 9, 10 and 11, block 510 then directs the processor circuit 54 to cause the second signals 58 to be produced in response to a radar beam scattered by the environment (which in this embodiment is the radar beam 106 scattered by the environment), and to store data 302 representing the second signals in the memory device 52.

In this embodiment, block 510 first directs the processor circuit 54 to operate the radar transmission system 66 shown in FIG. 6 to produce, as the incident radar beam 102, an incident radar pulse having a duration on the order of one nanosecond, for scattering by the environment to produce the radar beam 106 scattered by the environment, which in this embodiment includes scattered portions of the radar pulse scattered by respective portions of the environment.

More particularly, in the present embodiment, 75 times per second, at the commencement of every odd-numbered cycle of the 150 Hz timing signal produced by the processor circuit 54 under the direction of the timing thread 310 (in other words, once every 133,333.33 cycles of the 10 MHz clock signal produced by the clock 382; for example, at t=0.0067 s, 0.02 s, 0.0333 s, etc.) block 460 directs the processor circuit 54 to control the I/O system 390 to transmit a triggering signal, such as that shown at 511 in FIG. 10, to the radar transmission system 66 shown in FIG. 6. In this embodiment, the triggering signal 511 has a duration of approximately 3.3 ns (i.e., approximately 1.67 cycles of the 500 MHz clock signal produced by the multiplier 384). The 3.3 ns triggering signal 511 causes the UWB transmitter 144 to generate a 10 kV unipolar impulse signal to cause the transmission antenna system 108 to produce, as the incident radar beam 102, a UWB radar pulse ranging from 200 MHz-400 MHz and having a duration of approximately 3.3 ns (i.e., one complete cycle at the center frequency of 300 MHz), as described above in connection with the radar transmission system, and to direct the incident radar beam 102 to the environment 104.

In addition, it will be recalled that in the present embodiment the receiver 150 is configured to receive low-amplitude signals, and accordingly, it is desirable to protect the receiver 150 against possible overload from much higher-amplitude signals that may tend to be produced by the reception antenna system 110 shown in FIG. 7 if the reception antenna system inadvertently receives a portion of the incident radar beam 102 directly from the transmission antenna system 108. Accordingly, in this embodiment, prior to the transmission of the triggering signal 511 to the radar transmission system 66, block 510 directs the processor circuit 54 to transmit a triggering signal, such as that shown at 514 in FIG. 10, to the blanker 190 to cause the blanker to blank or block signals produced by the reception antenna system 110. More particularly, in this embodiment block 510 directs the processor circuit to begin transmitting the triggering signal 514 to the blanker 190 approximately 100 ns (one cycle of the 10 MHz clock signal) prior to the transmission of the triggering signal 511 to the radar transmission system, and to continue transmitting the triggering signal 514 for approximately 200 ns (two cycles of the 10 MHz clock signal) thereafter, to define a blanking interval of sufficient duration to prevent any transmitter cross-talk signals produced in response to directly received portions of the incident radar beam from reaching the receiver 150, effectively excising any radar transmission resonance around the aircraft 100.

Block 510 then directs the processor circuit 54 to continue monitoring the 10 MHz clock signal from the clock 382, until a pre-defined delay 516 has elapsed following the transmission of the triggering signal 511. More particularly, in this embodiment the delay 516 is equal to 1.2 μs (12 cycles of the 10 MHz clock signal), for the same reasons as those discussed above in connection with block 460.

As the incident radar beam 102 strikes the environment 104, the environment scatters the incident radar beam to produce the radar beam 106 scattered by the environment. A short time following the delay 516, the detector begins to receive the radar beam 106 scattered by the environment, and begins to produce the second signals 58 in response thereto.

More particularly, referring back to FIG. 4, as discussed above in connection with the laser system, at any given instant in time, there may be a plurality of portions 467 of the environment 104 directly beneath the aircraft 100, including the upper portion 468 and the intermediate portions 470 and 472, which in this example are all foliage, the lower portion 474 which in this example is ground level, and a subterranean portion shown generally at 518. In this embodiment, portions of the incident radar beam 102 tend to be scattered by the respective portions 467 of the environment. In particular, although the higher frequencies (in the vicinity of 400 MHz) of the incident radar beam 102 provide greater resolution than longer frequencies, these high frequencies are more significantly scattered by the upper and intermediate portions of the environment than lower frequencies of the incident radar beam. Conversely, although the longer wavelengths (in the vicinity of 200 MHz) of the incident radar beam 102 result in lower resolution, these longer wavelengths penetrate deeper into the environment 104, generally penetrating into the subterranean portion 518, which scatters portions of the incident radar beam back up through the environment to the aircraft 100 for detection thereat. Thus, in this embodiment, the radar beam 106 scattered by the environment includes scattered portions shown generally at 520 of the incident radar pulse, such as scattered portions 522, 524, 526 and 528 for example, scattered by the respective portions 467 of the environment 104.

Accordingly, referring back to FIGS. 7, 8a, 8b, 9, 10 and 11, in this embodiment block 510 the processor circuit 54 to operate an airborne radar reception system to continuously produce data signals in response to the scattered portions 520 of the radar pulse (i.e. the radar beam 106) scattered by the respective portions 467 of the environment 104, during a measurement interval of sufficient duration to receive all the scattered portions 520. In this embodiment the airborne radar reception system includes the radar reception system 68, which acts as a detector operable to receive the scattered portions 520 and to produce analog signals in response thereto, and further includes the ADC 400, which is operable to cooperate with the detector to continuously produce digital signals in response to the analog signals, during the measurement interval.

More particularly, to achieve this in the present embodiment, at the end of the 1.2 μs delay 516 shown in FIG. 10 following transmission of the triggering signal 511 to the radar transmission system 66, block 510 directs the processor circuit 54 to control the TTL chip of the 1/O system 390 to transmit a triggering signal to the ADC 400 shown in FIG. 7, to define a measurement window such as that shown at 530 in FIG. 10, having a duration or measurement interval 532 of at least on the order of one microsecond. More particularly still, in this embodiment the triggering signal is similar to the triggering signal 462, and in response to receiving a leading edge of the triggering signal, the ADC 400 is pre-programmed to take 512 samples of the second signals 58 at its sampling rate of 500 MS/s. Thus, in this embodiment the measurement interval 532 is 1.024 microseconds. In this regard, in the present embodiment, and in the present example, wherein the aircraft 100 is flying at an average altitude of 300 m AGL, it will be appreciated that the combined delay 516 of 1.2 μs and the further 1.024 μs measurement interval 532 provides for a total return time of 2.224 μs, which allows scattered portions 520 of the radar beam 106 scattered by respective portions of the environment as deep as 330 m below the aircraft 100, or in other words about 30 m below ground level in the present example, to be received at the aircraft 100. As significant returns are usually not obtained from depths greater than 30 m below ground, the measurement interval 532 is effectively sufficient for all of the scattered portions 520 to be received.

Referring to FIGS. 4, 7, 8a, 8b, 9 and 10, in this embodiment, the reception antenna system 110 receives the scattered portions 520 of the radar beam 106 scattered by the respective portions 467 of the environment 104, in response to which the reception antenna system 110 produces the second signals 58, or more particularly, analog electrical signals at frequencies of the scattered portions 520 (in this embodiment, 200 MHz-400 MHz), whose voltage varies in proportion to the intensity of the received scattered portions 520 of the radar beam 106.

In this embodiment the second signals 58 are then propagated through the blanker 190 and the receiver 150, as described above in connection with the radar reception system 68 shown in FIG. 7. In particular, in the present example, in which the aircraft 100 is flying at an average altitude of 300 m AGL, a user of the system 50 actuates the manual gain control device 218 shown in FIG. 7, to cause the RF gain control device 212 to control the attenuator 204 to transmit the second signals 58 therethrough with 0 dB attenuation (i.e., no attenuation). The frequency-shifter 227 then frequency-shifts the 200 to 400 MHz second signals 58 by −300 MHz and divides the second signals 58 into in-phase frequency-shifted signals supplied at the I-channel exit port 278, and in-quadrature frequency-shifted signals supplied at the Q-channel exit port 288, each at baseband to 100 MHz frequencies, as described in greater detail above in connection with the receiver 150 shown in FIG. 7.

In this embodiment, the second signals 58, or more particularly the I-channel and Q-channel signals produced at the exit ports 278 and 288 respectively of the receiver 150, are received at the input ports 404 and 406 respectively of the ADC 400 shown in FIG. 7. The ADC 400 simultaneously receives the 500 MHz clock signal from the multiplier 384. Upon receiving a leading edge of the triggering signal from the I/O system 390, the measurement window 530 commences, during which the ADC digitizes the second signals 58, by sampling the I-channel signals at a rate of 500 MS/s while simultaneously sampling the Q-channel signals at the same rate. More particularly, each I-channel sample produced by the ADC 400 includes an 8-bit digital representation of the voltage of the I-channel signals arriving at the input port 404, and similarly, each Q-channel sample includes an 8-bit representation of the voltage of the signals arriving at the input port 406. The ADC 400 temporarily stores the I-channel samples in a first area of the internal memory 418 corresponding to the input port 404, and temporarily stores the Q-channel samples in a second area of the internal memory corresponding to the input port 406. In addition, the ADC 400 transmits the second signals 58 in digital format to the processor circuit 54, or more particularly, transmits first and second respective digital electrical signals representing the 8-bit I-channel and Q-channel samples temporarily stored in the internal memory 418 to the processor circuit via the high-speed I/O device 420. The ADC 400 continues to sample the signals arriving at the input ports 404 and 406 in this manner, until 512 such I-channel and Q-channel sample pairs have been taken, at which point the ADC ceases such sampling.

Referring to FIGS. 8a, 8b and 9, in this embodiment, block 510 further directs the processor circuit 54 to store, as the data representing the second signals, an in-phase value and an in-quadrature value representing an in-phase component and an in-quadrature component respectively of the second signals. To achieve this, block 510 directs the processor circuit to receive the second signals 58 in their digital format from the ADC 400, and to store data representing the digital signals in the second memory device 329, which in this embodiment is the RAM 330. In this regard, the data structure 334 in which the data is to be stored has been previously defined in the RAM by the processor circuit at block 460 above, at which time the contents of the laser field 362 were reset following copying of the data structure 334 to the memory device 52.

Block 510 directs the processor circuit 54 to store 1024 bytes in response to the digital signals received from the ADC 400, in successive byte-pair entries in the radar beam field 360 of the data structure 334. More particularly, in this embodiment the radar beam field 360 has a width of two bytes. Accordingly, in this embodiment block 510 directs the processor circuit 54 to store the 512 one-byte I-channel samples in the first eight bit locations of the 512 two-byte sub-fields of the radar beam field 360, in the order in which such the digital signals representing such I-channel samples are received from the ADC 400. Similarly, block 510 directs the processor circuit to store the 512 one-byte Q-channel samples in the second eight bit locations in the 512 sub-fields of the field 360. Thus, in this embodiment, each of the 512 sub-fields of the radar beam field 360 is of the form (I, Q), wherein I and Q are 8-bit digital representations of the 0-100 MHz I-channel and Q-channel signals simultaneously sampled by the ADC 400. It will be appreciated that such a byte pair represents a sample of the entire −100 MHz to +100 MHz range of the frequency-shifted second signals 58, as the byte pair represents a complex vector including a real component (the I-channel sample) and the imaginary component (the Q-channel sample).

In this embodiment, block 510 further directs the processor circuit 54 to store measurement context information in the second memory device 329 in association with the data representing the second signals 58.

More particularly, in this embodiment, block 510 directs the processor circuit 54 to store, as the measurement context information, global positioning satellite (GPS) information and a time value indicative of a location and time respectively at which the radar beam (the radar beam 106) is received, and user-inputted information, as described above in connection with block 460.

In addition, as the data structure 334 includes radar data, in this embodiment block 510 configures the processor circuit to store, as the measurement context information, attenuation information indicative of an amount of attenuation of the second signals 58. More particularly, in this embodiment block 510 directs the processor circuit 54 to monitor the signal received at the I/O system 390 from the gain monitor connection 220 shown in FIG. 7, whose voltage represents an amount of attenuation of the second signals 58 provided by the attenuator 204. Block 510 directs the processor circuit to store a value representing this amount of attenuation in the gain monitoring sub-field 340. Although the gain monitoring sub-field is updated with each new data structure containing radar data in the present embodiment, alternatively, the gain monitoring sub-field 340 may be updated less frequently if desired, as the manual gain control device 218 shown in FIG. 7 will usually not be adjusted during the course of a given flight line.

Block 510 then directs the processor circuit 54 to store the data produced in response to the scattered portions 520 of the radar pulse (radar beam 106) scattered by the respective portions 467 of the environment 104, in the memory device 52, for use in producing a representation of the environment. More particularly, block 510 directs the processor circuit to store the data structure 334 as a new corresponding data structure 534 in the memory device 52, as the data 302. In this embodiment, the data 302 already contains previously generated data structures, including the data structure 500 containing laser data as described above in connection with block 460. Accordingly, block 510 directs the processor circuit to append the new data structure 534 to the data 302, contiguously to the most recently stored existing data structure 500 of the data 302. Thus, in this embodiment, the data 302 includes a plurality of contiguous successively-generated data structures such as the data structure 334.

Block 510 then directs the processor circuit 54 to clear the contents of the radar beam field 360 of the data structure 334 in the second memory device 329, for generation of the next successive data structure.

Referring to FIGS. 2, 8a, 8b and 10, following execution of blocks 460 and 510, block 540 directs the processor circuit to determine whether it is to cease execution of the measurement routine 308. In the present embodiment, block 540 directs the processor circuit to monitor signals received at the I/O system 390 from the manual input device 90 shown in FIG. 2, to determine whether a user of the system 50 has entered an “end” command indicating that a given desired flight line measurement has been completed. If such a command is detected, the measurement routine 308 is ended. If no such command is received, the processor circuit is directed back to blocks 460 and 510, to continue storing alternating data structures corresponding to the laser measurements performed at block 460 and the radar measurements performed at block 510 respectively, until the “end” command is detected at block 540. Alternatively, however, if desired, the measurement routine 308 may configure the processor circuit to automatically commence and terminate in response to pre-determined conditions.

Referring to FIGS. 2, 4, 8a, 8b and 9, if desired, the measurement routine 308 may further include an additional block of codes 550, for directing the processor circuit 54 to produce a representation of the environment 104, such as a representation 552 shown in FIG. 2 for example. In this regard, for some applications it may be desirable for a user of the system 50 to view a real-time representation of the environment 104 in response to the first signals 56 and/or the second signals 58. Such a representation may be used for the limited purpose of verifying that the system 50 appears to be obtaining and storing useful data representing the first and second signals, for example. In this embodiment, block 550 directs the processor circuit to display, as the representation 552, vertical traces 554 and 556 shown in FIG. 2, representing the data produced and stored in response to the first and second signals 56 and 58 respectively. In this embodiment, the vertical traces are produced in response to the sequential contents of the laser field 362 and the first eight bit positions of the electromagnetic beam field 360 of the two most recently produced data structures 334, such as the data structures 500 and 502 stored in the memory device 52 for example. More particularly, in this embodiment block 550 directs the processor circuit to store data in the display buffer 370 to control the display device 94 to produce a scrolling display, with a new such vertical traces being displayed once per second at a right-hand region of the display device 94, and gradually scrolling toward a left region of the display device to make room for the next such vertical traces. Alternatively, other real-time displays may be substituted, or such displays may be omitted entirely if desired.

Analysis

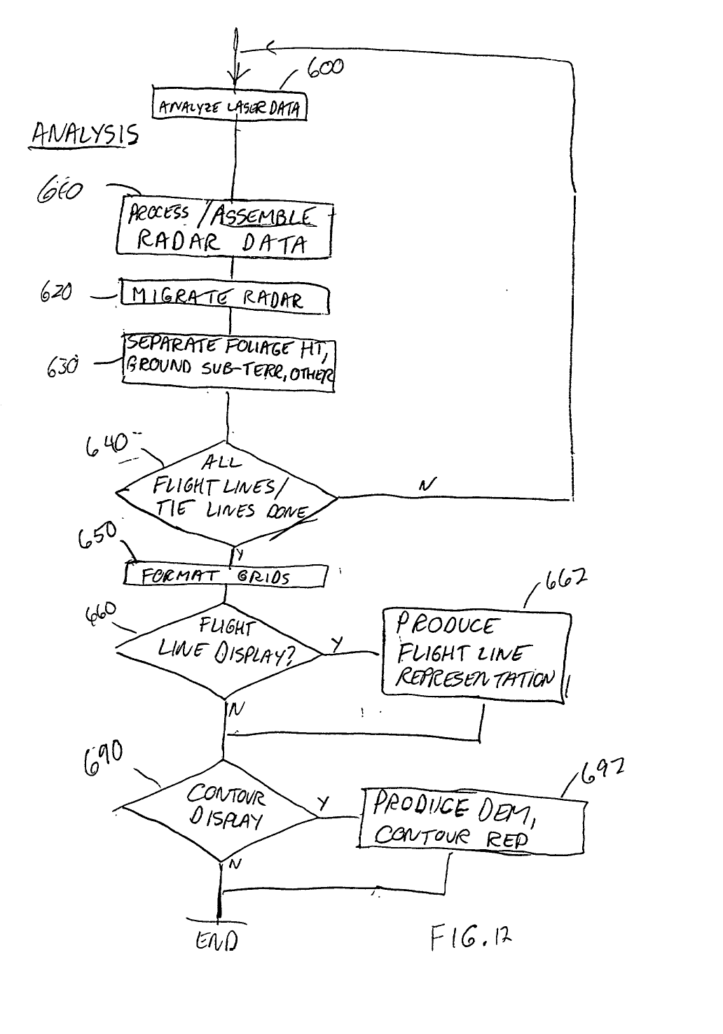

Referring to FIGS. 4, 8a, 8b, 11, 12 and 13, the analysis routine is shown generally at 320 in FIG. 12. Generally, the analysis routine 320 configures a representation processing circuit 560 to use the data 302 to produce a representation of the environment 104. For convenience of illustration, in the present embodiment the representation processing circuit 560 includes the processor circuit 54. More generally, however, it is contemplated that the representation processing circuit 560 which executes the analysis routine 320 will more often include a separate representation processing circuit, such as a microprocessor 562 shown in FIG. 4, which may be embodied in a ground-based computer based anywhere in the world such as a desktop computer 564, for example. More generally still, although the analysis routine 320 described herein provides a number of examples of representations of the environment 104 that may be produced using the data 302 obtained by the system 50, alternatively, such data may be used for producing any other type of representation, including any type of numerical, graphical, or imaging representation, for example.

In this embodiment, prior to execution of the analysis routine 320, interpolated GPS information is first obtained, in order to provide more accurate indications of the measurement location of the aircraft 100 at which each radar or laser measurement represented by each respective stored data structure was obtained. In this regard, it will be recalled that in the present embodiment, GPS information obtained from the GPS device 80 is updated only twice per second, during which time 75 laser data structures and 75 radar data structures are produced. Accordingly, in this embodiment an interpolation routine (not shown) is executed to interpolate more accurate position information corresponding to each measurement location. Such an interpolation routine may include GRAPHNAV software available from Wavepoint of Calgary, Canada for example, although alternatively, any other suitable interpolation or curve-fitting algorithms may be used.

More particularly, in this embodiment, prior to execution of the analysis routine 320, the data 302 in the memory 52 is first copied to an archive (not shown), to preserve the original raw data. (In embodiments where the representation processing circuit 560 is not the processor circuit 54, such archiving may be unnecessary, as the data 302 will have been copied from the memory 52 to a separate hard drive or other medium accessible by the representation processing circuit, and thus the memory 52 itself may serve as the archive, with all subsequent analysis and alternations being performed only on the data so copied.)

The interpolation routine then directs the representation processing circuit to sequentially address each set of data structures of the data 302 corresponding to a particular flight line, as identified by matching contents of the flight line sub-field 344 of each such data structure. For each addressed set of data structures corresponding to a given flight line, the interpolation routine directs the representation processing circuit to read the entire set of GPS data (x, y, z) stored in the GPS sub-fields 338 of the addressed set of data structures, and to produce and store interpolated position data (x, y, z) in the GPS sub-field 338. In this embodiment, the interpolated position data overwrites the contents of the GPS sub-field 338 of the addressed data structures of the data 302 (it will be recalled that the original raw data has been separately archived, and is therefore not lost by such overwriting). The interpolation routine directs the representation processing circuit to repeat such interpolation for each flight line flown by the aircraft 100, until the GPS sub-fields of the data structures of all of the data 302 contain more accurate, interpolated position data (x, y, z) indicative of the actual position of the aircraft 100 at the time the measurement represented by each such data structure was obtained.

If desired, in embodiments where differential GPS is employed, the interpolation routine may also direct the representation processing circuit to receive a “dot out file”, including GPS data obtained at the same times as the aircraft GPS data, at a separate ground station whose location is known, and may compare such information to the known location of the ground station to produce an error correction, which is then applied to correct the interpolated position data.

Once such interpolated position data has been produced for all laser and radar data structures of the data 302, the analysis routine 302 is then executed.

In this embodiment, the analysis routine 320 begins with a first block of codes 600, which directs the representation processing circuit 560 to analyze the laser data produced in response to the first signals 56. More particularly, in this embodiment block 600 directs the representation processing circuit 560 to identify a foliage height of the environment 104. In this regard, although radar data may also be used to identify the foliage height of the environment, it has been found that laser data is more accurate for this purpose.

Referring to FIGS. 4 and 11, it will be appreciated that if the environment 104 includes foliage above its ground level immediately beneath the aircraft when laser data is obtained as described above, then the scattered portion 478 of the incident laser pulse, scattered by the upper portion 468 of the environment, is the first scattered portion of the laser pulse to be received by the system 50, which produces a first return portion 602 of the first signals 56 in response thereto. If the foliage is fairly light, such as the situation shown in FIG. 11 for example, then further portions 604 of the first signals will be generated in response to additional scattered portions, such as those shown at 480, 482 and 484 for example, received at the system 50. However, if the foliage is thick, such as the situation shown in FIG. 2 for example, then the first return portion 602 of the first signals 56 is typically the only portion of the first signals 56 that is appreciably above noise level. Similarly, if there is no foliage at all between the aircraft 100 and the ground level of the environment, the first return portion 602 of the first signals 56 is produced in response to the scattered portion 484 of the laser pulse scattered by the lower portion 474, i.e. the ground level, of the environment.

Referring to FIGS. 4, 8a, 8b, 12 and 13, in this embodiment block 600 first directs the representation processing circuit 560 to address the first set of data structures of the data 302 corresponding to the next flight line which has not yet been analyzed by the representation processing circuit 560. More particularly, block 600 directs the representation processing circuit to read the contents of the flight line sub-field 344 of the manual data sub-field 342 of each of the data structures stored as the data 302 in the memory device 52, to identify all such data structures corresponding to the next unanalyzed flight line (such as flight line #1 in the case of the first time block 600 is executed by the representation processing circuit, for example), having laser data stored in their laser field 362. In this embodiment, in which each flight line is approximately 10 km long, the system 50 produces approximately 10,000 data structures containing laser data corresponding to locations approximately 1 meter apart along each flight line.

Block 600 then directs the representation processing circuit 560 to sequentially address each such identified data structure, and for each addressed data structure, block 600 directs the representation processing circuit to produce a position value P representing the position of the first of the 512 one-byte sub-fields of the laser field 362 of the addressed data block having contents exceeding a pre-defined threshold noise value representing a maximum likely noise value produced by the detector 122 of the laser system. For example, if the first 117 sub-fields of the laser field 362 contain values less than the noise value and the 118^{th} sub-field contains a value exceeding the noise value, the representation processing circuit produces a value P=118.

In this embodiment, block 600 then directs the representation processing circuit 560 to read the interpolated aircraft position information stored in the GPS sub-field 338 of the currently addressed data structure, and to produce a first return height value R₁, as follows:

R₁=z_{GPS}−0.5c[t_{DEL}+(t_{SAM})(P)] (3)

wherein

R₁ the first return height of the environment 104, or in other words, the height of the highest portion of the environment 104 in meters at the location corresponding to the currently addressed data structure, relative to a geoid;

Z_{GPS}=the height of the aircraft 100 in meters, relative to the geoid, at the location of the laser measurement, as obtained from the GPS sub-field 338 of the currently addressed data structure;

c=the speed of light in meters per second

t_{DEL}=the time delay in seconds following the transmission of the incident laser beam 112 prior to commencing sampling and storing data in the laser field 362 representing the first signals 56 (in this embodiment, t_{DEL}=1.2×10⁻⁶ s);

t_{SAM}=the sampling period in seconds between successive samples of the first signals 56 stored in respective successive sub-fields of the laser field 362 (in this embodiment, t_{SAM}=2.0×10⁻⁹ s); and

P=the position value (1≦P≦512) representing the position of the first sub-field of the laser field 362 containing a value greater than maximum expected noise.

Block 600 then directs the representation processing circuit 560 to store a set of values of the form (x, y, R₁) in the first return height store 372 in the RAM 330, wherein (x, y) are interpolated latitudinal and longitudinal coordinates to which the currently addressed data structure corresponds, obtained from the GPS sub-field 338 of the data structure, and R₁ is the first return height as described above.

Block 600 then directs the representation processing circuit 560 to repeat the above procedures for each of the addressed data structures corresponding to the particular flight line currently being analyzed, to produce and store a complete set of values (x, y, R₁) for the current flight line. In addition to storing such values in the first return height store 372, block 600 directs the representation processing circuit to copy such values to a corresponding first return height store 606 of an analyzed data region 605 of the memory device 52, which in this embodiment includes respective stores corresponding to each of the various stores of the second memory device 329 which store analyzed data produced by the representation processing circuit under the direction of the analysis routine.

Although the foregoing identification of the first return height from the laser data suffices for the analysis routine 320 of the present embodiment, alternatively, for other applications, it may be desirable to produce and store sets of values of the form (x, y, R₁, R₂, R₃, . . . R_{N}), wherein R₁ . . . R_{N} are obtained in the same manner as R₁ above and represent all return heights of the environment for which the value stored in the corresponding sub-field of the laser field 362 exceeded noise, in order to provide laser data over a full swath potentially ranging from a highest foliage height to ground level. Such complete data may be particularly useful for light foliage environments, for example, and may be used to produce various representations of the environment, including representations of the various respective portions of the environment that produced the corresponding scattered portions of the laser beam to produce the R₁ . . . R_{N} values.

In this embodiment, following execution of block 600, block 610 directs the representation processing circuit 560 to process and assemble the radar data for analysis. In this regard, block 610 first directs the representation processing circuit to read the contents of the flight line sub-field 344 of the manual data sub-field 342 of each of the data structures stored as the data 302 in the memory device 52, to identify all such data structures corresponding to the currently addressed flight line (addressed above at block 600), having radar data stored in their radar beam field 360. As with the laser data, In this embodiment the system 50 produces approximately 10,000 data structures containing radar data corresponding to locations approximately 1 meter apart along each flight line. Block 610 directs the representation processing circuit to sequentially address each such data structure, and to copy contents of the GPS sub-field 338 and the radar beam field 360 to a corresponding column of a table defined in the assembled data store 379 in the second memory device 329. More particularly, in this embodiment each such column in the assembled data store 379 includes a GPS field containing GPS data of the form (x, y, z) representing the interpolated position at which the radar measurement represented by a particular corresponding data structure was produced, and includes a radar field which in turn includes 512 positions (rows) or entries, each including two bytes representing the I-channel and Q-channel data respectively stored in the radar beam field 360 of the particular data structure.

If desired, block 610 may further direct the representation processing circuit 560 to perform pre-processing on the contents of the assembled data store 379. For example, in this embodiment, block 610 directs the representation processing circuit to perform a Fast Fourier Transform (FFT) on each column of data stored in the assembled data store 379. The 512 (I, Q) byte pairs in each such column form a complex input vector of the form f_{K}=I_{K}+iQ_{K} to be operated upon by the FFT, which produces and stores a corresponding set of 512 frequency-domain byte pairs, of the form (FR_{K}, FI_{K}) denoting the real and imaginary components of the FFT, over-writing the (I, Q) byte pairs of the column. In this regard, it will be recalled that the raw data 302 has been archived prior to commencement of the analysis routine 320, and thus this over-writing does not result in loss of the original archived raw time domain data.

In the present embodiment, such pre-processing further includes identification and removal of any interferers present in the resulting FFT values. In this regard, interferers such as noise spikes may sometimes arise at particular frequencies. In this embodiment, to identify such interferers, for each N^{th} frequency line represented by each respective N^{th} one (2≦N≦511) of the 512 frequency-domain byte pairs (FR_{N}, FI_{N}) of a given column of the assembled data store 379, block 610 directs the representation processing circuit 560 to compare the signal amplitude P_{N} represented by each such frequency-domain byte pair to the signal amplitudes P_{N-1}, P_{N+1} at neighboring frequency lines represented by neighboring frequency-domain byte pairs (FR_{N-1}, FI_{N-1}) and (FR_{N+1}, FI_{N+1}). If both P_{N}≧2P_{N-1} and P_{N}≧2P_{N+1}, then it is concluded that P_{N} corresponds to a noise spike, and accordingly, P_{N} is reduced to 0.5(P_{N-1}+P_{N+1}), and (FR_{N}, FI_{N}) are adjusted accordingly. For N=1 (corresponding to baseband frequency) no such identification or removal need be performed as this frequency will be reset to zero (discussed below), and for N=512, the signal amplitude may simply be compared to that of N=511.

In addition, in the present embodiment such pre-processing further includes normalization of the spectrum represented by each column of the assembled data store 379. To achieve this, for each addressed column of frequency-domain byte pairs (FR, FI), block 610 first directs the representation processing circuit 560 to effectively divide the time-domain values (I, Q) corresponding to the column contents (FR, FI) by a set of average time-domain return values that are expected from a reference environment (in this embodiment a flat liquid surface), by performing an equivalent frequency-domain deconvolution from the column contents of an average spectrum or spread function for the reference environment.

In this regard, in the present embodiment, to obtain the spread function for the reference environment, the aircraft 100 is flown over calm, flat water at least once during the mission, during which time at least one radar measurement data structure (referred to as the spread function data structure) is generated in the same manner as described above in connection with block 510 of the measurement routine. A user of the system 50 actuates the user input device 90 to cause a special identifying notation to be stored in the measurement context field 336 of this spread function data structure, such as in the manual data sub-field 342 for example. Block 610 directs the representation processing circuit to locate the spread function data structure, apply a Fast Fourier Transform (FFT) to the (I, Q) pairs of the data structure, and to remove interferers from the corresponding frequency-domain byte pairs (SFR, SFI) as described above, yielding a set of 512 spread function byte pairs (SFR, SFI) which may then be used for normalization of all radar data obtained during the mission.

Once this set of spread function byte pairs has been obtained, block 610 directs the representation processing circuit 560 to convolve the contents (FR, FI) of each column of the assembled data store 379 with the spread function values (SFR, SFI) in the frequency domain, to yield normalized frequency-domain byte pairs (FR, FI).

To complete the normalization process, in this embodiment block 610 directs the representation processing circuit 560 to truncate the normalized frequency-domain byte pairs (FR, FI) by further convolving them with a suitable window function in the frequency domain, which in this embodiment is a Kaiser window (K=4). Alternatively, other suitable windows may be substituted, such as a Hamming window (0.48 cos(ωt)+0.54), for example.

In the present embodiment block 610 further directs the representation processing circuit 560 to set the (FR, FI) bytes in location 1 of each column of the assembled data store 379, which correspond to baseband frequency (DC), equal to zero. In this regard, it will be recalled that the second signals 58 in the present embodiment were frequency-shifted by the radar reception system 68 from 300±100 MHz down to 0±100 MHz, and therefore contain a significant baseband (DC) component, which block 610 effectively removes.

Block 610 then directs the representation processing circuit 560 to perform an inverse Fast Fourier Transform (FFT⁻¹) on the 512 byte pairs stored in the presently addressed column of the assembled data store 379, effectively converting such values back into time-domain byte pairs of the form (I, Q), which are over-written into the presently addressed column.

In addition, in the present embodiment block 610 further directs the representation processing circuit 560 to decompose the calibration signal from the (I, Q) byte pairs. It will be recalled that in the present embodiment, the calibration signal includes the 320 MHz sine-wave generated by the calibration signal generator 226 and down-shifted to 20 MHz by the frequency-shifter 227 shown in FIG. 7. Block 610 directs the processor circuit to compare the decomposed calibration signal data with stored digital data representing a 20 MHz reference sine wave, to determine whether any “drop-out”, or in other words, a failure by the ADC 400 to take a sample, has occurred. It will be appreciated that such a drop-out will result in two successive samples of the decomposed calibration signal which are actually 4 ns apart in time, appearing in the sampled data as if they were only 2 ns apart, resulting in a discontinuous vertical jump in the decomposed calibration signal. If any such drop-out is detected, block 610 directs the representation processing circuit to “pad” the data, by inserting an additional (I, Q) byte pair at the point of discontinuity of the calibration signal, identical to the (I, Q) byte pair immediately preceding the discontinuity. In addition, block 610 directs the representation processing circuit to monitor the decomposed calibration signal data for “stuck bits”, or in other words, a malfunctioning of the ADC 400 resulting in a given bit position being always 1 or always 0. If such stuck bit errors are detected, an alarm message is generated and displayed to a user of the representation processing circuit.

Block 610 directs the representation processing circuit to repeat the foregoing steps for each of the columns stored in the assembled data store 379, until all such radar data corresponding to the currently addressed flight line has been pre-processed and assembled in the assembled data store 379 in the above manner. In addition to storing such values in the assembled data store 379, block 610 directs the representation processing circuit to copy such values to a corresponding assembled data store 612 of the analyzed data region 605 of the memory device 52.

Thus, following execution of block 610, the assembled data store 379 contains approximately 10,000 columns of radar data, each successive column including a radar field including 512 (I, Q) byte pairs that have been pre-processed as described above, and a GPS field containing data indicating a respective successive interpolated position of the aircraft 100 at which the radar measurements represented by the contents of the radar field were obtained.

In this embodiment, block 620 configures the representation processing circuit to apply a migration algorithm to the data representing the second signals 58 (or more particularly, to the data stored in the assembled data store 379), to associate the data representing the second signals with particular locations of the environment.

In this regard, it will be appreciated that the system 50 of the present embodiment employs considerably longer radar wavelengths (on the order of one meter), and a considerably broader radar bandwidth (a frequency width of 66% of its central frequency), than conventional radar systems (which typically employ a much narrower bandwidth surrounding a shorter central wavelength, on the order of 1 cm, 10 cm or 100 cm, for example). The wavelength ranges of the present embodiment provide numerous advantages over conventional systems, as the longer wavelengths used in the present embodiment may be used to obtain much deeper subterranean penetration for profiling of sub-surface features than conventional systems. For example, wavelengths shorter than 3 cm typically provide no ground penetration, and wavelengths as long as 30 cm typically do not penetrate further than 1-2 m even in exceptionally dry soil conditions, whereas the longer 1.0-1.5 m wavelengths employed in the present embodiment typically provide returns from depths of 10 m in normal soil. When coupled with the wide bandwidth employed in the present embodiment, such radar provides greater resolution than conventional radar systems, and is adequate to identify ground and foliage height with sufficient accuracy for the vast majority of applications. In addition, as the range from 0.75 m to 1.5 m is often reserved by governments for communications uses, there is typically very little noise in this wavelength region, which is advantageous for obtaining more sensitive measurements, and conversely, the power level and downward transmission direction of the incident radar beam 102 are not likely to cause undue interference in this wavelength range. However, the longer wavelength of the present embodiment results in greater beam divergence, typically about 5° (a spot size of 25 m produced from an altitude of 300 m AGL), in contrast with 1-2° beam widths that are often achieved with conventional radar systems.

Conventional radar analysis systems typically include compression algorithms, to effectively decrease the spot size of the beam. However, such compression algorithms are typically not suitable for data produced in response to a beam width as great as 5°.

Accordingly, in order to effectively decrease the spot size of the beam, and thereby increase measurement accuracy, in the present embodiment a migration algorithm is applied to the data in the assembled data store 379 produced in response to the second signals 58. In this regard, although migration algorithms have previously existed in other technical fields, such as geophysics for example, migration algorithms have not been previously applied in the technical field of airborne radar measurements, which is one possible application of the present embodiment of the invention.

Effectively, the principle underlying the migration algorithm is as follows. From the point of view of the radar reception system 68 of the present embodiment, when a portion of the environment 104 scatters the incident radar beam to produce a scattered portion which is received at the radar reception system, the location in the radar beam field 360 at which the data representing the scattered portion is stored is indicative of the time at which the scattered portion was received, and is therefore indicative of the scalar distance from the aircraft 100 to the portion of the environment that produced the received scattered portion of the radar beam. However, the radar reception system in the present embodiment does not measure the angle or direction to the corresponding portion of the environment which scattered the received portion of the radar beam. From an analytical point of view, therefore, in this embodiment it is as if all received scattered portions were received from directly below the aircraft 100, when in fact they were not. A given fixed point of the environment, such as a target spot on ground level of the environment, for example, will initially be a first scalar distance away from the aircraft 100, and this distance decreases as the aircraft approaches the fixed point. As the aircraft flies directly over the fixed point, the scalar distance between the aircraft and the point will be a minimum, and as the aircraft passes over the fixed point and moves away from it, the scalar distance will increase. Geometrically, the scalar distance of the fixed point from the aircraft, plotted against horizontal position of the aircraft, will map out a hyperbola.

By way of example, for a particular application, the aircraft 100 may fly flight lines of 10,000 meters each, with 10,000 corresponding data structures containing radar data produced and stored as described above in connection with block 510 of the measurement routine, and with corresponding data structures being produced and stored in the assembled data store 379 as described above in connection with block 610, each such data structure being produced at a 1 m interval as the aircraft 100 flies at 75 m/s ground speed. In most cases, it may be assumed that each flight line is flown in a straight line with respect to latitude and longitude, at constant ground speed, although the altitude Z_{GPS} of the aircraft 100 may vary relative to the geoid, either intentionally or due to updrafts or downdrafts. In any event, the aircraft's position at any given location at which a corresponding set of radar data was obtained may be expressed as (x, y, z).

Similarly, any given fixed point of the environment 104 along the flight line (i.e., in the vertical plane defined beneath the aircraft 100 as it flies along the flight line) may be described by coordinates (x_{FP}, y_{FP}, z_{FP}). At any one of the 10,000 interpolated aircraft positions (x, y, z) at which radar data of the environment was obtained, the scalar distance from the aircraft 100 to the fixed point (x_{FP}, y_{FP}, z_{FP}) will be:

d=\sqrt{(x_{FP}−x)²+(y_{FP}−y)²+(z_{FP}−z)²} (4)

It therefore follows from geometry, and from equations (3) and (4), that if a scattered portion of the incident radar beam scattered by the fixed point (x_{FP}, y_{FP}, z_{FP}) is received by the radar reception system 68 at the k^{th} aircraft position (x_{K}, y_{K}, z_{K}) along the flight line, then the position (row) P in the k^{th} data structure representing such a scattered portion is (rounded to the nearest natural number):

$${P}_{K} = \frac{\frac{2 {d}_{K}}{c} - {t}_{DEL}}{{t}_{SAM}} = \frac{\frac{2}{c} \sqrt{{( {x}_{FP} - {x}_{K} )}^{2} + {( {y}_{FP} - {y}_{K} )}^{2} + {( {z}_{FP} - {z}_{K} )}^{2}} - {t}_{DEL}}{{t}_{SAM}} \qquad ( 5 )$$

wherein

P_{K}=the position value (1≦P≦512) representing the position (row number) in the k^{th} successive column of radar data stored in the assembled data store 379 (obtained by the aircraft 100 at location (x_{K}, y_{K}, z_{K})) containing data representing a scattered portion (if any) scattered by the fixed point (x_{FP}, y_{FP}, z_{FP}) of the environment 104;

(x_{K}, y_{K}, z_{K})=the interpolated displacement of the aircraft 100 at the location of the k^{th} radar measurement, in meters relative to a reference point (z_{K} is relative to the geoid), obtained from the GPS field of the k^{th} column of the assembled data store;

(x_{FP}, y_{FP}, z_{FP})=the displacement of the fixed point of the environment 104 that is of current interest, in meters relative to a reference point;

c=the speed of light in meters per second;

t_{DEL}=the time delay in seconds following the transmission of the incident radar beam 102 prior to commencing sampling and storing data representing the second signals 58 (in this embodiment, t_{DEL}=1.2×10⁶ s);

t_{SAM}=the sampling period in seconds between successive samples of the second signals 58 (in this embodiment, t_{SAM}=2.0×10⁻⁹ s).

In addition to data representing radar scattering by the fixed point (x_{FP}, y_{FP}, z_{FP}), the value stored in the P^{th} location of the k^{th} radar data set may have also been produced in response to scattering by other portions of the environment, which produce a source of random noise. On average, however, if, for a particular fixed point (x_{FP}, y_{FP}, z_{FP}) of the environment, a position value Pⱼ is calculated for all of the 10,000 data sets (or at least, for all data sets for which 1≦P≦512, which therefore contain data corresponding to the fixed point (x_{FP}, y_{FP}, z_{FP})), and the contents of the position fields Pⱼ of each such radar data set are summed or integrated, then if the fixed point (x_{FP}, y_{FP}, z_{FP}) is a significant reflector, such as a point on the ground for example, then the resulting sum will be significant. Conversely, if the fixed point is not a significant reflector (such as a point in mid-air, for example) then the data stored in the locations Pⱼ of the radar data sets will represent merely background noise from other locations of the environment, which does not add in phase on average, and therefore, the resulting sum will be low or zero. Accordingly, in this embodiment, block 620 directs the representation processing circuit to apply a migration algorithm to the radar data stored in the assembled data store 379. More particularly, block 620 directs the representation processing circuit to define a set of fixed points of the environment, such as the fixed point (x_{FP}, y_{FP}, z_{FP}) discussed above. More particularly, in this embodiment the fixed points of interest include a two-dimensional array of fixed points, spaced horizontally at one meter intervals along the currently addressed 10 km flight line, and spaced vertically at one meter intervals from 120 m above the geoid to 30 m below the geoid (it will be recalled that in this embodiment the aircraft 100 flies each flight line approximately 300 m above the geoid). Thus, in this embodiment the representation processing circuit defines 10,000×150=1,500,000 fixed points of the environment, for consideration. For each such fixed point, block 620 directs the representation processing circuit to calculate a set of position values Pⱼ as discussed above, each successive position value Pⱼ representing a position (row) in a respective successive one of the 10,000 radar data sets stored in the assembled data store 379, although alternatively, such position values Pⱼ may be pre-calculated and stored in look-up tables, if desired. (It is noted that for any particular fixed point of the environment, it is not necessary to calculate Pⱼ for the majority of measurement locations of the aircraft along the flight line, due to the limited beam width of the incident radar beam, and also because Pⱼ does not exist in the required range 1≦Pⱼ≦512 for many of the 10,000 radar data sets, as the measurement location (x, y, z) of the aircraft 100 for many of the radar measurements is too far away from a particular fixed point (x_{FP}, y_{FP}, z_{FP}) for data from the fixed point to have been received at the aircraft during the 512-sample measurement window. Typically, for a particular fixed point (x_{FP}, y_{FP}, z_{FP}), it is not necessary to calculate Pⱼ for any measurement locations (x, y, z) of the aircraft in respect of which the angle formed by a vertical line through the fixed point and a line joining the fixed point to the measurement location is more than 15°).

Block 620 then directs the representation processing circuit to calculate a sum σ_{P}R of the contents of the radar data stored in the locations Pⱼ, or more particularly a sum of the magnitudes of the complex vectors fp=Ip+iQp represented by the (I, Q) byte pairs stored in each of the locations Pⱼ. Block 620 further directs the representation processing circuit to store the co-ordinates (x_{FP}, y_{FP}, z_{FP}) identifying the fixed point, along with the resulting sum σ_{P}R_{FP} corresponding to the co-ordinates, in the migrated data store 381 in the second memory device 329. In addition to storing such values in the migrated data store 381, block 620 directs the representation processing circuit to copy such values to a corresponding migrated data store 622 of the analyzed data region 605 of the memory device 52.

In this embodiment, block 630 then directs the representation processing circuit 560 to identify a height of a terrain surface of the environment. In this regard, the ground level of the environment (either soil or surface liquid, if present) will typically scatter the incident radar beam 102 with considerably greater intensity than any other portion of the environment. Accordingly, in this embodiment, block 630 directs the representation processing circuit to successively address each set of migrated data corresponding to a given vertical column of fixed points of the environment 104 (in other words, each vertical column of fixed points is for a fixed (x_{FP}, y_{FP}), and includes 150 different values z_{FP} spaced 1 m apart ranging from +120 m to −30 m relative to the geoid, along with the 150 corresponding radar sum values σ_{P}R_{FP} for the 150 points z_{FP}. Block 630 directs the representation processing circuit to identify the fixed point z_{FPG} whose corresponding sum value σ_{P}R_{FP} has the greatest magnitude, and to store a corresponding set of coordinates (x_{FP}, y_{Fp}, z_{FPG}) in the ground return height store 374. Block 630 directs the representation processing circuit to continue identifying and storing ground return heights z_{FPG} in this manner until 10,000 such ground return heights have been identified and stored in the ground return height store 374, one for each one-meter measurement interval at each location (x_{FP}, y_{FP}) along the currently addressed flight line. Block 630 further directs the representation processing circuit to copy such ground return data to a ground return height store 632 in the memory device 52.

In this embodiment, block 630 further directs the representation processing circuit 560 to identify a relative foliage height of the environment. More particularly, in this embodiment, for each (x, y) location along the currently addressed flight line, block 630 directs the representation processing circuit to subtract the corresponding ground return height value z_{FPG} stored in the ground return height store 374, from the corresponding first return R1 value stored in the first return height store 372, to identify a height of foliage of the environment relative to the ground level of the environment at location (x, y). Block 630 directs the representation processing circuit to store the resulting relative foliage height values z_{RFH} in the foliage height store 375, along with the corresponding coordinates (x, y) to which the respective foliage height values relate. In this regard, it is noted that the use of laser data representing absolute foliage height (stored in the first return height store 372) is typically more reliable than corresponding radar data representing absolute foliage height, as the latter typically has a low signal-to-noise ratio (such as 3 dB for example). Conversely, however, radar data representing ground height has a significantly higher signal-to-noise ratio than radar data representing foliage, and therefore provides a reliable estimate of ground height, whereas laser data representing ground height usually cannot be obtained in areas of thick foliage. Thus, the combination of laser and radar data as described above results in a more reliable determination of relative foliage height than either laser data alone or radar data alone could provide.

In this embodiment, in addition to storing such values in the foliage height store 375, block 630 directs the representation processing circuit to copy such values to a corresponding foliage height store 634 of the analyzed data region 605 of the memory device 52.

Alternatively, if desired, rather than using both laser and radar data to identify relative foliage height, block 630 may direct the representation processing circuit to use radar data alone to identify the relative foliage height. In this regard, an alternative block 630 may direct the representation processing circuit to produce a radar first return height store (not shown) in response to the contents of the migrated data store 381, by identifying a first return height z_{FP} for each location (x_{FP}, y_{FP}) having a corresponding sum value σ_{P}R_{FP} significantly greater than an expected noise value (for example, at least twice as great as noise). The alternative block 630 may then direct the representation processing circuit to subtract the corresponding ground return height value z_{FPG} from the first return height z_{FP} and to store the resulting difference in the foliage height store 375.

Additionally, if desired, block 630 may further direct the representation processing circuit 560 to identify features of the environment below the terrain surface. For example, in this embodiment block 630 direct the representation processing circuit to read the contents of the migrated data store 381, and if, for any given measurement location (x_{FP}, y_{FP}), any sum value (or values) σ_{P}R_{FP} greater than an expected noise value exists, corresponding to a return height z_{FP} less than the ground return height z_{FPG} for that location (i.e., underground), block 630 directs the representation processing circuit to store the co-ordinates (x_{FP}, y_{FP}, z_{FP}) for all such points in the subterranean data store 378. In this embodiment, the corresponding sum value σ_{P}R_{FP} is also stored in association with each such set of coordinates, and such coordinates and sum values are also copied to a corresponding subterranean data store 636 in the memory device 52.

Block 640 then directs the representation processing circuit 560 to determine whether all flight lines for the mission have been processed as described above. If not, block 640 directs the representation processing circuit to continue processing data corresponding to the next successive flight line flown by the aircraft 100 over the environment 104, as described above in connection with blocks 600-630, until data corresponding to all flight lines have been processed and stored in the above manner.

In addition, in this embodiment, when all flight lines have been processed, block 640 directs the representation processing circuit 560 to repeat blocks 600 through 630 in relation to contents of the data 302 obtained during the course of the aircraft 100's flight across the various tie lines over the environment 104, which in this embodiment are flown substantially perpendicular to the flight lines. The representation processing circuit is directed to produce and store analogous data in the tie lines region 383 of the second memory device 329, which in this embodiment includes respective stores (not shown) corresponding to the various other stores of the second memory device 329 discussed above in connection with blocks 600 through 630. As with flight line data, such tie line data is also copied to the analyzed data region 605 of the memory device 52. In this regard, it has been found that such tie line data is potentially useful for a number of purposes, including reduction of errors in production of contours from the flight line data, for example. Also, if desired, the tie line data corresponding to locations intersecting the flight lines may be compared to the corresponding flight line data for the point of intersection, to produce and store error correction data. Such error data may then be further analyzed to identify any possible systematic errors present in the flight line data, in order to correct or compensate the flight line data for such errors, if desired. Alternatively, however, the tie lines may be omitted or ignored, if desired.

In this embodiment, block 650 then directs the representation processing circuit 560 to format the contents of the first return height store 372, the ground return height store 374 and the foliage height store 375, and to store the resulting formatted data in the first return grid 373, the ground grid store 376 and the foliage grid store 377 respectively, and also in corresponding grid stores 654, 656 and 658 in the memory device 52. In this embodiment, block 650 further directs the representation processing circuit to produce and store corresponding formatted tie line ground grid and tie line foliage grid data in the tie lines region 383 and a corresponding tie lines region 652 in the memory device 52. In this embodiment, each such grid is formatted as a 2-D matrix, with the relevant x and y coordinates serving as indices defining the locations of the respective corresponding z values, as such a format is useful for many contouring algorithms. Alternatively, however, other formats may be substituted.

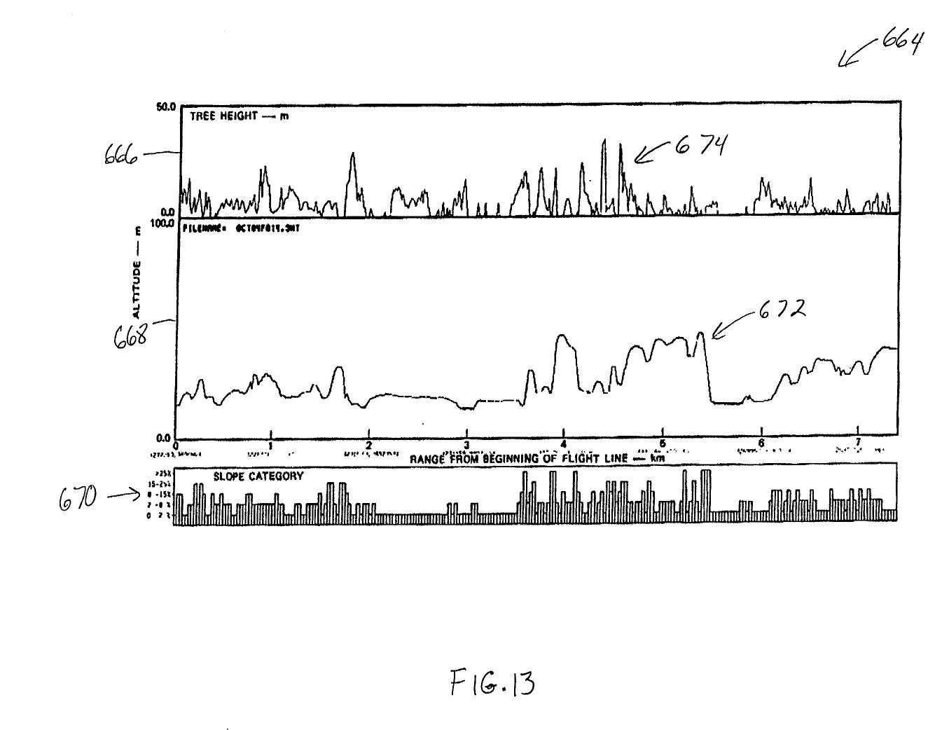

Referring to FIGS. 8a, 8b, 12, 13 and 14, block 660 then directs the representation processing circuit 560 to determine whether user input requesting display of a representation of the environment 104 along a specified flight line has been received. If so, block 662 directs the representation processing circuit 560 to produce and display a flight line representation, such as that shown at 664 in FIG. 13 for example. More particularly, in this embodiment the flight line representation 664 includes a relative foliage height field 666, a ground altitude field 668 and a slope field 670.

In this embodiment, to produce the flight line representation 664, block 662 directs the representation processing circuit 560 to identify contents of the ground grid store 376 and the foliage grid store 377 corresponding to the user-specified flight line. In response to such data, block 662 directs the representation processing circuit to display appropriate scaling information adjacent the ground altitude and relative foliage height fields 668 and 666. In this embodiment, block 662 then directs the representation processing circuit to apply a fitting algorithm, such as a least-squares fitting algorithm for example, to the ground height values z_{FPG} stored in the ground grid store 376 corresponding to respective successive locations (x_{FP}, y_{FP}) along the current flight line, and to plot a resulting best-fit curve 672 in the ground altitude field 668. In a similar manner, block 662 also directs the representation processing circuit to produce a best-fit curve 674 and to display it in the relative foliage height field 666, in response to the contents of the foliage grid store 377 corresponding to the current flight line. Alternatively, however, rather than applying a best-fit curve, the relevant contents of the ground grid store 376 and foliage grid store 377 may simply be plotted as successive data points in the fields 666 and 668, if desired.

In addition, in the present embodiment, block 662 directs the representation processing circuit to identify a slope of a terrain surface of the environment 104. More particularly, block 662 directs the representation processing circuit to calculate ground slope information, and to display a representation of such information in the slope field 670 of the flight line representation 664. In this embodiment, block 662 directs the representation processing circuit to calculate such slope information in response to the ground grid store data (x_{FP}, y_{FP}, z_{FPG}) corresponding to the specified flight line, at N intervals d m apart (in this embodiment, d=30 m), by calculating a slope value θ=TAN⁻¹[(z_{FPG(N)}−z_{FPG(N-1)})/d]. Alternatively, however, the slope may be calculated in other ways and/or at different intervals, if desired. In this embodiment, block 662 directs the representation processing circuit to display the resulting slope values as a bar graph in the slope field 670 of the flight line representation 664.

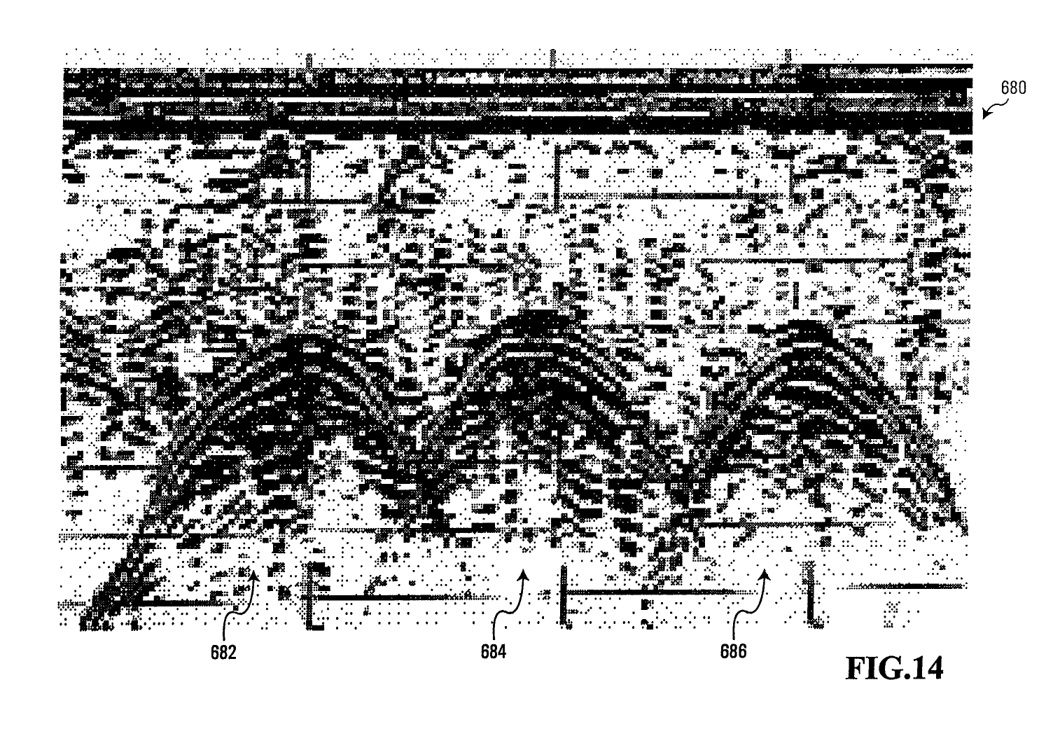

Alternatively, other types of flight line representations may be substituted if desired. For example, referring to FIGS. 8a, 8b, 12, 13 and 14, a segment of a representation of a subterranean portion of the environment 104 is shown generally at 680 in FIG. 14. In this embodiment, the representation 680 may be produced by the representation processing circuit 560 in response to receipt of a user-specified command requesting such a representation. The segment of the representation 680 shown in FIG. 14 corresponds to a much shorter segment of the environment 104 (approximately several meters across) than the flight line representation 664 shown in FIG. 13. To produce such a representation, block 662 directs the representation processing circuit to display a greyscale pixel for each data point (x_{FP}, y_{FP}, z_{FP}, σ_{P}R_{F}) stored in the subterranean data store 378, the opacity of which is proportional to the sum value σ_{P}R_{F}. In the exemplary segment 680, several hump-shaped irregularities 682, 684 and 686 may be observed, which in this embodiment are human graves beneath the surface of the environment 104.

If desired, block 662 may also direct the representation processing circuit to store the resulting flight line representation 664 or 680 in the analyzed data region 605 of the memory device 52.

Referring to FIGS. 8a, 8b, 12, 15 and 16, following execution of block 662, or alternatively if no user input requesting a flight line representation is detected, block 664 directs the representation processing circuit to determine whether user input requesting a contour display of the environment 104 has been received.

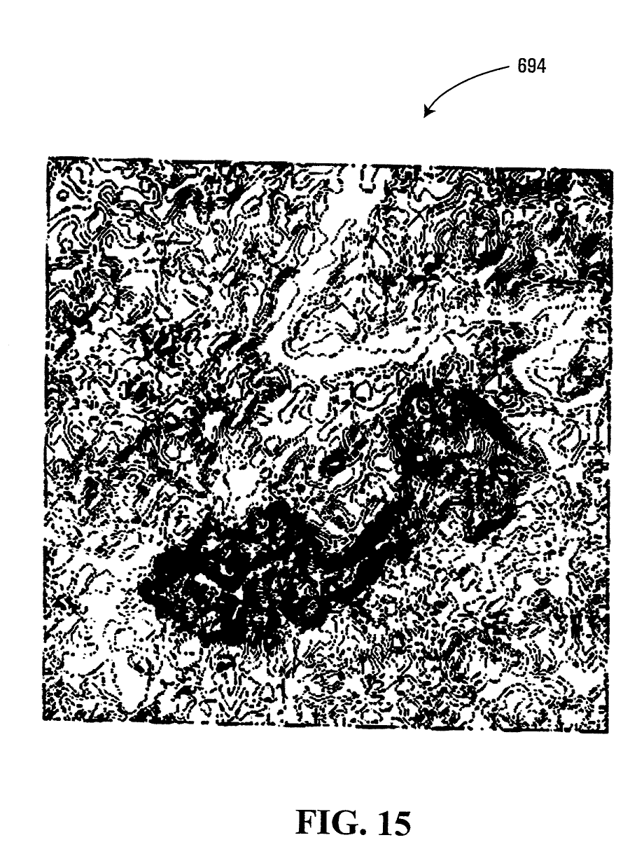

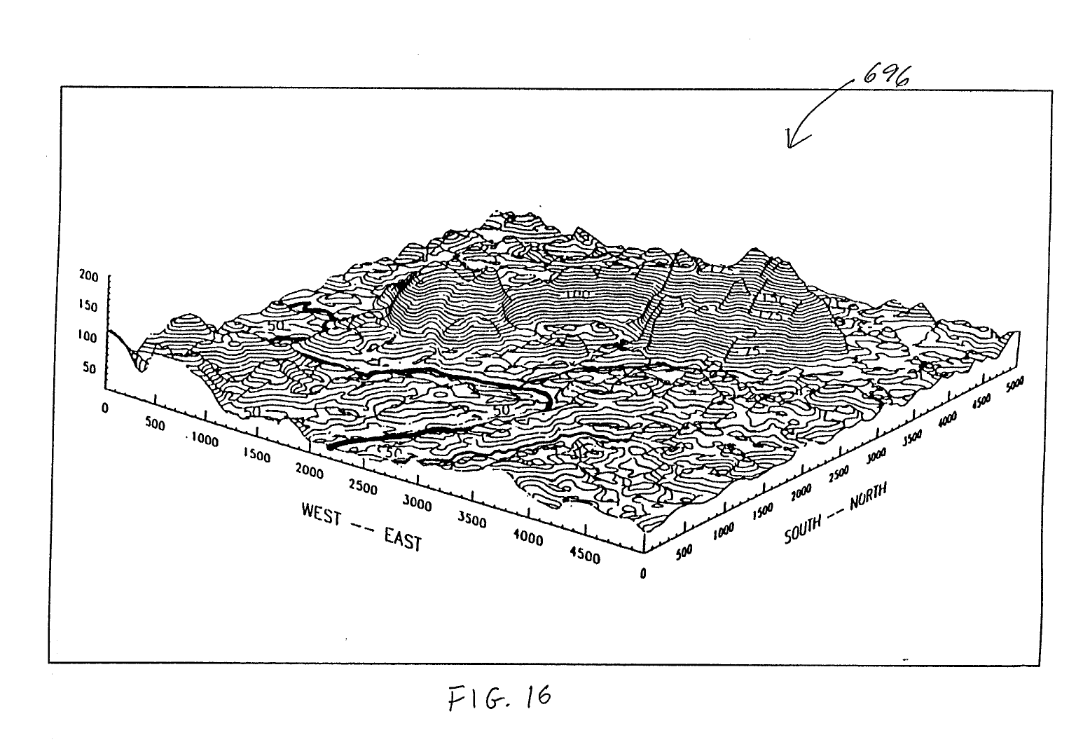

If so, block 692 directs the representation processing circuit 560 to produce a contour representation of the environment. More particularly, in this embodiment block 692 directs the representation processing circuit to produce a digital elevation model of the environment. To achieve this, in this embodiment block 692 directs the representation processing circuit to execute the contouring routine 325, which in this embodiment is the ANUDEM contouring software, to produce a digital elevation model in response to the entire contents of the ground grid store 376. In this embodiment, in order to reduce interpolation errors, block 692 directs the contouring routine to produce the digital elevation model in response to not only the contents of the ground grid store 376, but also in response to the contents of the tie line ground grid store (not shown) in the tie lines region 383 of the second memory device 329. After directing the representation processing circuit to produce such a digital elevation model, the contouring routine 325 directs the representation processing circuit to display a representation of the digital elevation model, such as a two-dimensional contour representation 694 of the environment 104 as shown in FIG. 15, or a three-dimensional contour representation shown generally at 696 in FIG. 16, for example.

Alternatively, or in addition, other contour representations of the environment may be produced, such as foliage height representations or subterranean feature representations produced in response to contents of the foliage grid store 377 or the subterranean data store 378, for example. If desired, such contour representations may be produced separately, or together with the ground altitude contour representations such as those shown in FIGS. 15 and 16, superimposed thereover, for example.

Similarly, variations of any such contour representations may also be substituted. For example, break lines, or in other words, known reference features of the environment 104 whose positional coordinates are known, may be input into the contouring routine 325 for calibration purposes. Or, as a further example, planimetric features, such as labels identifying villages, roads, rivers, drainage features and the like may be added to a contour representation to produce a full digital elevation map of the environment 104.

Similarly, if desired, referring back to FIGS. 2, 8a, 8b, 11 and 12, the camera 92 shown in FIG. 2 may be used to obtain visual images of the environment 104. For example, block 460 of the measurement routine 308 shown in FIG. 9 may be modified to additionally transmit a triggering signal to the camera 92 at a pre-defined interval, to cause the camera to produce digital data signals representing a visual image of the environment 104 beneath the aircraft 100 as it flies along a given flight line. Modified block 460 further directs the processor circuit 54 receive such signals via the I/O system 390, and to store corresponding image data in the memory device 52. For example, the processor circuit may be directed to store the image data in a camera field 698 of the data structure 334 in the second memory device 329, and to then copy the data structure to the memory device 52 as previously described. If desired, other representations of the environment, such as the contour representations described above for example, may be superimposed over the stored visual images of the environment, to produce a digital elevation map of the environment.

The analysis routine 320 is then ended.

Alternatives

Dual UWB Bands

Although the foregoing embodiment illustrates use of a 200-400 MHz ultra-wide band radar frequency range, alternatively, other frequency ranges may be substituted or added.

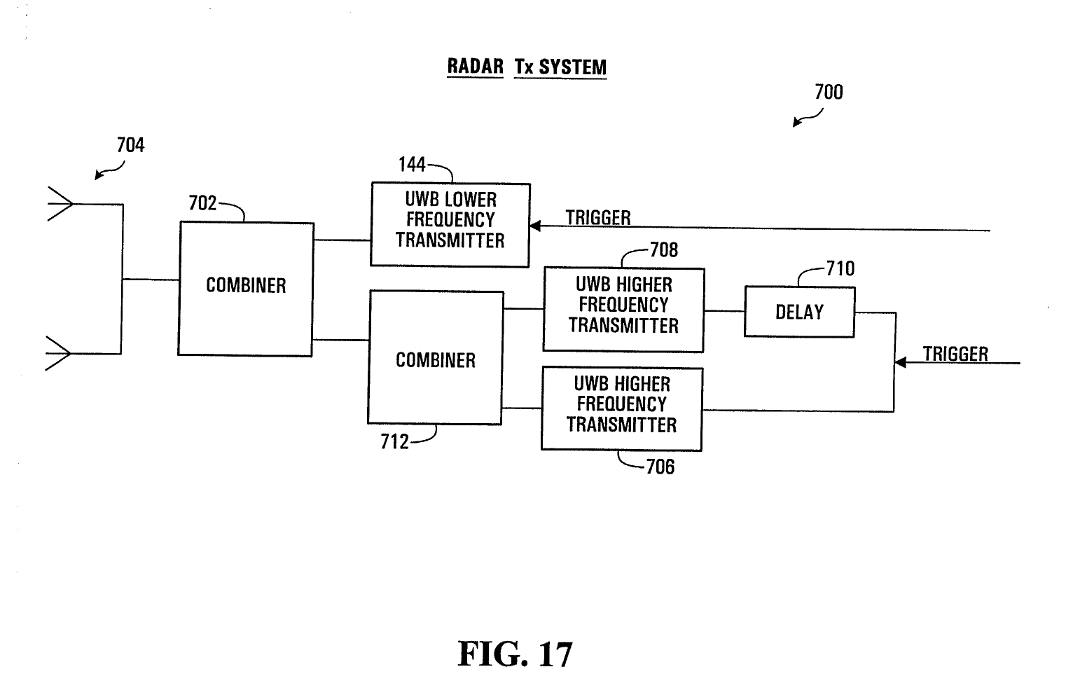

For example, referring to FIGS. 2, 6 and 17, a radar transmission system according to a third embodiment of the invention is shown generally at 700 in FIG. 17. In this embodiment, the radar transmission system 700 alternates between 200-400 MHz UWB radar pulses and 400-600 MHz UWB radar pulses. In this regard, the latter higher-frequency UWB range yields sharper spot coverage and therefore sharper resolution. At the same time, however, the former lower-frequency UWB range yields deeper penetration through foliage and other solid objects. Alternatively, for some applications it may be desirable to produce and store data produced in response to both these frequency ranges, to obtain the benefits of each.

In this embodiment, the radar transmission system 700 includes the UWB transmitter 144 shown in FIG. 6. In this embodiment, however, the UWB transmitter 144 is in communication with a first power combiner 702, which in turn is in communication with a transmission antenna system 704, which in this embodiment is capable of transmitting radar pulses having frequencies between 200 MHz and 600 MHz.

In this embodiment the radar transmission system 700 further includes first and second higher frequency UWB transmitters 706 and 708, each of which is in communication with the central processing system 60 for receiving a triggering signal therefrom. In this embodiment, each of the higher frequency UWB transmitters is operable to transmit a unipolar impulse signal having a duration of approximately 2 ns and a voltage of 10 kV to the transmission antenna system 704, to cause the antenna system to produce and tune a 2 ns electromagnetic radar pulse over an ultra-wide band frequency range between 400 MHz and 600 MHz (the 2 ns duration corresponds to a single cycle at the center frequency of 500 MHz).

A delay device 710 is interposed between the first higher frequency UWB transmitter 708 and the CPS 60. More particularly, in this embodiment the delay device includes a 50-ohm impedance delay cable of approximately 0.4 m in length, through which a triggering signal received from the CPS 60 travels at a speed of approximately 2 c/3. Thus, in this embodiment the delay device 710 delays the arrival of the triggering signal at the second higher frequency UWB transmitter 708 for an additional 2 ns (one cycle of the center frequency of 500 MHz of the transmitter 708) following the arrival of the triggering signal at the first higher frequency UWB transmitter 706.

The higher frequency UWB transmitters 706 and 708 are both in communication with a second power combiner 712, which receives the unipolar impulse signals produced by the first and second higher frequency UWB transmitters 706 and 708 and combines them onto a single signal line, which forwards the combined impulse signals, corresponding to two cycles at the 500 MHz center frequency, to the first combiner 702.

The first combiner 702 receives the 400-600 MHz combined impulse signals from the second combiner 712, and also receives a unipolar impulse signal from the UWB transmitter 144 operable to cause the transmission antenna system to produce and tune a 200 MHz-400 MHz radar pulse.

Referring back to FIGS. 7, 8a and 8b, in this embodiment the oscillator 260 shown in FIG. 7 includes a 300 MHz oscillator and additionally includes a 500 MHz oscillator, along with an SPDT switch (not shown) for switching between the two frequencies. The SPDT switch includes a monitoring connection in communication with the I/O system 390 of the CPS 60, for providing a signal indicative of the switch position. In addition, if desired, the calibration signal generator 226 may include first and second calibration signal generators switchable between two calibration signal frequencies, such as 320 MHz and 520 MHz for example.

Referring to FIGS. 7, 8a, 8b and 17, in operation, as with the main embodiment described above, a radar pulse is produced 75 times per second. However, in this embodiment, to produce every odd-numbered radar pulse, the processor circuit 54 transmits a triggering signal to the first higher-frequency UWB transmitter 706, which is also received at the second higher-frequency UWB transmitter 708 via the delay device 710. The UWB transmitters 706 and 708 each produce a unipolar impulse signal operable to drive the transmission antenna system 704 to produce a 2 ns radar pulse at 400 MHz-600 MHz, with the unipolar impulse signal produced by the second UWB transmitter 708 being delayed by 2 ns (one cycle at 500 MHz) relative to that produced by the first UWB transmitter 706. Such signals are combined by the combiner 712 which transmits the combined signal via the combiner 702 to the transmission antenna system 704, which produces a radar pulse at frequencies of 500±100 MHz, having a duration of 4 ns (two cycles at 500 MHz). The processor circuit 54 also transmits a switching signal to the oscillator 260, to cause the oscillator to transmit a 500 MHz mixing frequency signal to the frequency shifter 227, to effectively down-shift the resulting 500±100 MHz second signals 58 to 0±100 MHz (the same down-shifted frequency range as the 300±100 MHz second signals 58 of the main embodiment described above). If desired, the processor circuit may also transmit a switching signal to the calibration signal generator 226 to cause it to insert a 520 MHz rather than 320 MHz calibration signal into the second signals 58.

Similarly, to produce every even-numbered radar pulse, the processor circuit 54 transmits a triggering signal to the UWB transmitter 144 to produce a 300±100 MHz radar pulse, and transmits a triggering signal to the switch of the oscillator 260 to cause the oscillator to transmit a 300 MHz mixing frequency to the frequency-shifter 227 (as well as an additional triggering signal to the calibration signal generator to cause it to produce a 320 MHz calibration signal).

Processing, storage and analysis of such radar data proceeds as above, with the exception that each data structure 334 further includes a frequency sub-field 714 of the measurement context field 336. The processor circuit 54 is configured to store in the frequency sub-field 714, as the measurement context information, a frequency value indicative of a frequency of the radar beam. More particularly, in this embodiment the processor circuit stores a bit in the frequency sub-field 714 in response to the monitoring signal received from the switch of the oscillator 260, indicative of whether the oscillator is producing a 300 MHz or a 500 MHz mixing signal (effectively indicating whether the frequency of the radar pulse, in response to which the radar data stored in the data structure 334 were produced, was 300±100 MHz or 500±100 MHz).

Radar Transceiving System

Referring to FIGS. 6, 7 and 18, although the radar transmission system 66 and the radar reception system 68 were described above as including separate respective antenna systems 108 and 110, alternatively, the transmission antenna system and the reception antenna system may include a common transceiving antenna system, for both transmission and reception, if desired.

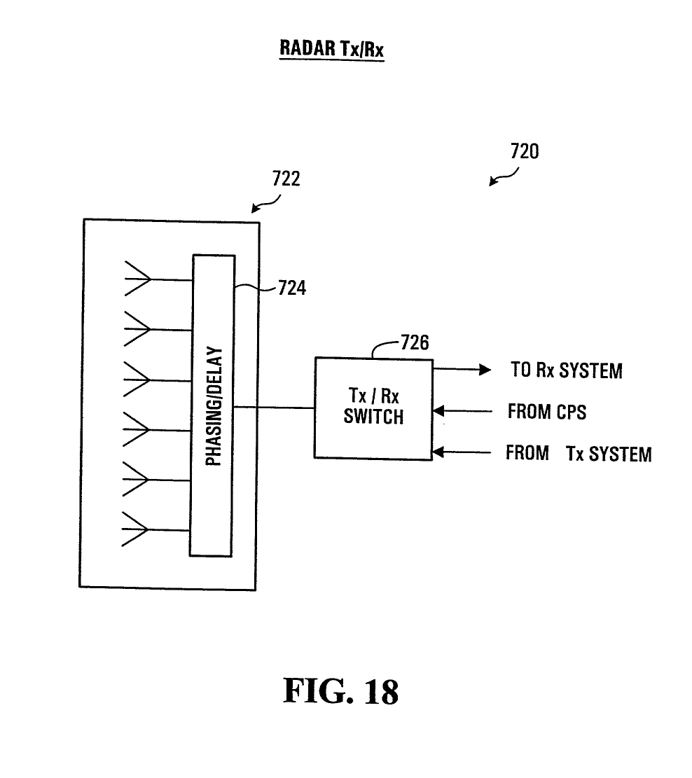

For example, a radar transceiving system according to a fourth embodiment of the invention is shown generally at 720 in FIG. 18. In this embodiment, the transceiving system 720 includes an antenna system 722 and a delay device 724, which in this embodiment are similar to the antenna system 110 and delay device 172 of the radar reception system 68 shown in FIG. 7.

In this embodiment, the transceiving system 720 further includes a transmit/receive switch 726, in communication with the central processing system 60. In this embodiment, the transmit/receive switch 726 includes suppression circuitry, sufficient to suppress signals produced by the antenna system 722 in response to leakage (i.e. inadvertent direct transmission from one antenna to another) of a portion of a transmitted radar pulse.

In the present embodiment, the transmit/receive switch 726 is in communication with the UWB transmitter 144 shown in FIG. 6, and with the blanker 190 and receiver 150 shown in FIG. 7. The transmit/receive switch is controllable by the processor circuit 54 to alternately transmit without receiving (or more particularly, to transmit unipolar impulse signals produced by the UWB transmitter 144 to the antenna system 722 while suppressing signals produced by the antenna system 722), and conversely, to receive without transmitting (or more particularly, to transmit signals produced by the antenna system 722 in response to received electromagnetic radiation to the blanker 190 and receiver 150, while suppressing signals produced by the UWB transmitter 144.)

In embodiments wherein the antennae are distributed over a distance (mounted along the underneath of the wings of the aircraft 100 from wing-tip to wing-tip for example), this provides for a considerably smaller radar spot projection on the environment 104, thereby effectively improving resolution. In some embodiments this may obviate the desirability of migrating the radar data as described above.

Arbitration

If desired, the laser data may be used to arbitrate the radar data. For example, the representation processing circuit 560 may be configured to examine the radar and laser height estimates, and to determine if local terrain slope caused any degradation in radar accuracy. If so, the representation processing circuit may be configured to find the nearest points in which the laser system was able to see the ground and interpolate a correction function.

Liquid

The representation processing circuit 560 may be additionally configured to identify surface liquid of the environment 104. In this regard, water has a significantly higher dielectric constant, and therefore significantly higher radar reflectivity, than dry ground. Accordingly, the representation processing circuit may be configured to compare the sum values stored in the migrated data store 381 to a pre-determined threshold value, to determine whether each respective fixed point corresponding to each such sum value is likely to represent surface water of the environment.

More generally, while specific embodiments of the invention have been described and illustrated, such embodiments should be considered illustrative of the invention only and not as limiting the invention as construed in accordance with the accompanying claims.

What is claimed is:

1. An environment measurement method comprising:
receiving first signals produced in response to a laser beam scattered by said environment;
receiving second signals produced in response to a radar beam scattered by said environment; and
storing data representing said first and second signals, for use in producing a representation of said environment.

2. The method of claim 1 further comprising receiving said laser beam scattered by said environment and producing said first signals in response thereto.

3. The method of claim 1 further comprising producing an incident laser beam for scattering by said environment to produce said laser beam scattered by said environment.

4. The method of claim 3 further comprising directing said incident laser beam to said environment at a desired angle.

5. The method of claim 4 wherein directing comprises adjusting a physical orientation of a beam directing device in response to an orientation signal, to direct said incident laser beam to said environment at said desired angle.

6. The method of claim 5 further comprising producing said orientation signal.

7. The method of claim 5 further comprising directing said laser beam scattered by said environment from said beam directing device to a detector.

8. The method of claim 2 wherein:
receiving said laser beam scattered by said environment comprises receiving scattered portions of a laser pulse scattered by respective portions of said environment; and
producing said first signals further comprises continuously producing data signals in response to said scattered portions of said laser pulse, during a measurement interval of sufficient duration to receive all said scattered portions.

9. The method of claim 1 further comprising producing said second signals in response to said radar beam scattered by said environment.

10. The method of claim 9 further comprising receiving said radar beam scattered by said environment at an airborne receiver, said radar beam having a wavelength of at least on the order of one meter.

11. The method of claim 10 wherein receiving comprises receiving, as said radar beam scattered by said environment, a radar beam having a wavelength between 0.7 and 2 meters.

12. The method of claim 9 further comprising directing an incident radar beam to said environment to produce said radar beam scattered by said environment.

13. The method of claim 12 wherein directing comprises directing to said environment, as said incident radar beam, an ultra-wide band (UWB) radar beam.

14. The method of claim 12 wherein directing comprises transmitting said incident radar beam to said environment from a transmission antenna system, and further comprising receiving said radar beam scattered by said environment at a reception antenna system.

15. The method of claim 14 wherein producing said second signals comprises delaying signals produced by at least some of a plurality of antennae of said reception antenna system.

16. The method of claim 14 wherein said transmission antenna system and said reception antenna system comprise a common transceiving antenna system, and wherein transmitting and receiving comprise transmitting and receiving at said common transceiving antenna system.

17. The method of claim 12 further comprising blanking transmitter cross-talk signals while directing said incident radar beam to said environment.

18. The method of claim 9 wherein producing said second signals comprises producing frequency-shifted signals in response to said radar beam scattered by said environment.

19. The method of claim 18 wherein producing frequency-shifted signals comprises:
producing initial electrical signals at frequencies of said radar beam scattered by said environment, in response thereto; and
applying said initial electrical signals and a mixing frequency signal to a mixer, to produce said frequency-shifted signals.

20. The method of claim 18 wherein producing frequency-shifted signals comprises producing in-phase frequency-shifted signals and in-quadrature frequency-shifted signals.

21. The method of claim 18 wherein producing said second signals further comprises digitizing said frequency-shifted signals.

22. The method of claim 9 further comprising adjustably attenuating said second signals.

23. The method of claim 1 wherein storing said data comprises defining a data structure comprising a measurement context field for storing measurement context information, a laser field for storing said data representing said first signals, and a radar beam field for storing said data representing said second signals.

24. The method of claim 1 wherein storing said data comprises storing measurement context information in association with said data representing said first and second signals.

25. The method of claim 24 wherein storing measurement context information comprises storing global positioning satellite (GPS) information indicative of a location at which at least one of said laser beam and said radar beam is received.

26. The method of claim 24 wherein storing measurement context information comprises storing at least one time value indicative of a time at which at least one of said laser beam and said radar beam is received.

27. The method of claim 24 wherein storing measurement context information comprises storing attenuation information indicative of an amount of attenuation of said second signals.

28. The method of claim 24 wherein storing measurement context information comprises storing a frequency value indicative of a frequency of said radar beam.

29. The method of claim 24 wherein storing measurement context information comprises storing user-inputted information.

30. The method of claim 29 wherein storing measurement context information comprises storing a flight line indication indicative of a flight line over which said laser beam and said radar beam are received by an airborne environment measurement system.

31. The method of claim 1 wherein storing said data representing said second signals comprises storing an in-phase value and an in-quadrature value representing an in-phase component and an in-quadrature component respectively of said second signals.

32. The method of claim 1 further comprising producing said representation of said environment in response to said data.

33. The method of claim 32 wherein producing said representation comprises applying a migration algorithm to said data representing said second signals, to associate said data representing said second signals with particular locations of said environment.

34. The method of claim 32 wherein producing said representation comprises identifying a foliage height of said environment.

35. The method of claim 32 wherein producing said representation comprises identifying a height of a terrain surface of said environment.

36. The method of claim 35 wherein producing said representation further comprises identifying features of said environment below said terrain surface.

37. The method of claim 35 wherein producing said representation further comprises identifying a slope of said terrain surface.

38. The method of claim 32 wherein producing said representation comprises producing a digital elevation model of said environment.

39. The method of claim 32 wherein producing said representation comprises producing at least one contour representation of said environment.

40. An environment measurement system comprising:
a memory device; and
a processor circuit in communication with said memory device, wherein said processor circuit is configured to receive first signals produced in response to a laser beam scattered by said environment, to receive second signals produced in response to a radar beam scattered by said environment, and to store data representing said first and second signals in said memory device, for use in producing a representation of said environment.

41. The system of claim 40 further comprising a detector operable to receive said laser beam scattered by said environment and to produce said first signals in response thereto.

42. The system of claim 40 further comprising a laser operable to produce an incident laser beam for scattering by said environment to produce said laser beam scattered by said environment.

43. The system of claim 42 further comprising a beam directing device operable to direct said incident laser beam to said environment at a desired angle.

44. The system of claim 43 further comprising a motion mechanism operable to adjust a physical orientation of said beam directing device in response to an orientation signal, to direct said incident laser beam to said environment at said desired angle.

45. The system of claim 44 further comprising an orientation monitoring device operable to produce said orientation signal.

46. The system of claim 43 wherein said beam directing device is locatable to direct said laser beam scattered by said environment to said detector.

47. The system of claim 41 further comprising an analog-to-digital converter (ADC) operable to cooperate with said detector to continuously produce data signals in response to scattered portions of a laser pulse scattered by respective portions of said environment, during a measurement interval of sufficient duration to receive all said scattered portions.

48. The system of claim 40 further comprising a radar system operable to produce said second signals in response to said radar beam scattered by said environment.

49. The system of claim 48 further wherein said radar system comprises an airborne radar reception system configured to receive, as said radar beam scattered by said environment, a radar beam having a wavelength of at least on the order of one meter.

50. The system of claim 49 wherein said airborne radar reception system is configured to receive, as said radar beam scattered by said environment, a radar beam having a wavelength between 0.7 and 2 meters.

51. The system of claim 48 wherein said radar system is configured to direct an incident radar beam to said environment to produce said radar beam scattered by said environment.

52. The system of claim 51 wherein said radar system is configured to direct to said environment, as said incident radar beam, an ultra-wide band (UWB) radar beam.

53. The system of claim 51 wherein said radar system comprises a transmission antenna system configured to direct said incident radar beam, and a reception antenna system configured to receive said radar beam scattered by said environment.

54. The system of claim 53 wherein said radar system further comprises a delay device operable to delay signals produced by at least some of a plurality of antennae of said reception antenna system.

55. The system of claim 53 wherein said transmission antenna system and said reception antenna system comprise a common transceiving antenna system.

56. The system of claim 51 wherein said radar system further comprises a blanker operable to blank transmitter cross-talk signals while directing said incident radar beam to said environment.

57. The system of claim 48 wherein said radar system further comprises a frequency-shifter operable to produce said second signals by producing frequency-shifted signals in response to said radar beam scattered by said environment.

58. The system of claim 57 wherein:
said radar system is configured to produce initial electrical signals at frequencies of said radar beam scattered by said environment, in response thereto; and
said frequency-shifter comprises a mixer operable to produce said frequency-shifted signals in response to said initial electrical signals and a mixing frequency signal.

59. The system of claim 57 wherein said frequency-shifter comprises at least one mixer and at least one phase-shifter, and is operable to produce, as said frequency-shifted signals, in-phase frequency-shifted signals and in-quadrature frequency-shifted signals.

60. The system of claim 57 further comprising an analog-to-digital converter (ADC) operable to digitize said frequency-shifted signals.

61. The system of claim 48 further comprising an attenuator operable to adjustably attenuate said second signals.

62. The system of claim 40 wherein said processor circuit is configured to define, in said memory device, a data structure comprising a measurement context field for storing measurement context information, a laser field for storing said data representing said first signals, and a radar beam field for storing said data representing said second signals.

63. The system of claim 40 wherein said processor circuit is configured to store measurement context information in said memory device in association with said data representing said first and second signals.

64. The system of claim 63 wherein said processor circuit is configured to store, as said measurement context information, global positioning satellite (GPS) information indicative of a location at which at least one of said laser beam and said radar beam is received.

65. The system of claim 63 wherein said processor circuit is configured to store, as said measurement context information, at least one time value indicative of a time at which at least one of said laser beam and said radar beam is received.

66. The system of claim 63 wherein said processor circuit is configured to store, as said measurement context information, attenuation information indicative of an amount of attenuation of said second signals.

67. The system of claim 63 wherein said processor circuit is configured to store, as said measurement context information, a frequency value indicative of a frequency of said radar beam.

68. The system of claim 63 wherein said processor circuit is configured to store, as said measurement context information, user-inputted information.

69. The system of claim 68 wherein said processor circuit is configured to store, as said measurement context information, a flight line indication indicative of a flight line over which said laser beam and said radar beam are received by an airborne environment measurement system.

70. The system of claim 40 wherein said processor circuit is configured to store, as said data representing said second signals, an in-phase value and an in-quadrature value representing an in-phase component and an in-quadrature component respectively of said second signals.

71. The system of claim 40 further comprising a representation processing circuit configured to produce said representation of said environment in response to said data.

72. The system of claim 71 wherein said representation processing circuit is configured to apply a migration algorithm to said data representing said second signals, to associate said data representing said second signals with particular locations of said environment.

73. The system of claim 71 wherein said representation processing circuit is configured to identify a foliage height of said environment.

74. The system of claim 71 wherein said representation processing circuit is configured to identify a height of a terrain surface of said environment.

75. The system of claim 74 wherein said representation processing circuit is configured to identify features of said environment below said terrain surface.

76. The system of claim 74 wherein said representation processing circuit is configured to identify a slope of said terrain surface.

77. The system of claim 71 wherein said representation processing circuit is configured to produce a digital elevation model of said environment.

78. The system of claim 71 wherein said representation processing circuit is configured to produce at least one contour representation of said environment.

79. The system of claim 71 wherein said representation processing circuit comprises said processor circuit.

80. An environment measurement system comprising:
means for receiving first signals produced in response to a laser beam scattered by said environment;
means for receiving second signals produced in response to a radar beam scattered by said environment; and
means for storing data representing said first and second signals, for use in producing a representation of said environment.

81. A computer-readable medium storing codes for directing a processor circuit to:
receive first signals produced in response to a laser beam scattered by said environment;
receive second signals produced in response to a radar beam scattered by said environment; and
store data representing said first and second signals, for use in producing a representation of said environment.

82. A signal comprising:
a first code segment for directing a processor circuit to receive first signals produced in response to a laser beam scattered by said environment;
a second code segment for directing said processor circuit to receive second signals produced in response to a radar beam scattered by said environment; and
a third code segment for directing said processor circuit to store data representing said first and second signals, for use in producing a representation of said environment.

83. A data structure comprising:
a laser field for storing data representing first signals produced in response to a laser beam scattered by an environment; and
a radar beam field for storing data representing second signals produced in response to a radar beam scattered by said environment.

84. The data structure of claim 83 further comprising a measurement context field for storing measurement context information.

85. An environment measurement method comprising:
continuously producing data in response to scattered portions of a laser pulse scattered by respective portions of said environment, during a measurement interval of sufficient duration to receive all said scattered portions; and
storing said data, for use in producing a representation of said environment.

86. The method of claim 85 wherein said measurement interval is at least on the order of one microsecond.

87. The method of claim 85 further comprising producing an incident laser pulse having a duration on the order of one nanosecond, for scattering by said environment to produce said scattered portions of said laser pulse.

88. The method of claim 85 further comprising:
receiving said incident laser pulse at a beam directing device; and
adjusting a physical orientation of said beam directing device in response to an orientation signal, to direct said incident laser pulse from said beam directing device to said environment.

89. An environment measurement system comprising:
a memory device; and
a processor circuit in communication with said memory device, wherein said processor circuit is configured to:
cooperate with a detection system to continuously produce data in response to scattered portions of a laser pulse scattered by respective portions of said environment, during a measurement interval of sufficient duration to receive all said scattered portions, and
store said data in said memory device, for use in producing a representation of said environment.

90. The system of claim 89 further comprising said detection system.

91. The system of claim 90 wherein said detection system comprises:
a detector operable to receive said scattered portions and to produce analog signals in response thereto; and
an analog-to-digital converter (ADC) operable to cooperate with said detector to continuously produce digital signals in response to said analog signals, during said measurement interval.

92. The system of claim 89 wherein said processor circuit is configured to define said duration of said measurement interval to be at least on the order of one microsecond.

93. The system of claim 89 further comprising a laser operable to produce an incident laser pulse having a duration on the order of one nanosecond, for scattering by said environment to produce said scattered portions of said laser pulse.

94. The system of claim 89 further comprising:
a beam directing device locatable to receive said incident laser pulse; and
a motion mechanism operable to adjust a physical orientation of said beam directing device in response to an orientation signal, to direct said incident laser pulse from said beam directing device to said environment.

95. An environment measurement system comprising:
means for continuously producing data in response to scattered portions of a laser pulse scattered by respective portions of said environment, during a measurement interval of sufficient duration to receive all said scattered portions; and
means for storing said data, for use in producing a representation of said environment.

96. A computer-readable medium storing codes for directing a processor circuit to:
cooperate with a detection system to continuously produce data in response to scattered portions of a laser pulse scattered by respective portions of said environment, during a measurement interval of sufficient duration to receive all said scattered portions, and
store said data, for use in producing a representation of said environment.

97. A signal comprising:
a first code segment for directing a processor circuit to cooperate with a detection system to continuously produce data in response to scattered portions of a laser pulse scattered by respective portions of said environment, during a measurement interval of sufficient duration to receive all said scattered portions, and
a second code segment for directing said processor circuit to store said data, for use in producing a representation of said environment.

98. An environment measurement method comprising:
producing signals in response to a radar beam scattered by said environment and received at an airborne receiver, said radar beam having a wavelength of at least on the order of one meter; and
storing data representing said signals, for use in producing a representation of said environment.

99. The method of claim 98 further comprising receiving said radar beam scattered by said environment at said airborne receiver, said radar beam having a wavelength between 0.7 and 2 meters.

100. The method of claim 98 wherein producing signals comprises continuously producing data signals in response to scattered portions of a radar pulse scattered by respective portions of said environment, during a measurement interval of sufficient duration to receive all said scattered portions.

101. The method of claim 98 further comprising directing an ultra-wide band (UWB) incident radar beam to said environment to produce said radar beam scattered by said environment.

102. An environment measurement system comprising:
an airborne radar reception system operable to produce signals in response to a radar beam scattered by said environment and having a wavelength of at least on the order of one meter; and
a processor circuit in communication with said airborne radar reception system, configured to store data representing said signals, for use in producing a representation of said environment.

103. The system of claim 102 wherein said airborne radar reception system is configured to receive, as said radar beam scattered by said environment, a radar beam having a wavelength between 0.7 and 2 meters.

104. The system of claim 102 wherein said airborne radar reception system is operable to continuously produce data signals in response to scattered portions of a radar pulse scattered by respective portions of said environment, during a measurement interval of sufficient duration to receive all said scattered portions.

105. The system of claim 104 wherein said airborne radar reception system comprises:
a detector operable to receive said scattered portions and to produce analog signals in response thereto; and
an analog-to-digital converter (ADC) operable to cooperate with said detector to continuously produce digital signals in response to said analog signals, during said measurement interval.

106. The system of claim 102 further comprising a radar transmission system operable to direct an ultra-wide band (UWB) incident radar beam to said environment to produce said radar beam scattered by said environment.

107. An environment measurement system comprising:
means for producing signals in response to a radar beam scattered by said environment and received at an airborne receiver, said radar beam having a wavelength of at least on the order of one meter; and
means for storing data representing said signals, for use in producing a representation of said environment.

108. An environment measurement method comprising:
receiving data representing signals produced at an airborne receiver in response to a radar beam scattered by said environment; and
applying a migration algorithm to said data, to associate said data with particular locations of said environment.

109. An environment measurement system comprising a processor circuit configured to:
receive data representing signals produced at an airborne receiver in response to a radar beam scattered by said environment; and
apply a migration algorithm to said data, to associate said data with particular locations of said environment.

110. An environment measurement system comprising:
means for receiving data representing signals produced at an airborne receiver in response to a radar beam scattered by said environment; and
means for applying a migration algorithm to said data, to associate said data with particular locations of said environment.

111. A computer-readable medium storing codes for directing a processor circuit to:
receive data representing signals produced at an airborne receiver in response to a radar beam scattered by said environment; and
apply a migration algorithm to said data, to associate said data with particular locations of said environment.

112. A signal comprising:
a first code segment for directing a processor circuit to receive data representing signals produced at an airborne receiver in response to a radar beam scattered by said environment; and
a second code segment for directing a processor circuit to apply a migration algorithm to said data, to associate said data with particular locations of said environment.
